(19) United States
(12) Patent Application Publication
(10) Pub. No.: US 2026/0054329 A1
(43) Pub. Date: Feb. 26, 2026

(54) SUBSTRATE BONDING SYSTEM AND SUBSTRATE BONDING METHOD

(71) Applicant: BONDTECH CO., LTD., Kyoto (JP)

(72) Inventor: Akira YAMAUCHI, Kyoto (JP)

(73) Assignee: BONDTECH CO., LTD., Kyoto (JP)

(21) Appl. No.: 19/111,939

(22) PCT Filed: Sep. 20, 2022
(86) PCT No.: PCT/JP2022/034913

§ 371 Date: Mar. 14, 2025

(51) Int. Cl. B23K 37/04; B23K 17/00; H02N 13/00

(52) U.S. Cl. CPC B23K 37/0426; B23K 17/00; H02N 13/00

(57) ABSTRACT

A substrate bonder includes a gas discharge hole (1413c, 1423c) provided in a second region in a stage and a head, and a controller that controls a chuck drive unit and a gas supply unit (1492) to release holding of a substrate with an electrostatic chuck (1413, 1423) and discharge gas from the gas discharge hole (1413c, 1423c) in a state where a peripheral portion of the substrate is held by the electrostatic chuck before bringing central portions of the substrates into contact with each other. The stage and the head include grooves (1413d, 1423d) provided in the second region and communicating with the gas discharge holes (1413c, 1423c).

### CROSS-REFERENCE TO RELATED APPLICATIONS

This application is a 371 of international PCT Application No. PCT/JP2022/034913 filed on Sep. 20, 2022, the entire contents of which are hereby incorporated by reference.

### TECHNICAL FIELD

The present invention relates to a substrate bonding system and a substrate bonding method.

### BACKGROUND ART

There has been proposed a device for bonding two substrates to each other, the device including an attachment device to which a substrate is attached at the time of bonding (see, for example, Patent Literature 1). The attachment device described in Patent Literature 1 includes an outer annular portion that holds a peripheral portion of a substrate with a vacuum chuck and a deformation unit that deforms the substrate such that a central portion of the substrate projects from the attachment device. Then, this device brings the central portions of the bonding surfaces of the two substrates into contact with each other and then releases the suction and holding of the peripheral portion of one substrate with the vacuum chuck. This causes the contact portion to expand radially outward from the central portion of the one substrate because of the restoring force and gravity acting on the peripheral portion of the one substrate and to reach the peripheral surface of the one substrate. The two substrates are thus bonded to each other.

### CITATION LIST

### Patent Literature

Patent Literature 1: WO 2013/023708 A

### SUMMARY OF INVENTION

### Technical Problem

However, in the case of the device described in Patent Literature 1, when the suction and holding of the peripheral portion of one substrate is released, the vacuum chuck may attach to the attachment surface of the substrate of the attachment device because of the electrostatic force generated in the peripheral portion of the substrate even when the vacuum chuck that sucks and holds the peripheral portion of the one substrate is stopped. In this case, the magnitude of the force acting on one substrate becomes non-uniform, and the speed at which the contact portion between the substrates expands varies, and as a result, there is a possibility that the bonding position accuracy in the entire two substrates bonded to each other decreases.

The present invention has been made in view of the above circumstances, and an object of the present invention is to provide a substrate bonding system and a substrate bonding method capable of improving bonding position accuracy in the entire substrates bonded to each other.

### Solution to Problem

To achieve the above-described object, a substrate bonding system according to the present invention is a substrate bonding system that bonds a first substrate and a second substrate, the substrate bonding system including:
a first substrate holding unit that holds the first substrate;
a second substrate holding unit that holds the second substrate in a state where a bonding surface of the second substrate faces a bonding surface of the first substrate;
at least one first electrostatic chuck provided in a first region facing a peripheral portion of the first substrate disposed at a substrate holding position set in advance in the first substrate holding unit;
at least one second electrostatic chuck that is provided in a second region inside the first region in the first substrate holding unit and holds a portion facing the second region in the first substrate disposed at the substrate holding position;
a chuck drive unit that individually drives the first electrostatic chuck and the second electrostatic chuck;
a gas discharge unit that is provided in the second region of the first substrate holding unit and discharges gas toward the first substrate;
a gas supply unit that supplies gas to the gas discharge unit; and
a controller that releases holding of the first substrate with the second electrostatic chuck and controls the chuck drive unit and the gas supply unit to discharge gas from the gas discharge unit in a state where the peripheral portion of the first substrate is held by the first electrostatic chuck before bringing a central portion of the bonding surface of the first substrate and a central portion of the bonding surface of the second substrate into contact with each other,
wherein the first substrate holding unit includes a first recess provided in the second region and communicating with the gas discharge unit.

A substrate bonding method according to the present invention as viewed from another viewpoint is a substrate bonding method for bonding a first substrate and a second substrate, the method including:
a step of causing a first electrostatic chuck provided in a first region facing a peripheral portion of the first substrate disposed at a substrate holding position set in advance in the first substrate holding unit to hold the peripheral portion of the first substrate;
a step of causing a second substrate holding unit to hold the second substrate in a state where a bonding surface of the second substrate faces a bonding surface of the first substrate;
a step of causing a gas discharge unit in the first substrate holding unit having a first recess to the first recess, the first recess being provided in a second region inside the first region and communicating with the gas discharge unit, in a state where the peripheral portion of the first substrate is held by the first electrostatic chuck; and
a step of, after the gas is discharged to the first recess, causing a central portion of the bonding surface of the first substrate and a central portion of the bonding surface of the second substrate to come into contact with each other.

### Advantageous Effects of Invention

According to the present invention, the first substrate holding unit, including the first recess provided in the second region and communicating with the gas discharge unit, brings the first substrate and the second substrate while discharging gas from the gas discharge unit between the first substrate holding unit and the first substrate through the first recess in a state where the central portion of the bonding surface of the first substrate and the central portion of the bonding surface of the second substrate are in contact with each other and the peripheral portion of the first substrate is held by the first electrostatic chuck. This causes the pressure of the gas discharged from the first recess to effectively act on the force for bringing the first substrate into close contact with the first substrate holding unit with the residual electrostatic force remaining in the second electrostatic chuck after the holding with the second electrostatic chuck is released, and the first substrate is brought into a free state with respect to the force for bringing the first substrate into close contact with the first substrate holding unit. Then, in this state, bonding can be advanced from the central portions of the first substrate and the second substrate toward the peripheral portions in a state where there is no influence of the adhesion force of the first substrate to the first substrate holding unit by pressurizing and bringing the central portions of the first substrate and the second substrate into contact with each other at a pressure equal to or higher than the critical pressure. Thus, the first substrate and the second substrate can be bonded on the entire surfaces with high positional accuracy without distortion.

### BRIEF DESCRIPTION OF DRAWINGS

FIG. 1 is a schematic configuration diagram of a substrate bonding system according to Embodiment 1 of the present invention.

FIG. 2 is a schematic front view of an activation processing device according to Embodiment 1.

FIG. 3 is a schematic front view of a substrate bonder according to Embodiment 1.

FIG. 4A is a schematic perspective view illustrating the vicinity of a stage and a head according to Embodiment 1.

FIG. 4B is a diagram for describing a method for finely adjusting the head according to Embodiment 1.

FIG. 5A is a schematic plan view of the stage and the head according to Embodiment 1.

FIG. 5B is an enlarged view of the stage and the head according to Embodiment 1.

FIG. 6A is a plan view of a part of a first region of the stage and the head according to Embodiment 1.

FIG. 6B is a plan view of a part of a second region of the stage and the head according to Embodiment 1.

FIG. 7A is a schematic sectional view of the stage and the head according to Embodiment 1 taken along the line B-B in FIG. 5A.

FIG. 7B is a schematic sectional view of the stage and the head according to Embodiment 1 taken along the line A-A in FIG. 5A.

FIG. 8 is a schematic plan view of a position measurement unit according to Embodiment 1.

FIG. 9A is a diagram illustrating three alignment marks provided on one of two substrates to be bonded.

FIG. 9B is a diagram illustrating three alignment marks provided on the other of two substrates to be bonded.

FIG. 10A is a schematic diagram illustrating a captured image of alignment marks.

FIG. 10B is a schematic diagram illustrating a state in which alignment marks are shifted from each other.

FIG. 11 is a schematic diagram of an inspection device according to Embodiment 1.

FIG. 12 is a flowchart illustrating a flow of a substrate bonding method executed by the substrate bonding system according to Embodiment 1.

FIG. 13A is a schematic plan view illustrating an electrostatic chuck and an alignment mark according to Embodiment 1 in a state where the electrostatic chuck and the alignment mark are overlapped with each other.

FIG. 13B is a schematic plan view illustrating the electrostatic chuck and an alignment mark according to Embodiment 1 in a state where the electrostatic chuck and the alignment mark are not overlapped with each other.

FIG. 14 is a flowchart illustrating a flow of a substrate bonding process executed by the substrate bonder according to Embodiment 1.

FIG. 15A is a schematic sectional view illustrating a state where central portions of substrates held by the stage and the head according to Embodiment 1 are set free from the stage and the head.

FIG. 15B is a schematic sectional view illustrating a state where central portions of bonding surfaces of the substrates held by the stage and the head according to Embodiment 1 are in contact with each other.

FIG. 16A is a schematic sectional view illustrating a state where the substrates held by the stage and the head according to Embodiment 1 are being brought close to each other.

FIG. 16B is a schematic sectional view illustrating a state where the substrates held by the stage and the head according to Embodiment 1 are being brought close to each other.

FIG. 17A is a schematic sectional view illustrating a state where peripheral portions of bonding surfaces of the substrates held by the stage and the head according to Embodiment 1 are in contact with each other.

FIG. 17B is a schematic sectional view illustrating a state where the head according to Embodiment 1 is being detached from the stage.

FIG. 18 includes diagrams illustrating a distribution of positional shift vectors obtained from a captured image in the inspection device according to Embodiment 1, illustrating a case where a horizontal offset vector and a projection offset amount are not corrected at the time of bonding substrates to each other, in which (A) is a diagram illustrating a positional shift vectors representing a positional shift amount and a positional shift direction of each alignment mark, (B) is a diagram illustrating XY-direction components of the positional shift vectors, (C) is a diagram illustrating rotation-direction components of the positional shift vectors, (D) is a diagram illustrating warpage components of the positional shift vectors, and (E) is a diagram illustrating distortion components of the positional shift vectors.

FIG. 19A is a diagram for describing an offset vector of an alignment mark.

FIG. 19B is a diagram for describing an offset vector of an alignment mark.

FIG. 19C is a diagram for describing an offset vector of an alignment mark.

FIG. 19D is a diagram for describing an offset vector of an alignment mark.

FIG. 19E is a diagram for describing an offset vector of an alignment mark.

FIG. 20A is a schematic plan view illustrating a state where an electrostatic chuck and an alignment mark according to a comparative example are overlapped with each other.

FIG. 20B is a schematic plan view illustrating the electrostatic chuck and the alignment mark according to the comparative example in a state where the orientation of a substrate has been changed.

FIG. 21A is a schematic plan view of a stage and a head according to Embodiment 2.

FIG. 21B is a sectional view of the stage and the head according to Embodiment 2 taken along the line C-C in FIG. 21A.

FIG. 22A is a schematic sectional view illustrating a state where central portions of bonding surfaces of the substrates held by the stage and the head according to Embodiment 2 are in contact with each other.

FIG. 22B is a schematic sectional view illustrating a state where pressing members respectively abut substrates held by the stage and the head according to Embodiment 2.

FIG. 23A is a schematic sectional view illustrating a state where the substrates held by the stage and the head according to Embodiment 2 are being brought close to each other.

FIG. 23B is a schematic sectional view illustrating a state where peripheral portions of bonding surfaces of the substrates held by the stage and the head according to Embodiment 2 are in contact with each other.

FIG. 24A is a schematic plan view of a stage and a head according to a modification.

FIG. 24B is an enlarged view of a part of the stage and the head according to the modification.

FIG. 25A is a schematic plan view of a stage and a head according to a modification.

FIG. 25B is an enlarged view of a part of the stage and the head according to the modification.

FIG. 26A is a schematic plan view of a stage and a head according to a modification.

FIG. 26B is a schematic sectional view of the stage and the head according to the modification taken along the line D-D in FIG. 26A.

FIG. 27A is a plan view of a part of a second region of a stage and a head according to a modification.

FIG. 27B is a schematic sectional view of the stage and the head according to the modification taken along the line E-E in FIG. 26A.

FIG. 28 is a schematic plan view of a stage and a head according to a modification.

FIG. 29 is a sectional view of a stage and a head according to a modification.

FIG. 30 is a schematic plan view of an imaging unit according to a modification.

FIG. 31 is a schematic front view of an activation processing device according to a modification.

FIG. 32 is a flowchart illustrating a flow of a substrate bonding process executed by a substrate bonder according to a modification.

### DESCRIPTION OF EMBODIMENTS

### Embodiment 1

Hereinafter, a substrate bonder according to an embodiment of the present invention will be described with reference to the drawings. The substrate bonder according to the present embodiment bonds two substrates by bringing the two substrates subjected to activation processing with respect to bonding surfaces to be bonded to each other into contact with each other in a vacuum chamber having a degree of vacuum equal to or higher than a preset reference degree of vacuum.

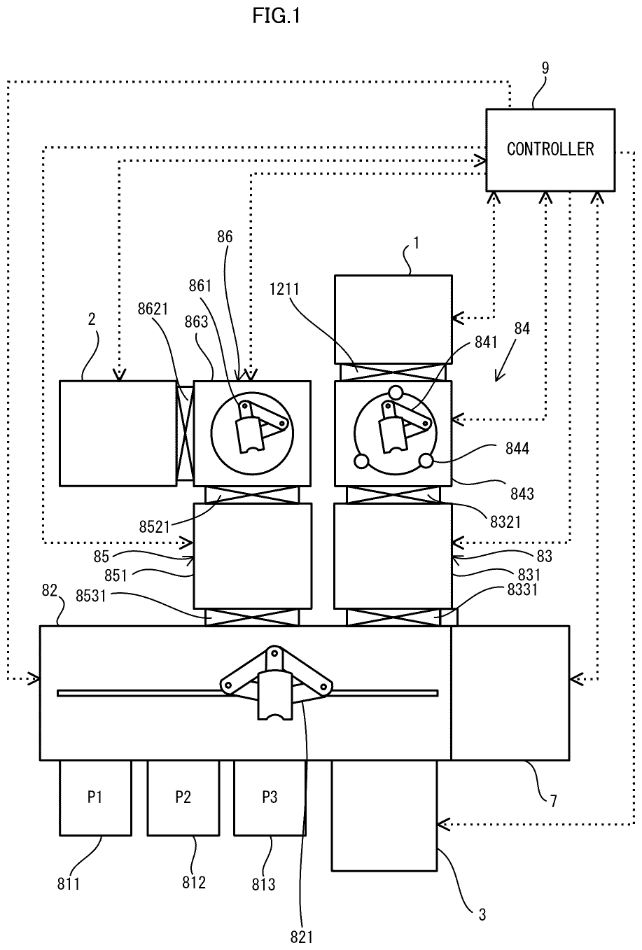

As illustrated in FIG. 1, the substrate bonding system according to the present embodiment includes introduction ports 811 and 812, an extraction port 813, conveyance devices 82, 84, and 86, a cleaning device 3, an activation processing device 2, a substrate bonder 1, load lock units 83 and 85, an inspection device 7, and a controller 9 that controls operation of the conveyance devices 82, 84, and 86, the cleaning device 3, the activation processing device 2, the substrate bonder 1, the load lock units 83 and 85, and the inspection device 7. The conveyance device 82 includes a conveyance robot 821 having an arm provided with a holding unit for holding a substrate at a distal end. The conveyance robot 821 is movable along an arrangement direction of the introduction ports 811 and 812 and the extraction port 813 and can change the direction of the distal end of the arm by turning. The conveyance device 82 is provided with a high efficiency particulate air (HEPA) filter (not illustrated). This brings the inside of the conveyance device 82 in an atmospheric pressure environment with extremely few particles.

The cleaning device 3 cleans a conveyed substrate while discharging water, a cleaning liquid, or N₂ gas toward the substrate. The cleaning device 3 includes a stage (not illustrated) that supports the substrate, a rotation drive unit (not illustrated) that rotates the stage in a plane orthogonal to a vertical direction, and a cleaning nozzle (not illustrated) that discharges water, the cleaning liquid, or N₂ gas to which ultrasonic waves or megasonic vibrations have been applied. Then, the cleaning device 3 cleans the entire surfaces of the bonding surfaces of substrates W1 and W2 by rotating the stage while spraying water to which ultrasonic waves are applied from the cleaning nozzle to the bonding surfaces of the substrates and swinging the cleaning nozzle in a radial direction of the substrates W1 and W2. Then, the cleaning device 3 spin-dries the substrates W1 and W2 by rotating the stage in a state where discharge of water with the cleaning nozzle is stopped. Similarly to the conveyance device 82, the cleaning device 3 is provided with a HEPA filter (not illustrated).

The load lock unit 83 includes a chamber 831, an exhaust pipe (not illustrated) communicating with the inside of the chamber 831, a vacuum pump (not illustrated) that exhausts gas inside the chamber 831 through the exhaust pipe, and an exhaust valve (not illustrated) inserted in the exhaust pipe. The load lock unit 83 reduces (decompresses) the air pressure in the chamber 831 by opening the exhaust valve and operating the vacuum pump to discharge the gas in the chamber 831 to the outside of the chamber 831 through the exhaust pipe. The load lock unit 83 includes a gate 8331 disposed on the conveyance device 82 side in the chamber 831, a gate 8321 disposed on the conveyance device 84 side in the chamber 831, and gate drive units 8332 and 8322 that open and close the gates 8331 and 8321, respectively. The load lock unit 83 includes an alignment mechanism (not illustrated) that adjusts the orientations of the substrates W1 and W2 in the chamber 831. The gates 8331 and 8321 are provided so as to cover an opening (not illustrated) penetrating on the conveyance device 82 side and an opening (not illustrating) penetrating on the chamber 84 side in the chamber 831, respectively. The load lock unit 83 includes a chamber 831, an exhaust pipe (not illustrated) communicating with the inside of the chamber 831, a vacuum pump (not illustrated) that exhausts gas inside the chamber 831 through the exhaust pipe, and an exhaust valve (not illustrated) inserted in the exhaust pipe. The load lock unit 83 reduces (decompresses) the air pressure in the chamber 831 by opening the exhaust valve and operating the vacuum pump to discharge the gas in the chamber 831 to the outside of the chamber 831 through the exhaust pipe. The chamber 831 is connected to the conveyance device 82 via the gate 8331, and is connected to the conveyance device 84 via the gate 8321. Similarly to the load lock unit 83, the load lock unit 85 includes a chamber 851, an exhaust pipe (not illustrated), a vacuum pump (not illustrated), and an exhaust valve (not illustrated). The chamber 851 is connected to the conveyance device 82 via the gate 8531, and is connected to the conveyance device 86 via the gate 8521.

The conveyance device 84 includes a chamber 843, an exhaust pipe (not illustrated) communicating with the inside of the chamber 843, a vacuum pump (not illustrated) that exhausts gas inside the chamber 843 through the exhaust pipe, an exhaust valve (not illustrated) inserted in the exhaust pipe, and a conveyance robot 841 that conveys the substrates W1 and W2. The conveyance device 84 keeps the inside of the chamber 843 in a decompressed state by opening the exhaust valve and operating the vacuum pump to discharge the gas in the chamber 843 to the outside of the chamber 843 through the exhaust pipe. The chamber 843 is connected to the substrate bonder 1 via the gate 1211, and is connected to the load lock unit 83 via the gate 8321. The gate 1211 is in an open state when the conveyance robot 841 conveys the substrates W1 and W2 into the substrate bonder 1. The conveyance robot 841 has an arm provided with a holding unit for holding a substrate at a distal end, and can change the direction of the distal end of the arm by turning. The holding unit is, for example, an electrostatic chuck, and it sucks and holds a side of the substrates W1 and W2 opposite to the bonding surface side. The conveyance device 84 includes a conveyance device imaging unit 844 that captures images of a plurality of portions of the peripheral portions of the substrates W1 and W2.

Similarly to the conveyance device 84, the conveyance device 86 includes a chamber 863, an exhaust pipe (not illustrated), a vacuum pump (not illustrated), an exhaust valve (not illustrated), and a conveyance robot 861. The chamber 863 is connected to the activation processing device 2 via the gate 8621, and is connected to the load lock unit 85 via the gate 8521. Similarly to the conveyance robot 841, the conveyance robot 861 has an arm provided with a holding unit for holding a substrate at a distal end, and can change the direction of the distal end of the arm by turning. The holding unit is, for example, an electrostatic chuck, and it sucks and holds a side of the substrates W1 and W2 opposite to the bonding surface side.

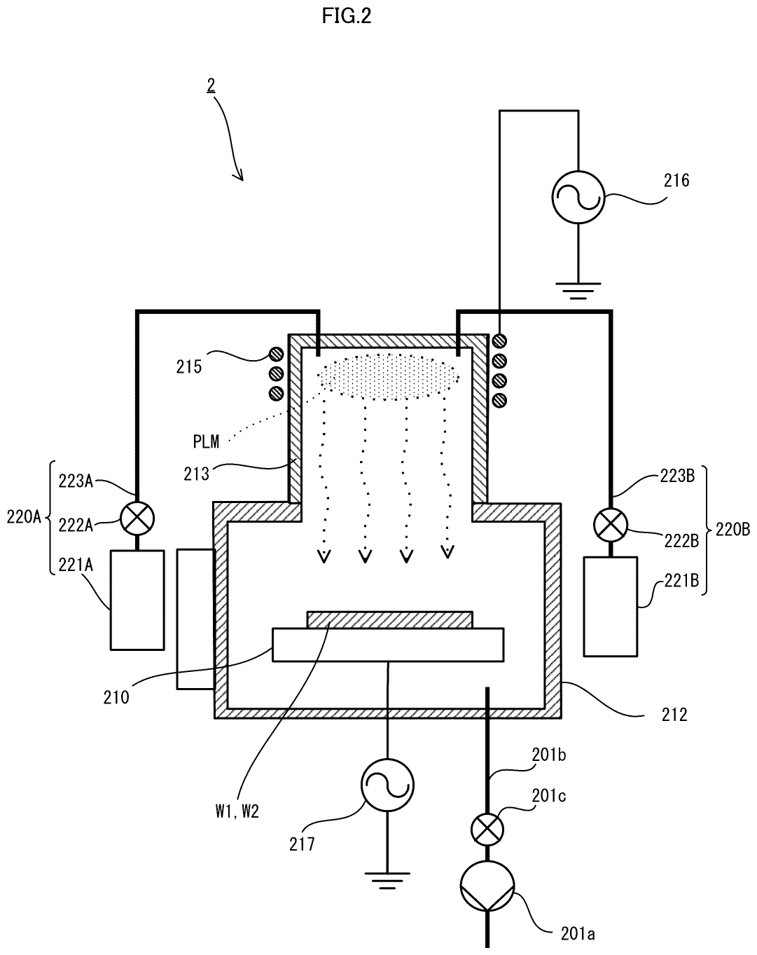

The activation processing device 2 performs activation processing of activating the bonding surface of the substrate by performing at least one of reactive ion etching using nitrogen gas and irradiation with nitrogen radicals with respect to the bonding surface. The activation processing device 2 is a device that generates inductively coupled plasma (ICP), including a stage 210, a processing chamber 212, a plasma chamber 213, an induction coil 215 wound outside the plasma chamber 213, and a high-frequency power source 216 that supplies a high-frequency current to the induction coil 215 as illustrated in FIG. 2. The plasma chamber 213 is formed of, for example, quartz glass. The activation processing device 2 includes a nitrogen gas supply unit 220A and an oxygen gas supply unit 220B. The nitrogen gas supply unit 220A includes a nitrogen gas storage unit 221A, a supply valve 222A, and a supply pipe 223A. The oxygen gas supply unit 220B includes an oxygen gas storage unit 221B, a supply valve 222B, and a supply pipe 223B. The substrates W1 and W2 are placed on the stage 210. The processing chamber 212 communicates into the plasma chamber 213. The processing chamber 212 is connected to a vacuum pump 201a via an exhaust pipe 201b and an exhaust valve 201c. The activation processing device 2 reduces (decompresses) the air pressure in the chamber 212 by opening the exhaust valve 201c and operating the vacuum pump 201a to discharge the gas in the chamber 212 to the outside of the chamber 212 through the exhaust pipe 201b.

As the high-frequency power source 216, one that supplies a high-frequency current of, for example, 27 MHz to the induction coil 215 can be adopted. Then, when a high-frequency current is supplied to the induction coil 215 in a state where N₂ gas is introduced into the plasma chamber 213, plasma PLM is formed in the plasma chamber 213. Here, since ions contained in the plasma are trapped in the plasma chamber 213 by the induction coil 215, there may be no trap plate in a portion between the plasma chamber 213 and the processing chamber 212. A plasma generation source that generates plasma PLM in the plasma chamber 213 and supplies N₂ radicals in the plasma to the bonding surfaces of the substrates W1 and W2 supported by the stage 210 is configured from the induction coil 215, the high-frequency power source 216, and the nitrogen gas supply unit 220A. Here, an example has been described in which the activation processing device 2 is a device that generates ICP, including the induction coil 215 and the high-frequency power source 216, but the activation processing device 2 is not limited to this configuration. The activation processing device 2 may be a device that generates capacitively coupled plasma (CCP), including a flat plate electrode disposed outside the plasma chamber 213, a high-frequency power source electrically connected to the flat plate electrode, and a trap plate disposed in a portion between the plasma chamber 213 and the processing chamber 212 to trap ions in the plasma. In this case, as the high-frequency power source, for example, one that applies a high-frequency bias of 27 MHz can be adopted. Then, the power to be supplied from the high-frequency power source into the plasma chamber is set to, for example, 250 W. A bias application unit 217 is a high-frequency power source that applies a high-frequency bias to the substrates W1 and W2 supported by the stage 210. As the bias application unit 217, for example, one that generates a high-frequency bias of 13.56 MHz can be adopted. By applying a high-frequency bias to the substrates W1 and W2 with the bias application unit 217 like this, a sheath region is generated in which ions having kinetic energy repeatedly collide with the substrates W1 and W2 in the vicinity of the bonding surfaces of the substrates W1 and W2. Then, the bonding surfaces of the substrates W1 and W2 are etched by ions having kinetic energy present in the sheath region.

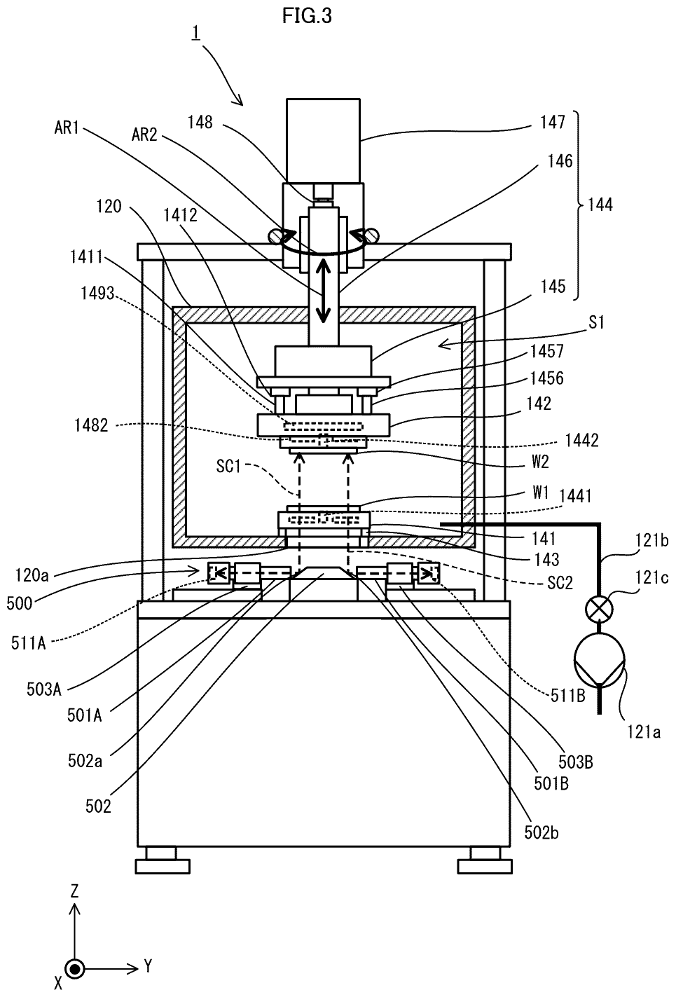

As illustrated in FIG. 3, the substrate bonder 1 includes a chamber 120, a stage 141 as a first substrate holding unit, a head 142 as a second substrate holding unit, a stage drive unit 143, a head drive unit 144, substrate heating units 1481 and 1482, and a position measurement unit 500. In addition, the substrate bonder 1 includes a distance measurement unit 1493 that measures the distance between the stage 141 and the head 142. In the following description, the ±Z directions in FIG. 1 are defined as up-down directions, and the XY directions are defined as horizontal directions as appropriate. The chamber 120 maintains the region S1 where the substrates W1 and W2 are disposed at a degree of vacuum equal to or higher than a preset reference degree of vacuum. The chamber 120 is connected to a vacuum pump 121a via an exhaust pipe 121b and an exhaust valve 121c. When the exhaust valve 121c is opened and the vacuum pump 121a is operated, the gas in the chamber 120 is discharged to the outside of the chamber 120 through the exhaust pipe 121b, and the inside of the chamber 120 is maintained in a decompressed atmosphere. In addition, the air pressure (degree of vacuum) in the chamber 120 can be adjusted by changing the opening/closing amount of the exhaust valve 121c to adjust the exhaust amount. A window 120a used to measure the relative position between the substrates W1 and W2 with the position measurement unit 500 is provided in a part of the chamber 120.

The stage drive unit 143 is a holding unit drive unit capable of moving the stage 141 in the XY directions or rotating the stage around the Z axis.

The head drive unit 144 includes a lift drive unit 146 that lifts and lowers the head 142 vertically upward or downward (see the arrows AR1 in FIG. 3), an XY-direction drive unit 145 that moves the head 142 in the XY directions, and a rotation drive unit 147 that rotates the head 142 in a rotation direction around the Z axis (see the arrows AR2 in FIG. 3). The XY-direction drive unit 145 and the rotation drive unit 147 constitute a holding unit drive unit that moves the head 142 in the directions (XY directions, rotation direction around Z axis) orthogonal to the vertical directions. The head drive unit 144 includes a piezo actuator 1456 for adjusting the inclination of the head 142 with respect to the stage 141 and a first pressure sensor 1457 for measuring the pressure applied to the head 142. The XY-direction drive unit 145 and the rotation drive unit 147 move the head 142 relative to the stage 141 in the X directions, the Y directions, and the rotation direction around the Z axis, and thus the substrate W1 held by the stage 141 and the substrate W2 held by the head 142 can be aligned.

The lift drive unit 146 moves the head 142 in the vertical directions to bring the stage 141 and the head 142 close to each other or move the head 142 away from the stage 141. When the lift drive unit 146 moves the head 142 vertically downward, the substrate W1 held by the stage 141 and the substrate W2 held by the head 142 come into contact with each other. Then, in a state where the substrates W1 and W2 are in contact with each other, when the lift drive unit 146 applies a drive force to the head 142 in a direction approaching the stage 141, the substrate W2 is pressed against the substrate W1. The lift drive unit 146 is provided with a pressure sensor 148 that measures a drive force applied by the lift drive unit 146 to the head 142 in the direction approaching the stage 141. The pressure acting on the bonding surfaces of the substrates W1 and W2 when the substrate W2 is pressed against the substrate W1 by the lift drive unit 146 can be detected from the measurement value of the pressure sensor 148. The pressure sensor 148 is formed of, for example, a load cell.

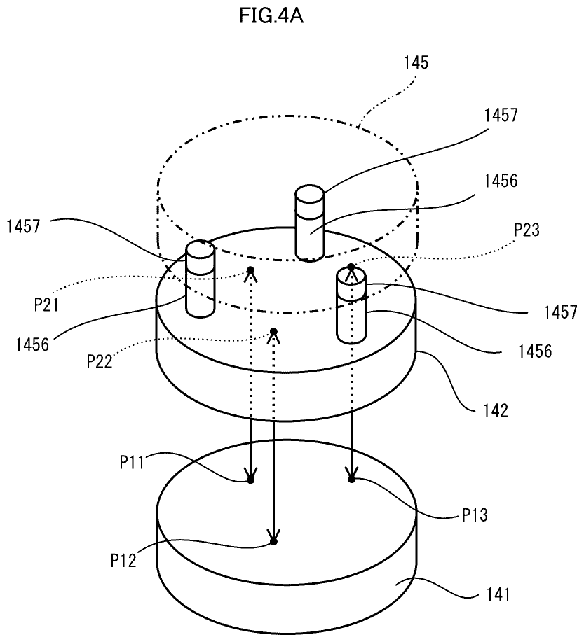

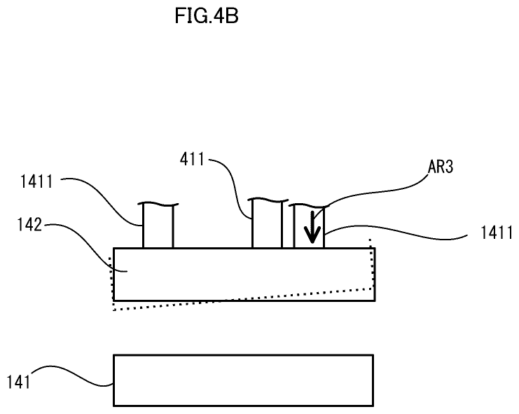

As illustrated in FIG. 4A, there are three piezo actuators 1456 and three first pressure sensors 1457. The three piezo actuators 1456 and the three first pressure sensors 1457 are disposed between the head 142 and the XY-direction drive unit 145. The three piezo actuators 1456 are fixed to three positions not on the same straight line on the upper surface of the head 142, the three positions being arranged at substantially equal intervals along the circumferential direction of the head 142 on the peripheral portion of the upper surface of the head 142 having a substantially circular shape in plan view. Each of the three first pressure sensors 1457 connects the upper end of the piezo actuator 1456 and the lower surface of the XY-direction drive unit 145. Each of the three piezo actuators 1456 can expand and contract in the up-down directions. As the three piezo actuators 1456 expand and contract, the inclination of the head 142 around the X axis and the Y axis and the position of the head 142 in the vertical direction are finely adjusted. For example, as indicated by the broken line in FIG. 4B, when the head 142 is inclined with respect to the stage 141, the lower surface of the head 142 and the upper surface of the stage 141 can be brought into a substantially parallel state to each other by expanding one of the three piezo actuators 1456 (see the arrow AR3 in FIG. 4B) and finely adjusting the orientation of the head 142. The three pressure sensors 1457 measure the pressure at three positions on the lower surface of the head 142. Then, by driving each of the three piezo actuators 1456 such that the pressurizing forces measured by the three pressure sensors 1457 become equal, the substrates W1 and W2 can be brought into contact with each other while maintaining the lower surface of the head 142 and the upper surface of the stage 141 substantially in parallel.

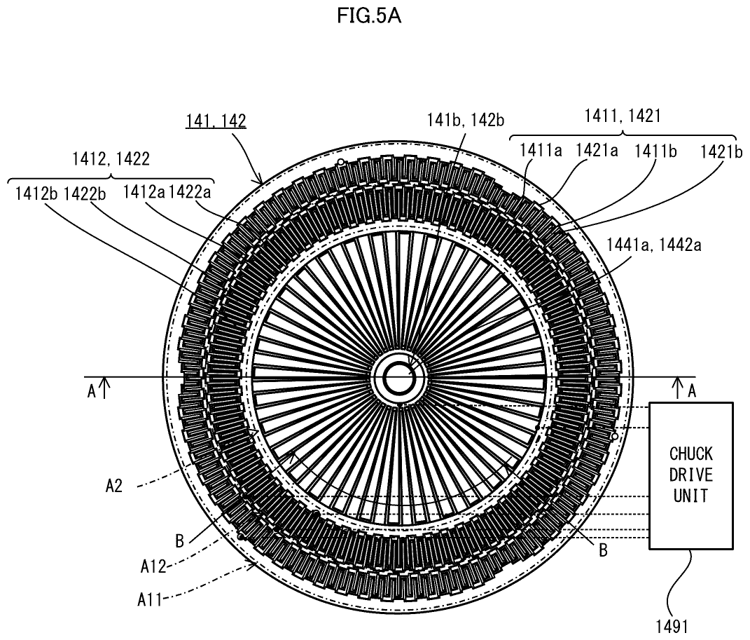

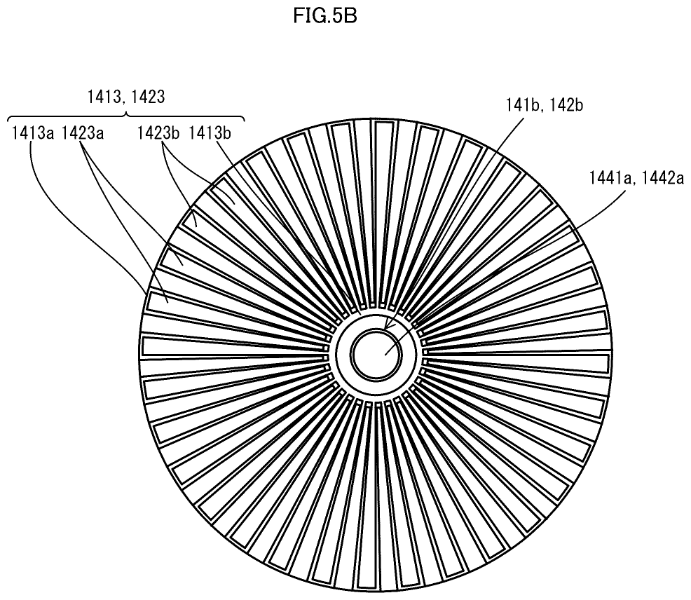

The stage 141 and the head 142 are disposed to face each other in the vertical direction in the chamber 120. The stage 141 is a first substrate holding unit that holds the substrate W1 on its upper surface, and the head 142 is a second substrate holding unit that holds the substrate W2 on its lower surface. Here, the stage 141 supports the substrate W1 in a state where the upper surface thereof is in surface contact with the entire substrate W1, and the head 142 supports the substrate W2 in a state where the lower surface thereof is in surface contact with the entire substrate W2. The stage 141 and the head 142 are made of a translucent material such as glass having translucency, for example. As illustrated in FIGS. 5A and 5B, the stage 141 and the head 142 are provided with electrostatic chucks 1411, 1412, 1413, 1421, 1422, and 1423 that hold the substrates W1 and W2. The electrostatic chucks 1411 and 1421 hold peripheral portions of the substrates W1 and W2. Through holes 141b and 142b having a circular shape in plan view are provided in a central portion of the stage 141 and the head 142. Further, the stage 141 and the head 142 are provided with an air pressure detection unit (not illustrated) that detects the air pressure in the region between the stage 141, the head 142, and the substrates W1 and W2 at a time when gas is discharged from gas discharge holes 1411c and 1421c to be described later.

The electrostatic chucks 1411, 1412, 1421, and 1422 are first electrostatic chucks provided in an annular first region A1 facing the peripheral portions of the substrates W1 and W2 in the stage 141 and the head 142 in a state where the substrates W1 and W2 are held by the stage 141 and the head 142. The electrostatic chucks 1411 and 1412 are respectively provided in two sub-annular regions A11 and A12 set in advance around the central portion of the stage 141 in the first region A1 of the stage 141. Then, the electrostatic chucks 1411 and 1412 hold portions facing the two sub-annular regions A11 and A12, respectively, in the substrate W1 disposed at a preset substrate holding position in the stage 141. The electrostatic chucks 1421 and 1422 are also respectively provided in two sub-annular regions A11 and A12 set in advance around the central portion of the stage 142 in the first region A1 of the stage 142. Then, the electrostatic chucks 1421 and 1422 hold portions facing the two sub-annular regions A11 and A12, respectively, in the substrate W2 disposed at a preset substrate holding position in the stage 142. Here, the substrate holding position is set to a position that coincides with the first region A1, for example when the external dimensions of the substrates W1 and W2 are the same as the first region A1.

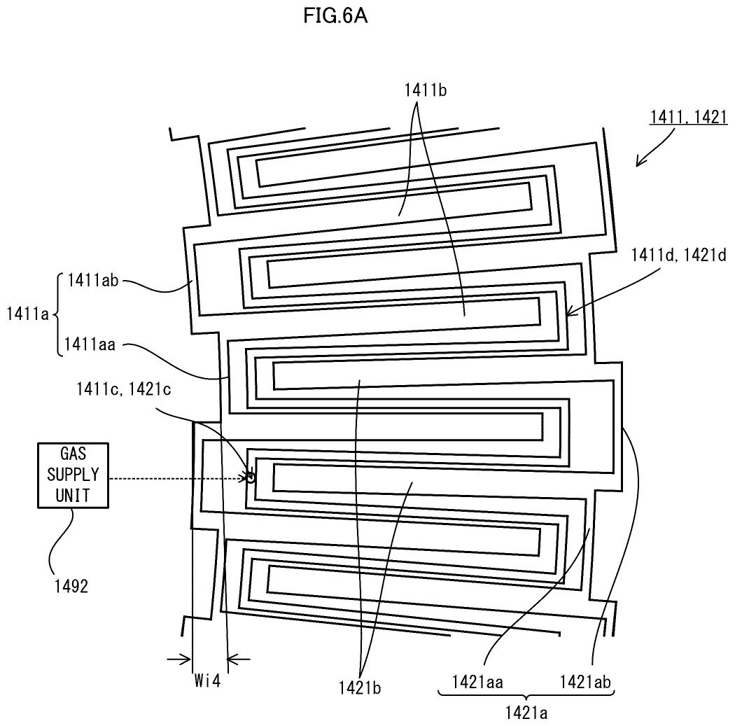

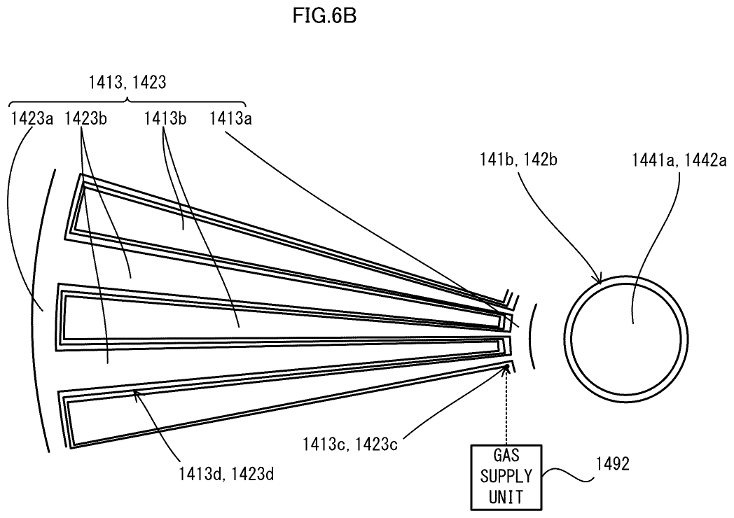

The electrostatic chucks 1411 and 1421 includes, in the first region A1, a plurality of electrode elements 1411b and 1412b radially extending in a direction from the central portion of the stage 141 and the head 142 toward the peripheral edges of the stage 141 and the head 142, respectively, and two annular terminal electrodes 1411a and 1421a disposed along the circumferential direction of the stage 141 and the head 142, respectively. The plurality of electrode elements 1411b and 1412b are first electrode elements extending from the two terminal electrodes 1411a and 1421a toward the other terminal electrodes 1411a and 1421a along the radial direction of the two terminal electrodes 1421a and 1411a, respectively. Here, the terminal electrodes 1411a and 1421a correspond to a third terminal electrode and a fourth terminal electrode. The terminal electrode 1411a has a smaller diameter than the terminal electrode 1421a and is disposed on the central portion side of the stage 141 and the head 142. The plurality of elongated electrode elements 1411b and 1421b are alternately arranged in the circumferential direction of the first region A1 in the stage 141 and the head 142. As illustrated in FIG. 6A, the terminal electrodes 1411a and 1421a include bent portions 1411ab and 1421ab that are bent to project in a direction away from the other terminal electrodes 1411a and 1421a in plan view, respectively, and long and thin coupling portions 1411aa and 1421aa that extend along the circumferential direction of the stage 141 and the head 142 and couple ends of two bent portions 1411ab and 1421ab adjacent to each other in the circumferential direction of the stage 141 and the head 142, respectively. A maximum width Wi4 between the bent portions 1411ab and 1421ab and the coupling portions 1411aa and 1421aa in the radial direction of the stage 141 and the head 142 is set to be longer than a width of an alignment mark described later, for example.

The electrostatic chucks 1412 and 1422 also include, in the first region A1, a plurality of electrode elements 1412b and 1422b radially extending in a direction from the central portion of the stage 141 and the head 142 toward the peripheral edge of the stage 141 and the head 142, respectively, and two annular terminal electrodes 1412a and 1422a disposed along the circumferential direction of the stage 141 and the head 142, respectively. The plurality of electrode elements 1412b and 1422b are first electrode elements extending from the two terminal electrodes 1412a and 1422a toward the other terminal electrodes 1422a and 1412a along the radial direction of the two terminal electrodes 1412a and 1422a, respectively. The terminal electrodes 1412a and 1422a correspond to a third terminal electrode and a fourth terminal electrode. The terminal electrode 1412a has a smaller diameter than the terminal electrode 1422a and is disposed on the central portion side of the stage 141 and the head 142. In the first region A1, the electrostatic chucks 1412 and 1422 are disposed inside the electrostatic chucks 1411 and 1421. The plurality of elongated electrode elements 1412b and 1422b are alternately arranged in the circumferential direction of the first region A1 in the first region A1 in the stage 141 and the head 142. The terminal electrodes 1411a, 1421a, 1422a, and 1412a and the plurality of electrode elements 1411b, 1421b, 1412b, and 1422b are made of, for example, metal. In this manner, the electrostatic chucks 1411, 1412, 1421, and 1422 include the plurality of electrode elements 1411b, 1412b, 1421b, and 1422b radially extending in a direction from the central portion of the stage 141 and the head 142 toward the peripheral edge of the stage 141 and the head 142, respectively. As a result, the substrate bonder 1 can capture images of alignment marks MK1a, MK1b, MK1c, MK2a, MK2b, and MK2c provided on the substrates W1 and W2 described later from gaps between the plurality of electrode elements 1411b, 1412b, 1421b, and 1422b with imaging units 501A, 501B, and 501C described later.

In the sub-annular region A11 of the first region A1 in the stage 141 and the head 142, grooves 1411d and 1421d are formed, each of which has a portion radially extending in a direction from the central portion of the stage 141 and the head 142 toward the peripheral edge of the stage 141 and the head 142. The grooves 1411d and 1421d are partially provided with gas discharge holes 1411c and 1421c connected to the gas supply unit 1492. The gas discharge holes 1411c and 1421c correspond to gas discharge units that discharge gas, and the grooves 1411d and 1421d correspond to second recesses communicating with the gas discharge holes 1411c and 1412c. Here, the width of the grooves 1411d and 1421d is set to, for example, about 0.2 mm. The grooves 1411d and 1421d have portions extending along the extending directions of the plurality of electrode elements 1411b and 1412b, respectively. The grooves 1411d and 1421d are provided between the plurality of electrode elements 1411b electrically connected to the terminal electrode 1411a and the plurality of electrode elements 1412b connected to the terminal electrode 1421a in the electrostatic chucks 1411 and 1412. Also in the sub-annular region A12 of the first region A1 in the stage 141 and the head 142, grooves (not illustrated) are formed, a part of which radially extends in a direction from the central portion of the stage 141 and the head 142 toward the peripheral edge of the stage 141 and the head 142. The grooves 1411d and 1421d are partially provided with gas discharge holes (not illustrated) connected to the gas supply unit 1492. The gas discharge hole provided in the sub-annular region A12 also corresponds to a gas discharge unit that discharges gas, and the grooves provided in the sub-annular region A12 also corresponds to second grooves constituting a second recess communicating with the gas discharge hole provided in the sub-annular region A12. The grooves also have portions extending along the extending directions of the plurality of electrode elements 1411b and 1412b, respectively. The grooves 1411d and 1421d are provided between the plurality of electrode elements 1421b electrically connected to the terminal electrode 1411a and the plurality of electrode elements 1412b connected to the terminal electrode 1421a in the electrostatic chucks 1421 and 1422.

The electrostatic chucks 1413 and 1423 are second electrostatic chucks provided in the second region A2 inside the first region A1 in the stage 141 and the head 142. As illustrated in FIG. 5B, the electrostatic chucks 1413 and 1423 include, in the second region A2, a plurality of electrode elements 1413b and 1423b radially extending in a direction from the central portion of the stage 141 and the head 142 toward the peripheral edge of the stage 141 and the head 142, respectively, and two annular terminal electrodes 1413a and 1423a disposed along the circumferential direction of the stage 141 and the head 142, respectively. The plurality of electrode elements 1413b and 1423b are second electrode elements extending from the two terminal electrodes 1413a and 1423a toward the other terminal electrodes 1423a and 1413a, respectively, along the radial direction of the stage 141 and the head 142. As illustrated in FIG. 6B, each of the plurality of electrode elements 1413b and 1423b has a wedge shape in plan view in which the width in the direction orthogonal to the extending direction in plan view becomes wider toward the peripheral edge side of the stage 141 and the head 142. The terminal electrodes 1413a and 1423a correspond to a first terminal electrode electrically connected to the plurality of electrode elements 1413b and a second terminal electrode electrically connected to the plurality of electrode elements 1423b, respectively.

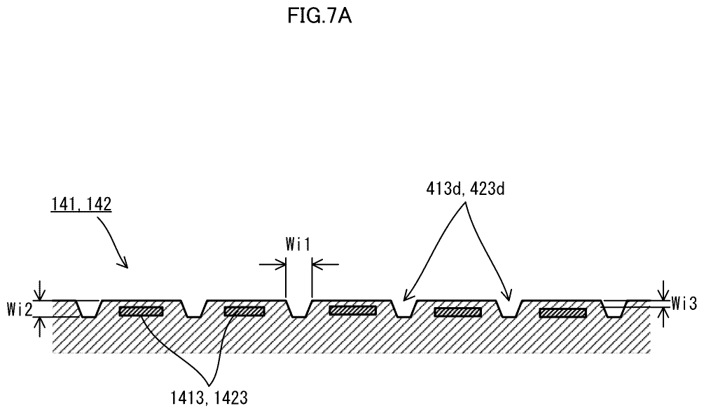

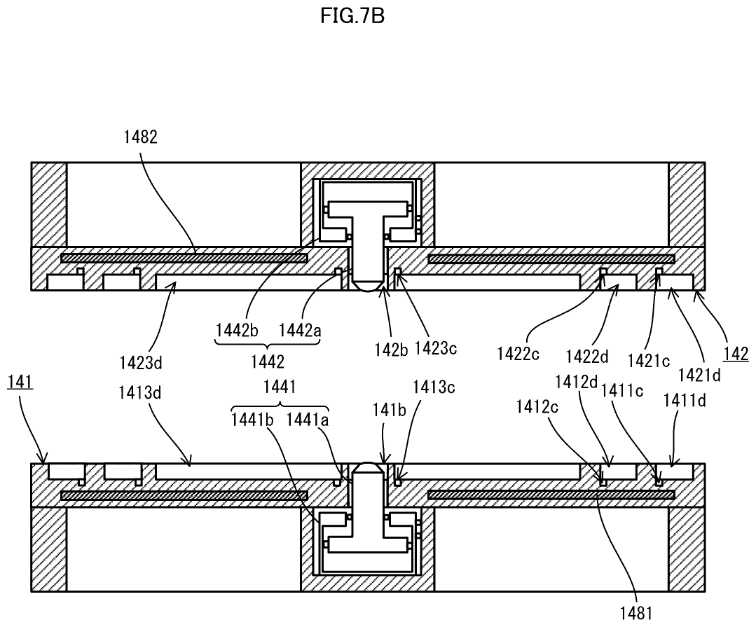

In the second region A2 of the stage 141 and the head 142, grooves 1413d and 1423d are formed, each of which has a portion radially extending in a direction from the central portion of the stage 141 and the head 142 toward the peripheral edge of the stage 141 and the head 142. The grooves 1413d and 1423d in the stage 141 and the head 142 are partially provided with gas discharge holes 1413c and 1423c connected to the gas supply unit 1492, respectively. The gas discharge holes 1413c and 1423c correspond to gas discharge units that discharge gas, and the grooves 1413d and 1423d correspond to first recesses that configures a first recess communicating with the gas discharge holes 1413c and 1423c. Here, the width Wi1 of the grooves 1413d and 1423d is set to, for example, about 0.2 mm. The grooves 1413d and 1423d have portions extending along the extending directions of the plurality of electrode elements 1413b and 1423b, respectively. The grooves 1413d and 1423d are provided between the plurality of electrode elements 1413b electrically connected to the terminal electrode 1413a and the plurality of electrode elements 1423b connected to the terminal electrode 1423a in the electrostatic chucks 1413 and 1423. In addition, as illustrated in FIG. 7A, a width Wi3 between the electrostatic chucks 1413 and 1423 and the surfaces of the stage 141 and the head 142 is set to be shorter than a depth Wi2 of the grooves 1413d and 1423d. For example, when the substrates W1 and W2 are sapphire substrates or glass substrates, the width is set to be 0.05 mm or more and 0.1 mm or less. When the substrates W1 and W2 are Si substrates, the width can be set to about 5 mm. The terminal electrodes 1413a and 1423a and the plurality of electrode elements 1413b and 1423b are formed of a transparent conductive film containing a transparent conductive material such as ITO, for example.

The electrostatic chucks 1411, 1412, 1413, 1421, 1422, and 1423 are connected to the chuck drive unit 1491. The chuck drive unit 1491 drives the electrostatic chucks 1411, 1412, 1413, 1421, 1422, and 1423 by applying a voltage to the electrostatic chucks 1411, 1412, 1413, 1421, 1422, and 1423 based on a control signal input from the controller 9. The chuck drive unit 1491 drives the electrostatic chucks 1411, 1412, 1413, 1421, 1422, and 1423 independently of each other based on a control signal input from the controller 9.

When separating the substrates W1 and W2 from the electrostatic chucks 1411 and 1412, the chuck drive unit 1491 applies a pulse voltage between the two terminal electrodes 1411a and 1412a of the electrostatic chucks 1411 and 1412. When separating the substrates W1 and W2 from the electrostatic chucks 1421 and 1422, the chuck drive unit 1491 applies a pulse voltage between the two terminal electrodes 1421a and 1422a of the electrostatic chucks 1421 and 1422. When separating the substrates W1 and W2 from the electrostatic chucks 1413 and 1423, the chuck drive unit 1491 applies a pulse voltage between the two terminal electrodes 1431a and 1432a of the electrostatic chucks 1413 and 1423. Here, while alternately applying pulse voltages having different polarities between the terminal electrodes 1411a and 1412a (1421a, 1422a, 1431a, 1432a), the chuck drive unit 1491 gradually decreases the amplitude of the pulse voltages. The pulse interval of each pulse voltage is determined in consideration of the discharge time of the stage 141 and the head 142. The pulse width of each pulse voltage may be set equal to each other or may be set to be longer with time. Alternatively, the pulse widths of any selected five or less pulse voltages may be set to be equal. Further, the pulse intervals may be set equal to each other or may be set to be longer with time. Alternatively, any selected four or less pulse intervals may be set to be equal. The gas supply unit 1492 individually supplies gas to the gas discharge holes 1411c, 1421c, 1412c, 1422c, 1413c, and 1423c based on a control signal input from the controller 9 to discharge the gas from the gas discharge holes 1411c, 1421c, 1412c, 1422c, 1413c, and 1423c.

Further, as illustrated in FIG. 7B, the stage 141 and the head 142 include a pressing mechanism 1441 that presses the central portion of the substrate W1 and a pressing mechanism 1442 that presses the central portion of the substrate W2. The pressing mechanism 1441 is provided at the central portion of the stage 141, and the pressing mechanism 1442 is provided at the central portion of the head 142. The pressing mechanism 1441 includes a pressing unit 1441a that can project and retract toward the head 142 through the through hole 141b of the stage 141, and a pressing drive unit 1441b that drives the pressing unit 1441a. The pressing mechanism 1442 includes a pressing unit 1442a that can project and retract toward the stage 141 through the through hole 142b of the head 142, and a pressing drive unit 1442b that drives the pressing unit 1442a. The pressing drive units 1441b and 1442b include, for example, voice coil motors. The pressing units 1441a and 1442a perform one of pressure control for controlling the pressure applied to the substrates W1 and W2 to be kept constant and position control for controlling the contact positions of the substrates W1 and W2 to be kept constant. For example, when the position of the pressing unit 1441a is controlled and the pressure of the pressing unit 1442a is controlled, the substrates W1 and W2 are pressed at a constant position and with a constant pressure.

The description returns to FIG. 1. The distance measurement unit 1493 is, for example, a laser range finder, and measures the distance between the stage 141 and the head 142 without contacting the stage 141 or the head 142. The distance measurement unit 1493 measures the distance between the stage 142 and the head 141 from the difference between reflected light on the upper surface of the stage 141 and reflected light on the lower surface of the head 142 when laser light is emitted from above the transparent head 142 toward the stage 141. As illustrated in FIG. 4A, the distance measurement unit 1493 measures distances between the three points P11, P12, and P13 on the upper surface of the stage 141 and the three points P21, P22, and P23 facing the sites P11, P12, and P13 in the Z direction on the lower surface of the head 142.

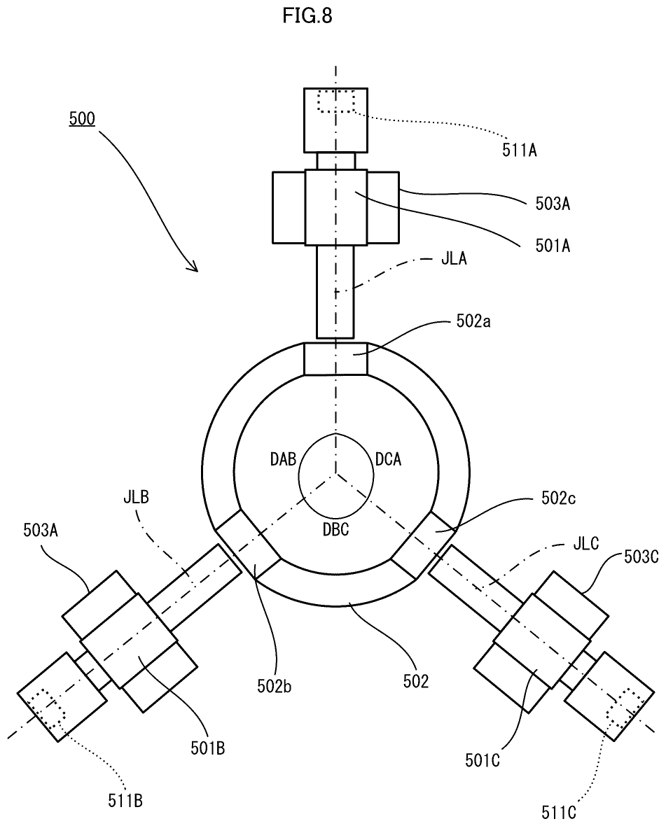

For example, as illustrated in FIG. 8, the position measurement unit 500 includes three imaging units 501A, 501B, and 501C, a reflection member 502, and imaging unit position adjustment units 503A, 503B, and 503C, and measures the positional shift amount between the substrate W1 and the substrate W2 in a direction (XY direction, rotation direction around Z axis) orthogonal to the vertical direction. The three imaging units 501A, 501B, and 501C are disposed around the reflection member 502 such that angles DAB, DBC, and DCA on the acute angle side formed by two optical axes JLA and JLB (JLB and JLC, JLC and JLA) adjacent to each other in the circumferential direction of the reflection member 502 are equal. In the reflection member 502, reflection surfaces 502a, 502b, and 502c are formed at portions facing the three imaging units 501A, 501B, and 501C, respectively. The imaging units 501A, 501B, and 501C and the reflecting member 502 are disposed on the side of the stage 141 opposite to the side holding the substrate W1. Each of the imaging units 501A, 501B, and 501C is a first imaging unit including imaging elements 511A, 511B, and 511C and a coaxial illumination system (not illustrated). As the light source of the coaxial illumination system, a light source that emits light (for example, infrared light) that transmits through the substrates W1 and W2, the stage 141, and the window 120a provided in the chamber 120 is used.

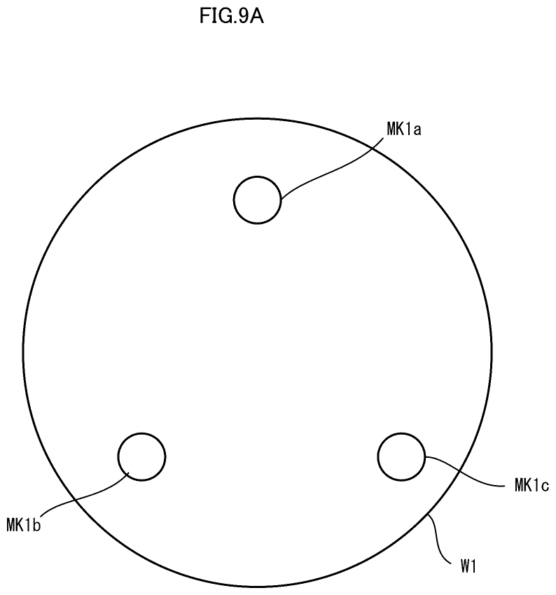

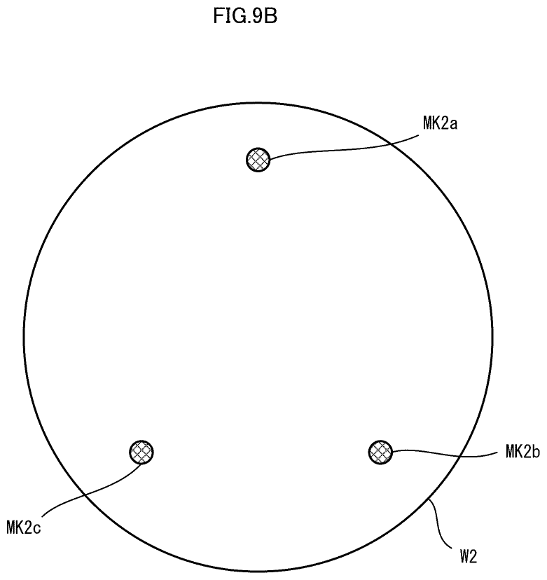

For example, as illustrated in FIGS. 9A and 9B, at least three alignment marks MK1a, MK1b, and MK1c are provided on the substrate W1, and at least three alignment marks MK2a, MK2b, and MK2c are also provided on the substrate W2. Either the alignment marks MK1a, MK1b, and MK1c or the alignment marks MK2a, MK2b, and MK2c corresponds to the first alignment mark, and the other corresponds to the second alignment mark. The substrate bonder 1 executes positioning operation (alignment operation) of the substrates W1 and W2 while recognizing the positions of the alignment marks MK1a, MK1b, MK1c, MK2a, MK2b, and MK2c provided on the substrates W1 and W2 with the position measurement unit 500. More specifically, the substrate bonder 1 first causes the two substrates W1 and W2 to face each other by executing a rough alignment operation of the substrates W1 and W2 while recognizing the alignment marks MK1a, MK1b, NK1c, MK2a, MK2b, and NK2c provided on the substrates W1 and W2 with the position measurement unit 500. Thereafter, the substrate bonder 1 executes more detailed alignment operation (fine alignment operation) while simultaneously recognizing the alignment marks MK1a and MK2a (MK1b and MK2b, MK1c and MK2c) provided on the two substrates W1 and W2 with the position measurement unit 500.

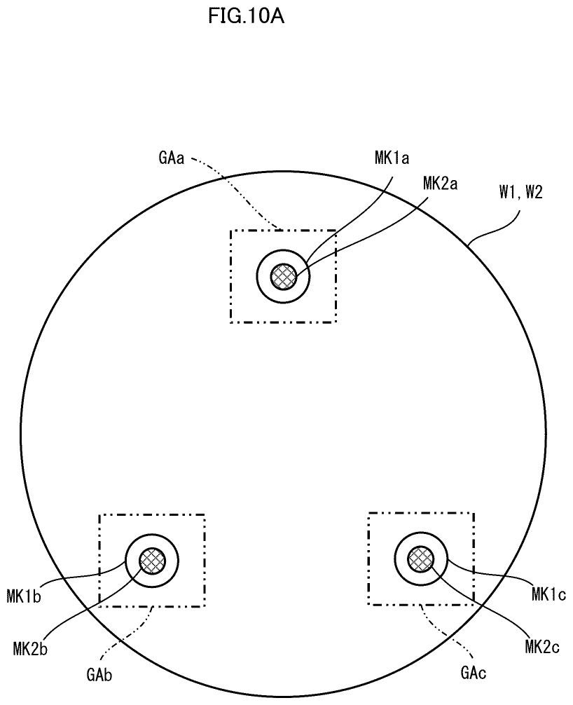

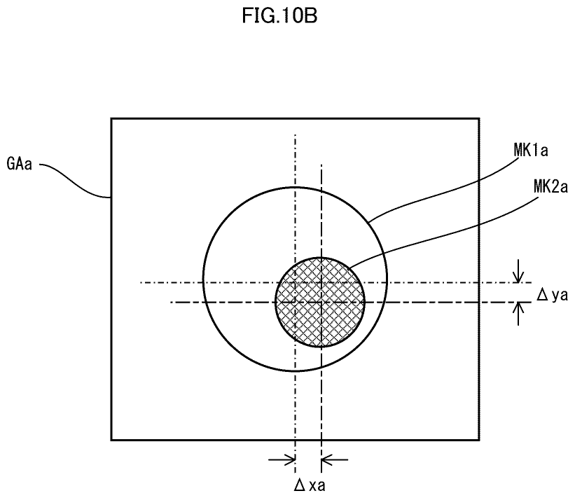

Here, as indicated by the broken line arrows SC1 and SC2 in FIG. 3, the light emitted from the light source of the coaxial illumination system of the imaging unit 501A is reflected by the reflection surface 502a of the reflection member 502 and travels upward, and passes through the window 120a of the chamber 120 and a part or all of the substrates W1 and W2. The light transmitted through a part or all of the substrates W1 and W2 is reflected by the alignment marks MK1a and MK2a of the substrates W1 and W2, travels downward, passes through the window 120a, is reflected by the reflection surface 502a of the reflection member 502, and enters the imaging element 511A of the imaging unit 501A. The light emitted from the light source of the coaxial illumination system of the imaging unit 501B is reflected by the reflection surface 502b of the reflection member 502 and travels upward, and passes through the window 120a of the chamber 120 and a part or all of the substrates W1 and W2. The light transmitted through a part or all of the substrates W1 and W2 is reflected by the alignment marks MK1b and MK2b of the substrates W1 and W2, travels downward, passes through the window 120a, is reflected by the reflection surface 502b of the reflection member 502, and enters the imaging element 511B of the imaging unit 501B. Although not illustrated in FIG. 3, the light emitted from the light source of the coaxial illumination system of the imaging unit 501C illustrated in FIG. 8 is reflected by the reflection surface 502c of the reflection member 502, travels upward, and passes through the window 120a of the chamber 120 and a part or all of the substrates W1 and W2. The light transmitted through a part or all of the substrates W1 and W2 is reflected by the alignment marks MK1c and MK2c of the substrates W1 and W2, travels downward, passes through the window 120a, is reflected by the reflection surface 502c of the reflection member 502, and enters the imaging element 511C of the imaging unit 501C. In this manner, as illustrated in FIGS. 10A and 10B, the position measurement unit 500 acquires a captured image GAa including the alignment marks MK1a and MK2a of the two substrates W1 and W2, a captured image GAb including the alignment marks MK1b and MK2b of the two substrates W1 and W2, and a captured image GAc including the alignment marks MK1c and MK2b of the two substrates W1 and W2. The imaging operation of the captures images GAa, GAb, and GAc with the imaging units 501A, 501B, and 501C is executed substantially simultaneously. The three imaging units 501A, 501B, and 501C capture images of the alignment marks MK1a, MK1b, MK1c, MK2a, MK2b, and MK2c in the first region A1 including the two sub-annular regions A11 and A12 of the stage 141 and the head 142.

The imaging unit position adjustment units 503A, 503B, and 503C move the imaging units 501A, 501B, and 501C in the vertical directions or in the horizontal directions orthogonal to the optical axis of the imaging units 501A, 501B, and 501C and the vertical directions, respectively. Each of the imaging unit position adjustment units 503A, 503B, and 503C includes an imaging unit holding unit (not illustrated) that holds corresponding one of the imaging units 501A, 501B, and 501C, and an actuator (not illustrated) that drives the imaging unit holding unit in the vertical directions and the horizontal directions. The imaging unit position adjustment units 503A, 503B, and 503C can move the imaging positions of the substrates W1 and W2 in a direction orthogonal to the thickness direction of the substrates W1 and W2 by moving the imaging units 501A, 501B, and 501C in the vertical directions or the horizontal directions, respectively.

The description returns to FIG. 3. The substrate heating units 1481 and 1482 are, for example, electric heaters, and are provided on the stage 141 and the head 142, respectively, as illustrated in FIG. 7B. The substrate heating units 1481 and 1482 heat the substrates W1 and W2 by transferring heat to the substrates W1 and W2 held by the stage 141 and the head 142. By adjusting the amount of heat generated by the substrate heating units 1481 and 1482, the temperatures of the substrates W1 and W2 and the bonding surfaces of the substrates can be adjusted. The substrate heating units 1481 and 1482 are connected to a heating unit drive unit (not illustrated), and the heating unit drive unit supplies a current to the substrate heating units 1481 and 1482 based on a control signal input from the controller 9 illustrated in FIG. 1 to cause the substrate heating units 1481 and 1482 to generate heat.

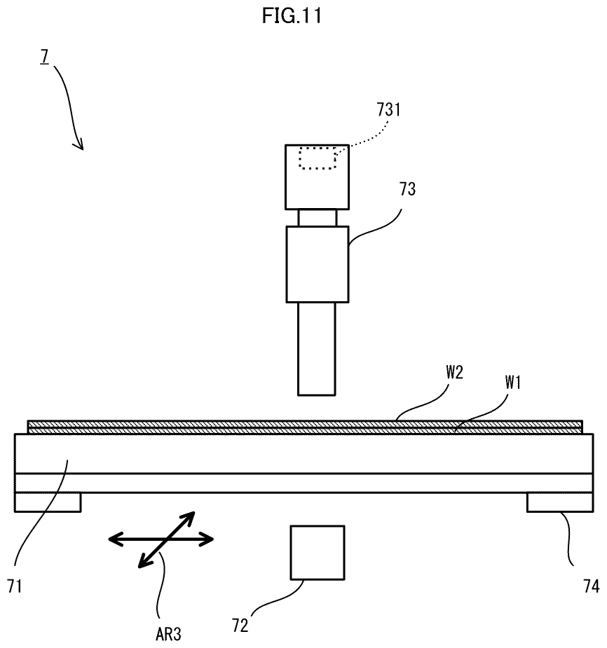

The inspection device 7 detects the positional shift amount of all the alignment marks MK1a, MK1b, MK1c, MK2a, MK2b, and MK2c provided on the substrates W1 and W2 bonded to each other. For example, as illustrated in FIG. 11, the inspection device 7 includes a stage 71 on which the substrates W1 and W2 bonded to each other are placed, a light source 72, an imaging unit 73, and a horizontal direction drive unit 74. The stage 71 is made of a material transparent to light emitted from the light source 72. Then, the light source 72 emits light toward the substrates W1 and W2 from the side of the stage 71 opposite to the side on which the substrates W1 and W2 are placed. The imaging unit 73 is a second imaging unit including an imaging element 731 on which the light passing through the stage 71 and the substrates W1 and W2 among the light emitted from the light source 72 is incident. As indicated by the arrows AR3, the horizontal direction drive unit 74 moves the stage 71 in the horizontal directions orthogonal to the thickness direction of the stage 71.

The description returns to FIG. 1. The controller 9 is a control system including, for example, a personal computer, and includes a central processing unit (CPU) and a memory. The memory stores a program to be executed by the CPU. The controller 9 converts measurement signals input from the pressure sensor 148 and the position measurement unit 150 into measurement information and acquires the measurement information. In addition, the controller 9 converts captured image signals input from the imaging units 501A, 501B, and 501C of the substrate bonder 1, the imaging unit 73 of the inspection device 7, and the conveyance device imaging unit 844 of the conveyance device 84 into captured image information and acquires the captured image information. Further, the controller 9 controls these operations by outputting control signals to the chuck drive unit 1491, the gas supply unit 1492, the imaging unit position adjustment units 503A, 503B, and 503C, the piezo actuator 1456, the pressing drive units 1441b and 1432b, the heating unit drive unit, the stage drive unit 143, and the head drive unit 144 of the substrate bonder 1. As illustrated in FIG. 10B, the controller 9 calculates positional shift amounts dxa and dya between one set of alignment marks MK1a and MK2a provided on the substrates W1 and W2 based on the captured image GAa acquired from the imaging unit 501A. FIG. 10B illustrates a state where one set of alignment marks MK1a and MK2a is shifted from each other. Similarly, the controller 9 calculates positional shift amounts dxb, dyb, dxc, and dyc between other two sets of alignment marks MK1b and MK2b, MK1c and MK2c provided on the substrates W1 and W2 based on the captured images GAb and GAc acquired from the imaging units 501B and 501C. Thereafter, the controller 9 calculates relative positional shift amounts dx, dy, and dθ of the two substrates W1 and W2 in the X directions, the Y directions, and the rotation direction around the Z axis based on the positional shift amounts dxa, dya, dxb, dyb, dxc, and dyc of the three sets of alignment marks and the geometric relationship of the three sets of the marks. Then, the controller 9 moves the head 142 in the X directions and the Y directions or rotates the head about the Z axis so as to reduce the calculated positional shift amounts dx, dy, and de. In this manner, the substrate bonder 1 executes the alignment operation of correcting the positional shift amounts dx, dy, and dθ of the two substrates W1 and W2 in the horizontal directions. In addition, the controller 9 controls these operations by outputting control signals to the activation processing device 2, the conveyance devices 82, 84, and 86, the cleaning device 3, and the inspection device 7.

In addition, when the substrates W1 and W2 are brought into contact with each other on the entire surface in a state where the central portions of the bonding surfaces of the substrates W1 and W2 are in contact with each other and the peripheral portions of the substrates W1 and W2 are held by the electrostatic chucks 1411, 1412, 1421, and 1422, the controller 9 first controls the chuck drive unit 1491 and the gas supply unit 1492 so as to release the holding of the substrates W1 and W2 with the electrostatic chucks 1421 and 1422 after filling the entire groove provided in the sub-annular region A12 with gas from the gas discharge hole provided in the sub-annular region A12 of the first region A1. Next, the controller 9 controls the chuck drive unit 1491 and the gas supply unit 1492 so as to release the holding of the substrates W1 and W2 with the electrostatic chucks 1411, 1412, 1421, and 1422 after filling the entire grooves 1411d and 1412d provided in the sub-annular region A11 with gas from the gas discharge holes 1411c and 1412c provided in the sub-annular region A11 of the first region A1. At this time, the controller 9 controls the flow rate of the gas to be discharged from the gas discharge holes 1411c, 1421c, 1421c, and 1422c based on the air pressure detected by the air pressure detection unit described above so that the air pressure becomes lower than the critical pressure. As a result, the substrates W1 and W2 are in contact with each other on the entire surface.

Further, the controller 9 calculates the positional shift amount and the positional shift direction of each of the plurality of alignment marks of the substrates W1 and W2 based on the captured image obtained by imaging the plurality of alignment marks of the substrates W1 and W2 with the imaging unit 73. Then, the controller 9 separates an axial-direction component along each of the two intersecting axial directions of the positional shift vectors determined by the calculated positional shift amount and positional shift direction, that is, an XY-direction component, and a rotation-direction component, and calculates a horizontal offset vector that is a vector reflecting an axial direction offset amount that is an XY-direction offset amount of the substrate W2 with respect to the substrate W1 when the substrates W1 and W2 are bonded and a rotation direction offset amount that is an offset amount in the rotation direction based on the separated XY-direction component and rotation direction component. In addition, the controller 9 separates a warpage component of the positional shift vector determined by the calculated positional shift amount and the positional shift direction, and calculates the projection offset amount that is the offset amount of the projection amount of the central portion of the substrate W1 to the substrate W2 side with respect to the peripheral portion of the substrate W1 when the substrates W1 and W2 are bonded based on the separated warpage component. Here, every time the plurality of substrates W1 and W2 bonded to each other set in advance are produced, the controller 9 calculates the horizontal offset vector and the projection offset amount based on the positional shift amount and a statistical value (for example, the average value or the intermediate value) in the positional shift direction obtained for the plurality of substrates W1 and W2 bonded to each other. In addition, the controller 9 calculates a horizontal offset vector so as to minimize the positional shift amount of each of the plurality of sets of alignment marks imaged by the imaging unit 73. Then, the controller 9 stores information indicating the calculated horizontal offset vector and the calculated projection offset amount in the memory.

In addition, the controller 9 calculates the positional shift amount and the positional shift direction of the alignment marks MK1a, MK1b, MK1c, MK2a, MK2b, and MK2c based on each of the captured images obtained by imaging, with the imaging units 501A, 501B, and 501C, the alignment marks MK1a, MK1b, MK1c, MK2a, MK2b, and MK2c in a state where the substrates W1 and W2 are separated and the captured images obtained by imaging the alignment marks MK1a, MK1b, MK1c, MK2a, MK2b, and MK2c of the substrates W1 and W2 bonded to each other with the imaging units 501A, 501B, and 501C. Then, the controller 9 updates the horizontal offset vector based on the calculated positional shift amount and positional shift direction. Specifically, the controller 9 calculates a positional shift amount error from the captured images obtained by imaging the alignment marks MK1a, MK1b, MK1c, MK2a, MK2b, and MK2c after the substrates W1 and W2 are separated from each other and the alignment of the substrates W1 and W2 is completed. Then, the controller 9 subtracts the positional shift amount error from the positional shift amount calculated from the captured images obtained by imaging the alignment marks MK1a, MK1b, MK1c, MK2a, MK2b, and MK2c of the substrates W1 and W2 bonded to each other, thereby calculating the positional shift amount at the time of bonding the substrates W1 and W2. Here, since the positional shift amount error is not 0, the offset direction and the offset amount corresponding to the plurality of alignment marks calculated from the captured image captured by the imaging unit 73 of the inspection device 7 cannot be adopted as they are. Here, the above-described horizontal offset vector is calculated for each set of alignment marks MK1a and MK2a (MK1b and MK2b, MK1c and MK2c). The controller 9 may acquire information on the positional shift amount and the positional shift direction of the alignment marks MK1a, MK1b, MK1c, MK2a, MK2b, and MK2c of the substrates W1 and W2 bonded to each other from the inspection device 7 and calculate the positional shift amount error. The calculation of the horizontal offset vector may be executed by the inspection device 7 or may be executed by the substrate bonder 1. When the horizontal offset vector is calculated by the inspection device 7, information indicating the positional shift amount error may be notified to the inspection device 7. In addition, the offset direction and the offset amount calculated based on the captured image captured by the imaging unit 73 of the inspection device 7 are the offset direction and the offset amount common to all the sets of alignment marks of the substrates W1 and W2, and on the other hand, the horizontal offset vector reflecting the offset direction and the offset amount corrected based on the positional shift amount error is determined for each set of the alignment marks MK1a and MK2a (MK1b and MK2b, MK1c and MK2c).

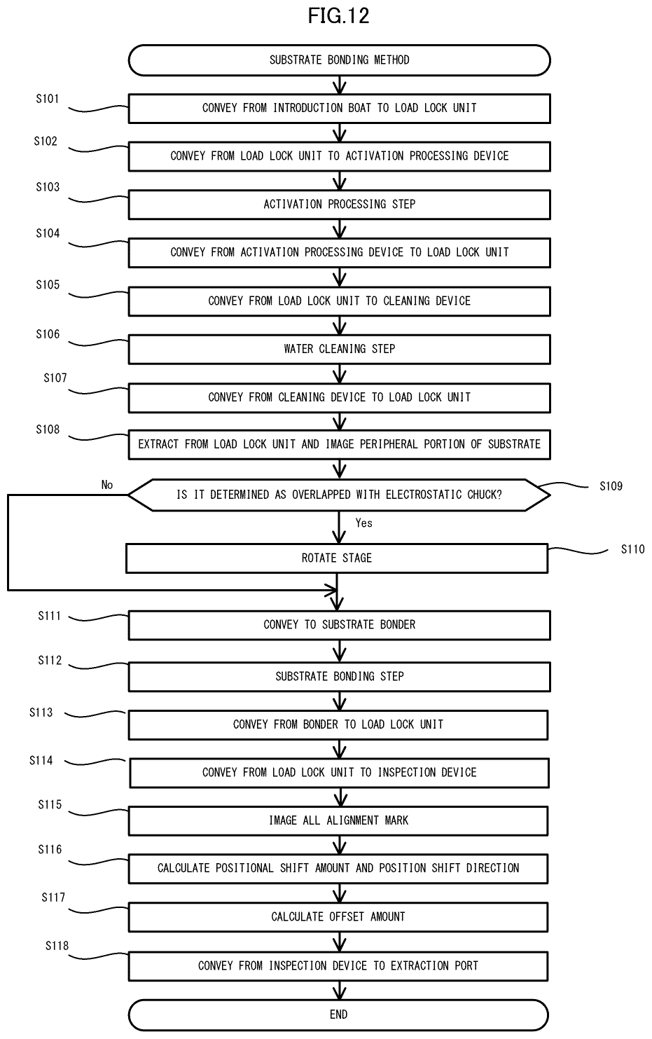

Next, with respect to the substrate bonding system according to the present embodiment, a flow of an operation from when the substrates W1 and W2 are put in the bonding system to when the substrates W1 and W2 are bonded and taken out from the substrate bonding system will be described with reference to FIGS. 12 to 17B. Here, it is assumed that the substrates W1 and W2 are disposed in the introduction ports 811 and 812 in advance. The substrates W1 and W2 are formed of, for example, any of a Si substrate, a glass substrate, an oxide substrate (for example, a silicon oxide (SiO2) substrate, an alumina substrate (Al2O3), or the like), and a nitride substrate (for example, silicon nitride (SiN) and aluminum nitride (AlN)). At least one of the substrates W1 and W2 may have a metal portion and an insulating film exposed on the bonding surface thereof. Alternatively, at least one of the substrates W1 and W2 may be one in which an insulating film formed by depositing an oxide or a nitride on the bonding surface thereof is exposed. Here, it is assumed that the substrate W1 is a glass substrate or an oxide substrate, and the substrate W2 is a Si substrate or a nitride substrate. For example, the substrate W2 to be held by the head 142 in the substrate bonder 1 is disposed in the introduction port 811, and for example, the substrate W1 to be placed on the stage 141 in the substrate bonder 1 is disposed in the introduction port 812.

First, as illustrated in FIG. 12, the substrate bonding system causes the conveyance robot 821 of the conveyance device 82 to convey the substrates W1 and W2 from the introduction ports 811 and 812 to the load lock unit 85 (step S101). Next, the substrate bonding system causes the conveyance robot 861 of the conveyance device 86 to convey the substrates W1 and W2 from the load lock unit 85 to the activation processing device 2 (step S102). Subsequently, the activation processing device 2 performs an activation processing step of activating the bonding surface of the substrate by performing at least one of reactive ion etching using nitrogen gas and irradiation with nitrogen radicals with respect to the bonding surface on at least one of the substrate W1 and W2 having a smaller bonding surface to be bonded (step S103). Here, the activation processing device 2 has a different processing sequence depending on the type of substrate to be subjected to activation processing on the bonding surface. When activating the substrate W1, that is, the bonding surface of a glass substrate or an oxide substrate, the activation processing device 2 first introduces N2 gas into the processing chamber 212 from the nitrogen gas storage unit 221A through the supply pipe 223 A by opening the supply valve 222A illustrated in FIG. 2. Next, the activation processing device 2 applies a high-frequency bias to the substrates W1 and W2 placed on the stage 210 with the bias application unit 217 in a state where the supply of the high-frequency current from the high-frequency power source 216 to the induction coil 215 is stopped. As a result, reactive ion etching (RIE) using N2 gas is performed on the bonding surface of the substrate W1. Subsequently, the activation processing device 2 starts supplying a high-frequency current from the high-frequency power source 216 to the induction coil 215 and generates plasma with N2 gas. At this time, the activation processing device 2 stops the application of the high-frequency bias to the substrate W1 with the bias application unit 217. The bonding surface of the substrate W1 is thus irradiated with N2 radicals.

When activating the substrate W2, that is, the bonding surface of an Si substrate or a nitride substrate, the activation processing device 2 first introduces O2 gas into the processing chamber 212 from the oxygen gas storage unit 221B through the supply pipe 223B by opening the supply valve 222B. Next, the activation processing device 2 applies a high-frequency bias to the substrate W2 placed on the stage 210 with the bias application unit 217 in a state where the supply of the high-frequency current from the high-frequency power source 216 to the induction coil 215 is stopped. As a result, reactive ion etching (RIE) using O2 gas is performed on the bonding surface of the substrate W2. Subsequently, the activation processing device 2 exhausts the O2 gas in the processing chamber 212 by closing the supply valve 222B and stopping the supply of the O2 gas from the oxygen gas storage unit 221B to the processing chamber 212. Thereafter, the activation processing device 2 introduces N2 gas into the processing chamber 212 from the nitrogen gas storage unit 221A through the supply pipe 223 A by opening the supply valve 222A. Thereafter, the activation processing device 2 starts supplying a high-frequency current from the high-frequency power source 216 to the induction coil 215 and generates plasma with N2 gas. At this time, the activation processing device 2 stops the application of the high-frequency bias to the substrate W2 with the bias application unit 217. The bonding surface of the substrate W2 is thus irradiated with N2 radicals.

The description returns to FIG. 12. Thereafter, the conveyance device 86 conveys the substrates W1 and W2 from the activation processing device to the load lock unit 85 (step S104). Next, the conveyance robot 821 of the conveyance device 82 conveys the substrates W1 and W2 from the load lock unit 85 to the cleaning device 3 (step S105). Subsequently, the cleaning device 3 executes a water cleaning step of cleaning the bonding surfaces of the substrates W1 and W2 while spraying water on the bonding surfaces (step S106). Here, the cleaning device 3 cleans the entire surfaces of the bonding surfaces of the substrates W1 and W2 by scanning the stage on which the substrates W1 and W2 are placed in the XY directions while spraying water to which ultrasonic waves are applied from the cleaning head onto the bonding surfaces of the substrates W1 and W2. As a result, foreign matter adhered to the bonding surfaces of the substrates W1 and W2 is removed. Subsequently, after stopping the discharge of water from the cleaning head, the cleaning device 3 rotates the stage to spin dry the substrate, thereby completing the cleaning processing. Thereafter, the conveyance device 82 conveys the substrates W1 and W2 from the cleaning device 3 to the load lock unit 83 (step S107). Next, the conveyance device 84 takes out the substrates W1 and W2 from the load lock unit 83, and the conveyance device imaging unit 844 images the peripheral portions of the substrates W1 and W2 (step S108).

Subsequently, the controller 9 determines whether the alignment marks MK1a, MK2a, MK1b, MK2b, MK1c, and MK2c used for calculating the positional shift amount are overlapped with the electrostatic chucks 1411, 1412, 1421, and 1422 based on the captured image acquired from the conveyance device imaging unit 844 (step S109). Specifically, the controller 9 acquires information indicating a relative positional relationship between the positions of the electrostatic chucks 1411 and 1421 of the stage 141 and the head 142 of the substrate bonder 1 and the positions of the substrates W1 and W2 held by the conveyance device 84 in advance, and determines whether the alignment marks MK1a, MK2a, MK1b, MK2b, MK1c, and MK2c used for calculating the positional shift amount are overlapped with the electrostatic chucks 1411, 1412, 1421, and 1422 based on the information. Here, when the controller 9 determines that none of the alignment marks MK1a, MK2a, MK1b, MK2b, MK1c, and MK2c used for calculating the positional shift amount is overlapped with the electrostatic chucks 1411, 1412, 1421, or 1422 (step S109: No), the processing in and after step S111 is executed as it is.

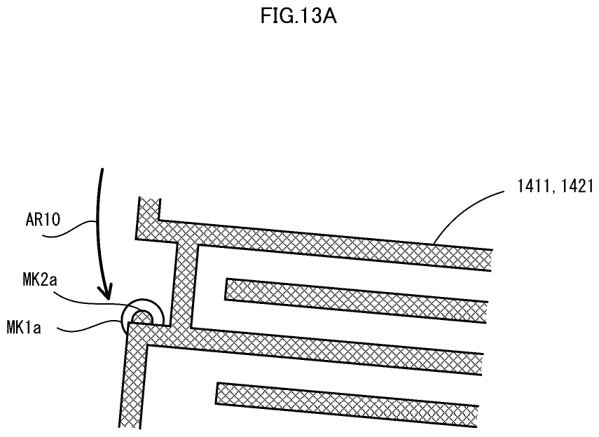

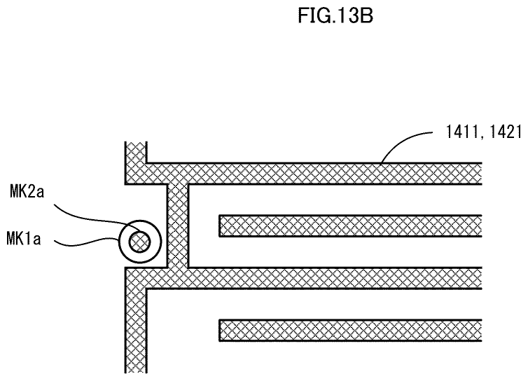

On the other hand, it is assumed that the controller 9 determines that at least one of the alignment marks MK1a, MK2a, MK1b, MK2b, MK1c, and MK2c used for calculating the positional shift amount is overlapped with the electrostatic chucks 1411, 1412, 1421, and 1422 (step S109: Yes). For example, as illustrated in FIG. 13A, it is assumed that it is determined that the alignment marks MK1a and MK2a are overlapped with a part of the electrostatic chucks 1411 and 1421. In this case, as illustrated in FIG. 12, the controller 9 rotates the stage 141 such that none of the alignment marks MK1a, MK2a, MK1b, MK2b, MK1c, and MK2c used for calculating the positional shift amount of the substrates W1 and W2 is overlapped with the electrostatic chucks 1411, 1412, 1421, or 1422, and then receives the substrates W1 and W2 (step S110). For example, the substrates W1 and W2 are received after the stage 141 is rotated in the rotation direction indicated by the arrow AR10 in FIG. 13A from the state illustrated in FIG. 13A. Here, the controller 9 rotates the stage 141 such that all the alignment marks MK1a, MK2a, MK1b, MK2b, MK1c, and MK2c are positioned between the plurality of electrode elements 1411b, 1412b, 1421b, and 1422b of the electrostatic chucks 1411, 1412, 1421, and 1422. As a result, in the substrates W1 and W2, for example, as illustrated in FIG. 13B, the alignment marks MK1a and MK2a used for calculating the positional shift amount of the substrates W1 and W2 are not overlapped with the electrostatic chucks 1411 and 1421. In addition, the controller 9 controls the imaging unit position adjustment units 503A, 503B, and 503C to move the imaging units 501A, 501B, and 501C to positions where the alignment marks MK1a, MK2a, MK1b, MK2b, MK1c, and MK2c of the substrates W1 and W2 can be imaged. The description returns to FIG. 12. Thereafter, the conveyance device 84 conveys the substrates W1 and W2 to the substrate bonder 1 (step S111). Next, the substrate bonder 1 executes a substrate bonding process (step S112).

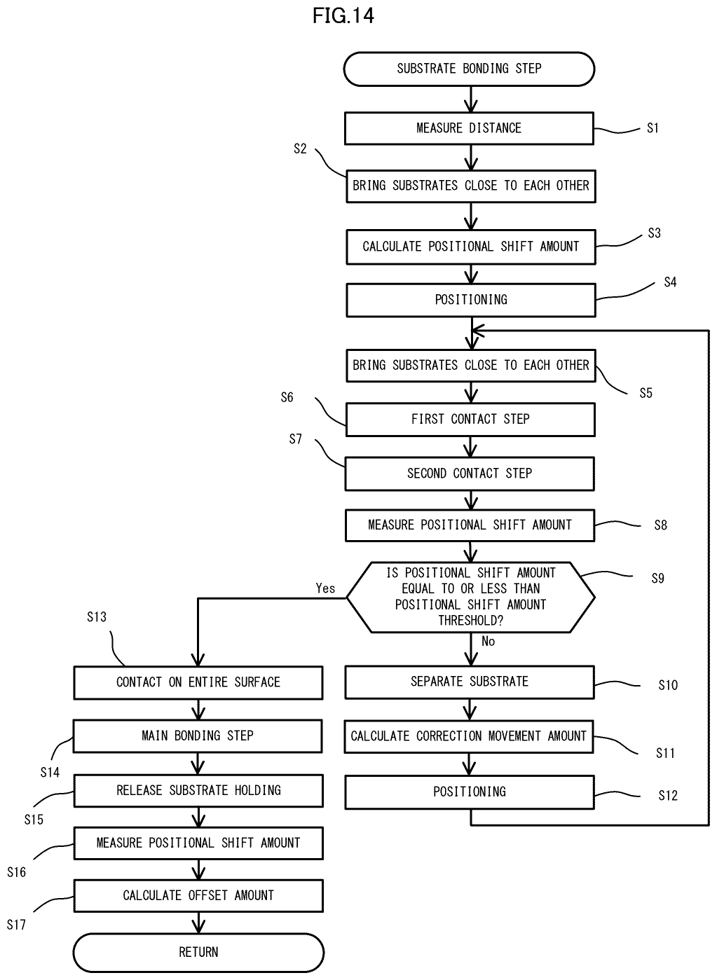

Here, the substrate bonding step executed by the substrate bonding system will be described in detail with reference to FIG. 14. In FIG. 14, it is assumed that the substrate bonder 1 has already stored the measurement results of the thicknesses of the substrates W1 and W2 in the memory of the controller 9. First, the substrate bonder 1 executes the distance measuring step of measuring the distance between the stage 141 and the head 142 at three points of the stage 141 and the head 142 with the distance measurement unit 1493 (step S1).

Next, the substrate bonder 1 calculates the distance between the bonding surface of the substrate W1 and the bonding surface of the substrate W2 based on the measured distances between the stage 141 and the head 142 at the three points of the stage 141 and the head 142 and the thicknesses of the substrates W1 and W2. Then, the substrate bonder 1 moves the head 142 vertically downward based on the calculated distance to bring the substrates W1 and W2 close to each other (step S2). Subsequently, the substrate bonder 1 calculates a positional shift amount of the substrate W1 with respect to the substrate W2 in a state where the substrates W1 and W2 are separated from each other (step S3). Here, the controller 9 first acquires, from the imaging units 501A, 501B, and 501C of the position measurement unit 500, captured images GAa, GAb, and GAc (see FIG. 10A) of the alignment marks MK1a, MK2a, MK1b, MK2b, MK1c, and MK2c provided in the portions of the two substrates W1 and W2 facing the first region A1 in the non-contact state. Then, the controller 9 calculates the positional shift amounts dx, dy, and dθ of the two substrates W1 and W2 in the X directions, the Y directions, and the rotation direction around the Z axis based on the three captured images GAa, GAb, and GAc. Subsequently, the substrate bonder 1 executes positioning by moving the substrate W2 relative to the substrate W1 so as to correct the calculated positional shift amounts dx, dy, and dθ (step S4). Here, the substrate bonder 1 moves the stage 141 in the X directions, the Y directions, and the rotation direction around the Z axis so as to reduce the positional shift amounts dx, dy, and de.

Thereafter, the substrate bonder 1 brings the substrates W1 and W2 close to each other by further bringing the head 142 close to the stage 141 (step S5). Here, the substrate bonder 1 disposes the head 142 at a position where the gap between the substrates W1 and W2 is an optimum gap for bringing the central portions thereof into contact with each other in a state where the substrates W1 and W2 are warped. In this state, the peripheral portions of the substrates W1 and W2 are separated from each other by about 50 μm.

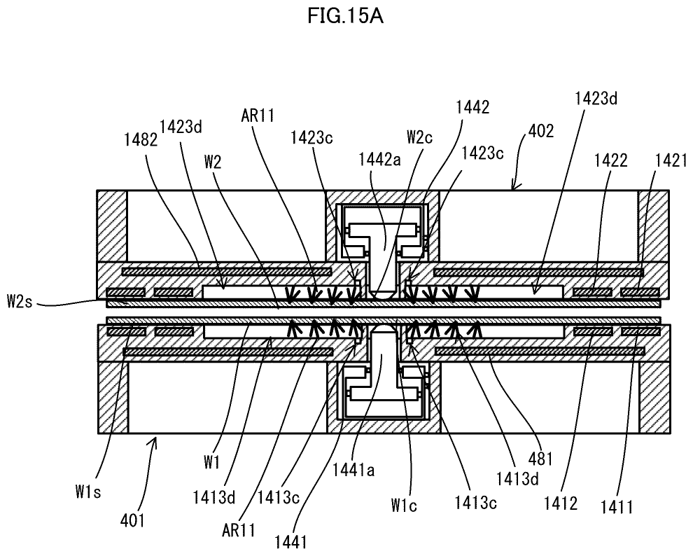

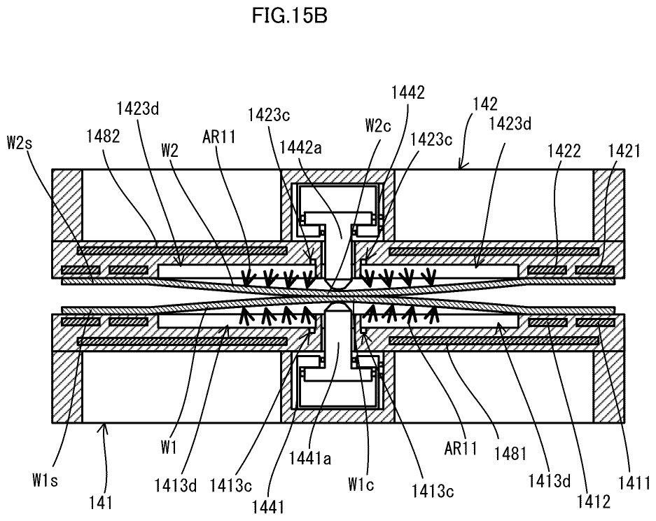

Next, the substrate bonder 1 executes a first contact step of bringing the central portion of the substrate W1 and the central portion of the substrate W2 into contact with each other by warping the substrates W1 and W2 in a state where the substrates W1 and W2 are separated from each other (step S6). First, as indicated by the arrow AR11 in FIG. 15A, the substrate bonder 1 fills the entire grooves 1413d and 1423d provided in the second region A2 with gas from the gas discharge holes 1413c and 1423c provided in the second region A2 of the stage 141 and the head 142. Thereafter, the substrate bonder 1 releases the holding of the substrate W1 with the electrostatic chucks 1413 and 1423 of the stage 141 and the head 142. At this time, the controller 9 controls the gas supply unit 1492 such that the gas is discharged from the gas discharge hole 1413c so that the pressure at which the substrate W1 comes into contact with the substrate W2 becomes lower than the critical pressure at which the substrates W1 and W2 are temporarily bonded. Specifically, the controller 9 controls the flow rate of the gas to be discharged from the gas discharge holes 1413c and 1423c based on the air pressure detected by the air pressure detection unit described above such that the air pressure becomes lower than the critical pressure. Next, the substrate bonder 1 presses the central portion of the substrate W1 toward the substrate W2 with the pressing unit 1441a in a state where the peripheral portion of the substrate W1 is held by the electrostatic chucks 1411 and 1412 of the stage 141. Here, the state in which the peripheral portion of the substrate W1 is held by the electrostatic chucks 1411 and 1412 includes not only a state in which a voltage is applied from the chuck drive unit 1491 to the electrostatic chucks 1411 and 1412 of the stage 141, but also a state in which a voltage is not applied to the electrostatic chucks 1411 and 1412 but the peripheral portion of the substrate W1 is in close contact with the electrostatic chucks 1411 and 1412 because of residual electrostatic force of the electrostatic chucks 1411 and 1412. As a result, as illustrated in FIG. 15B, the substrate W1 is warped such that the central portion W1c thereof projects toward the substrate W2. The substrate bonder 1 presses the central portion of the substrate W2 toward the substrate W1 with the pressing unit 1442a in a state where the peripheral portion of the substrate W2 is held by the electrostatic chucks 1421 and 1422 of the head 142. As a result, as illustrated in FIG. 15B, the substrate W2 is warped such that the central portion thereof projects toward the substrate W1. In this manner, the pressure of the gas discharged from the grooves 1413d and 1423d is effectively applied to the force for bringing the substrates W1 and W2 into close contact with the stage 141 and the head 142 because of the residual electrostatic force remaining between the electrode elements 1413b and 1423b after releasing the holding with the electrostatic chucks 1413 and 1423. Thus, the substrates W1 and W2 are in a free state with respect to the force for bringing the substrates W1 and W2 into close contact with the stage 141 and the head 142. Then, in this state, bonding can be advanced from the central portions of the substrates W1 and W2 toward the peripheral portions in a state where there is no influence of the adhesion force to the stage 141 and the head 142 by pressurizing and bringing the central portions of the substrates W1 and W2 into contact with each other at a pressure equal to or higher than the critical pressure. Thus, the substrates W1 and W2 can be bonded on the entire surfaces with high positional accuracy without distortion. In addition, when the substrates W1 and W2 are pressed against the central portions of the substrates W1 and W2 by the pressing units 1441a and 1432a before the substrates W1 and W2 are free from the force to be brought into close contact with the stage 141 and the head 142, the distortion generated in the substrates W1 and W2 increases because of the influence of the close contact force to the stage 141 and the head 142. In addition, the controller 9 causes the pressing units 1441a and 1432a to project from the stage 141 and the head 142 such that one of the pressing units 1441a and 1432a has a larger projection amount than the other by the projection offset amount based on the information indicating the projection offset amount stored in the memory. As a result, the amount of warpage of the substrates W1 and W2 when the substrates W1 and W2 are bonded to each other can be reduced.

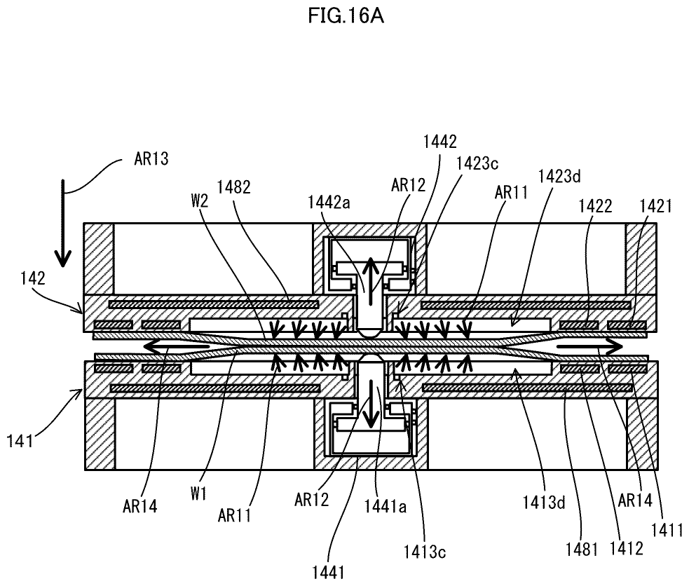

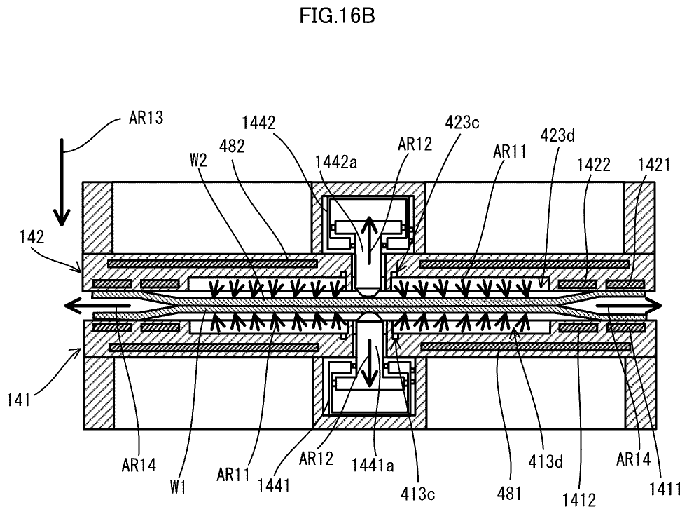

Subsequently, as illustrated in FIG. 14, the substrate bonder 1 executes a second contact step of expanding the contact portions of the substrates W1 and W2 from central portions W1c and W2c of the substrates W1 and W2 toward the peripheral portions W1s and W2s (step S7). Here, as indicated by the arrows AR12 in FIG. 16A, the substrate bonder 1 moves the pressing unit 1441a in a direction of embedding the pressing unit 1441a in the stage 141 and moves the pressing unit 1442a in a direction of embedding the pressing unit 1442a in the head 142. At the same time, the substrate bonder 1 moves the head 142 in the direction of approaching the stage 141 as indicated by the arrow AR13. As a result, as indicated by the arrows AR14, the contact portion between the substrates W1 and W2 expands from the central portions toward the peripheral portions of the substrates W1 and W2 because of an intermolecular force (van der Waals force) generated between the substrates W1 and W2 starting from the central portions point-pressurized by the pressing mechanisms 1441 and 1432 or a bonding force because of water or an OH group present on the bonding surface of the substrates W1 and W2. Then, when the head 142 is brought close to a position separated from the stage 141 by a preset distance, the substrate bonder 1 releases the holding of the substrates W1 and W2 with the electrostatic chucks 1421 and 1422 as illustrated in FIG. 16B. At this time, the substrate bonder 1 first fills the entire grooves provided in the sub-annular region A12 with the gas from the gas discharge hole provided in the sub-annular region A12 of the first region A1, then releases the holding of the substrates W1 and W2 with the electrostatic chucks 1421 and 1422. At this time, the controller 9 controls the flow rate of the gas to be discharged from the gas discharge holes 1412c and 1422c based on the air pressure detected by the air pressure detection unit described above such that the air pressure becomes lower than the critical pressure. Next, the substrate bonder 1 fills the entire grooves 1411d and 1412d provided in the sub-annular region A11 with the gas from the gas discharge holes 1411c and 1412c provided in the sub-annular region A11 of the first region A1, then releases the holding of the substrates W1 and W2 with the electrostatic chucks 1411, 1412, 1421, and 1422. As a result, the holding of the substrates W1 and W2 with the electrostatic chucks 1421 and 1422 is released. The contact portion between the substrates W1 and W2 further expands from the central portion to the peripheral portion of the substrates W1 and W2. Here, when the bonding surfaces of the substrates W1 and W2 are in contact with each other, the substrates W1 and W2 are temporarily bonded because of the hydrogen bonding between OH groups or between water molecules.

Thereafter, as illustrated in FIG. 14, the substrate bonder 1 measures the positional shift amount of the substrate W2 from the substrate W1 in a state where the bonding surface of the substrate W1 is in contact with the bonding surface of the substrate W2 (step S8). At this time, the substrate bonder 1 measures the positional shift amount of the substrates W1 and W2 in a state where the movement of the substrate W2 with respect to the substrate W1 is restricted because of the expansion of the contact portion between the substrates W1 and W2. Subsequently, the substrate bonder 1 determines whether all of the calculated positional shift amounts dx, dy, and dθ are equal to or less than the preset positional shift amount thresholds dxth, dyth, and dθth (step S9).

Here, it is assumed that the substrate bonder 1 determines that any one of the calculated positional shift amounts dx, dy, and dθ is larger than the preset positional shift amount threshold values dxth, dyth, and dθth (step S9: No). In this case, the substrate bonder 1 lifts the head 142 to separate the substrate W2 from the substrate W1 (step S10). At this time, the substrate bonder 1 moves the pressing unit 1441a in a direction of embedding the pressing unit 1441a into the stage 141 and moves the pressing unit 1442a in a direction of burying the pressing unit 1442a in the head 142 while increasing the distance between the substrates W1 and W2 by lifting the head 142. Here, the substrate bonder 1 controls the lift of the head 142 such that the tensile pressure of the substrate W2 when peeling the substrate W2 from the substrate W1 becomes constant. As a result, the substrate W2 is separated from the substrate W1, and the contact state between the substrates W1 and W2 is released.

Next, the substrate bonder 1 calculates correction movement amounts of the substrates W1 and W2 for setting all the calculated positional shift amounts dx, dy, and de to equal or less than the positional shift amount thresholds dxth, dyth, and dθth (step S11). Here, the controller 9 calculates a correction movement amount by which the substrate W2 is moved by a movement amount corresponding to the difference between the positional shift amounts dx, dy, and dθ between the substrate W1 and the substrate W2 in a state where the substrate W2 is in contact with the substrate W1 and the positional shift amount between the substrate W1 and the substrate W2 in a state where the substrate W2 is not in contact with the substrate W1. Then, the controller 9 further adds the offset amounts in the XY direction and the rotation direction indicated by the horizontal offset vectors in the XY direction and the rotation direction stored in the memory to the correction movement amount. By performing the alignment while performing the offset by the correction movement amount, when the substrates W1 and W2 come into contact with each other again and the same positional shift due to the contact of the substrates W1 and W2 has occurred, the positional shift of the substrates W1 and W2 disappears.

Subsequently, the substrate bonder 1 executes positioning so as to correct relative positional shift amounts dx, dy, and dθ between the two substrates W1 and W2 in a state where the two substrates W1 and W2 are not in contact with each other (step S12). Here, the substrate bonder 1 moves the stage 141 in the X directions, the Y directions, and the rotation direction around the Z axis by the correction movement amount calculated in step S111. In this manner, the substrate bonder 1 adjusts the relative position of the substrate W2 with respect to the substrate W1 so as to reduce the positional shift amounts dx, dy, and dθ in a state where the substrates W1 and W2 are separated from each other. Then, the substrate bonder 1 executes the processing of step S9 again.

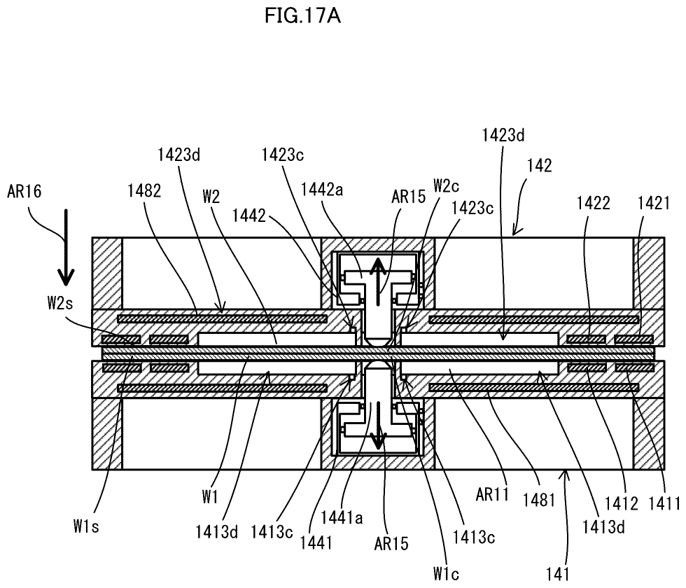

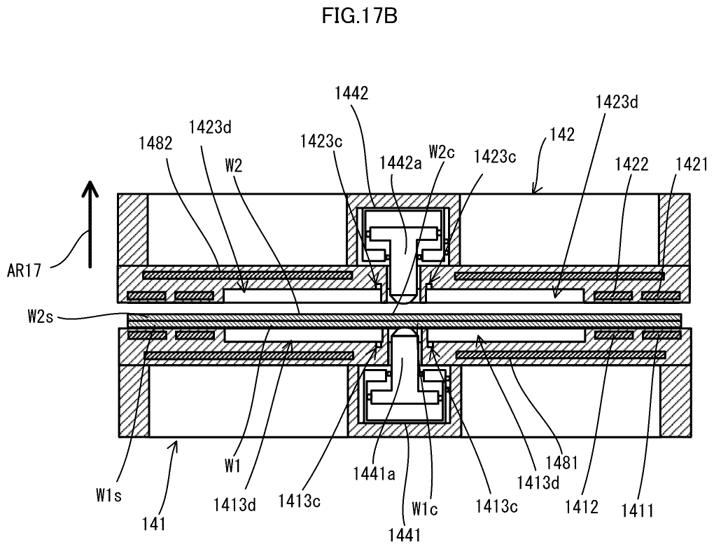

On the other hand, it is assumed that the substrate bonder 1 has determined that all of the calculated positional shift amounts dx, dy, and dθ are equal to or less than preset positional shift amount thresholds dxth, dyth, and dθth (step S9: Yes). In this case, the substrate bonder 1 further expands the contact portion between the substrates W1 and W2 from the central portions of the substrates W1 and W2 toward the peripheral portions to bring the substrates W1 and W2 into contact with each other over the entire surface (step S13). Here, as illustrated in FIG. 17A, the substrate bonder 1 moves the pressing unit 1441a of the pressing mechanism 1441 in the direction of embedding the pressing unit 1442 in the stage 141 and moves the pressing unit 1442a of the pressing mechanism 1442 in the direction of embedding the pressing unit 1442a in the head 142, and at the same time, further moves the head 142 in the direction of approaching the stage 141 as indicated by the arrow AR16, thereby reducing the distance between the peripheral portions of the substrates W1 and W2. In this manner, the substrate bonder 1 brings the peripheral portion of the substrate W1 into contact with the peripheral portion of the substrate W2 and brings the bonding surfaces of the substrates W1 and W2 into contact with each other on the entire surfaces.

The description returns to FIG. 14. Thereafter, the substrate bonder 1 executes a main bonding process of bonding the substrates W1 and W2 by pressing the substrate W1 against the substrate W2 to pressurize the substrates W1 and W2 and then heating the substrates W1 and W2 in a state where the substrates W1 and W2 are in contact with each other on the entire surfaces (step S14). Next, the substrate bonder 1 stops the electrostatic chuck 1421 of the head 142 to release the holding of the substrate W2 (step S15). Subsequently, the substrate bonder 1 moves the head 142 upward to separate the head 142 from the substrate W2 as indicated by the arrow AR17 in FIG. 17B. Next, the substrate bonder 1 measures the positional shift amount of the substrate W2 with respect to the substrate W1 again in a state where the substrates W1 and W2 are bonded to each other (step S16). Subsequently, the controller 9 calculates a horizontal offset vector of the substrate W2 with respect to the substrate W1 and a projection offset amount of the projection amounts of the pressing units 1441a and 1432a of the pressing mechanisms 1441 and 1432, which are used when calculating the correction amount movement amount in the next bonding of the substrates W1 and W2, based on the calculated positional shift amount (step S17). Here, the controller 9 stores information indicating the calculated horizontal offset vector and the calculated projection offset amount in the memory.

The description returns to FIG. 12. Subsequently, the conveyance device 84 conveys the substrates W1 and W2 bonded to each other from the substrate bonder 1 to the load lock unit 83 (step S113). Subsequently, the conveyance device 82 extracts the substrates W1 and W2 bonded to each other from the load lock unit 83 and conveys the substrates to the inspection device 7 (step S114). Thereafter, the inspection device 7 images all the alignment marks including the alignment marks MK1a, MK2a, MK1b, MK2b, MK1c, and MK2c provided on the substrates W1 and W2 bonded to each other (step S115). Here, the alignment marks MK1a, MK2a, MK1b, MK2b, MK1c, and MK2c are used for alignment in the substrate bonder 1, and the inspection device 7 images not only the alignment marks MK1a, MK2a, MK1b, MK2b, MK1c, and MK2c but also all the other alignment marks. The alignment marks of one of the substrate W1 and the substrate W2 correspond to third alignment marks, and the alignment marks of the other substrate correspond to fourth alignment marks. Here, the inspection device 7 images all the alignment marks including the alignment marks MK1a, MK2a, MK1b, MK2b, MK1c, and MK2c provided on the substrates W1 and W2 bonded to each other in order with the imaging unit 73. Next, the controller 9 calculates the positional shift amount and the positional shift direction in each alignment mark from the image captured by the imaging unit 73 of the inspection device 7 (step S116).

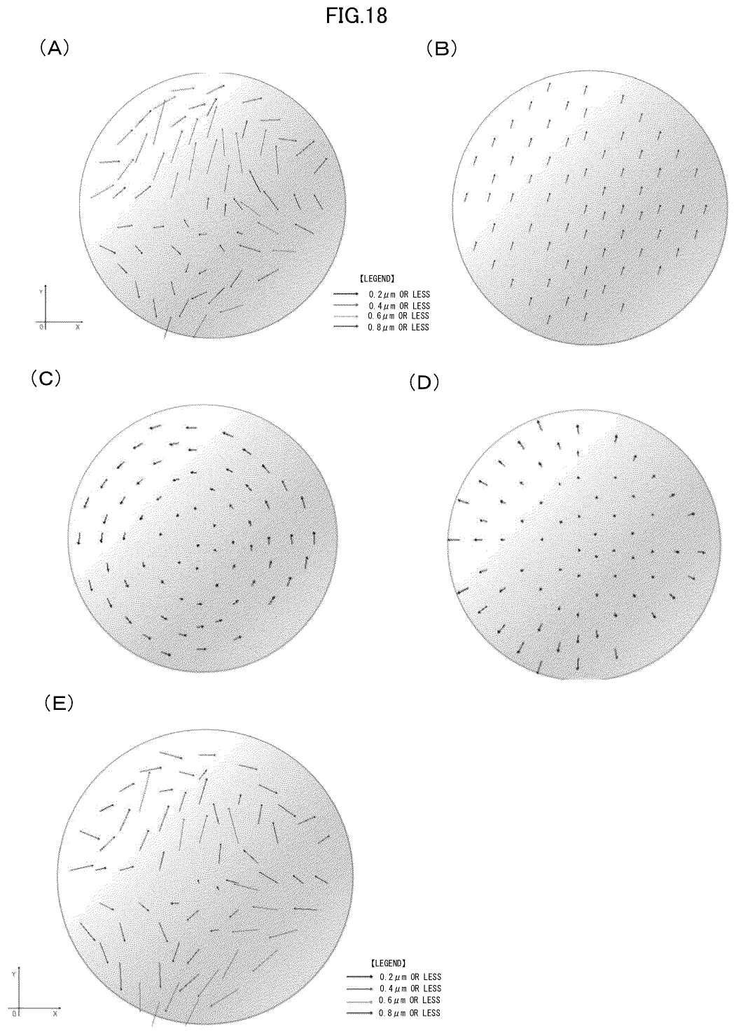

Subsequently, the controller 9 calculates a horizontal offset vector of the substrate W2 with respect to the substrate W1 and a projection offset amount of the projection amounts of the pressing units 1441a and 1432a of the pressing mechanisms 1441 and 1432, which are used when calculating the correction amount movement amount in the next bonding of the substrates W1 and W2, based on the calculated positional shift amount (step S117). Specifically, the controller 9 separates the positional shift vector in each alignment mark specified by the calculated positional shift amount and positional shift direction into an XY-direction component, a rotation-direction component, a warpage component, and a distortion component. Here, for example, when the distribution of the positional shift vectors as illustrated in FIG. 18(A) is obtained, the controller 9 separates the positional shift vectors into an XY-direction component, a rotation-direction component, a warpage component, and a distortion component as illustrated in each of FIGS. 18(B) to (E). That is, in FIGS. 18(B) to (E), a combination of the XY-direction component, the rotation-direction component, the warpage component, and the distortion component is in a relationship of matching with the positional shift vector. Then, the controller 9 calculates the horizontal offset vector, that is a vector reflecting the axial offset amount that is an offset amount in the axial direction along each of the two intersecting axes of the substrate W2 with respect to the substrate W1, that is the offset amount in the XY directions and the rotational direction offset amount that is an offset amount in the rotational direction, from only the XY-direction component and the rotational-direction component obtained by separating the components.

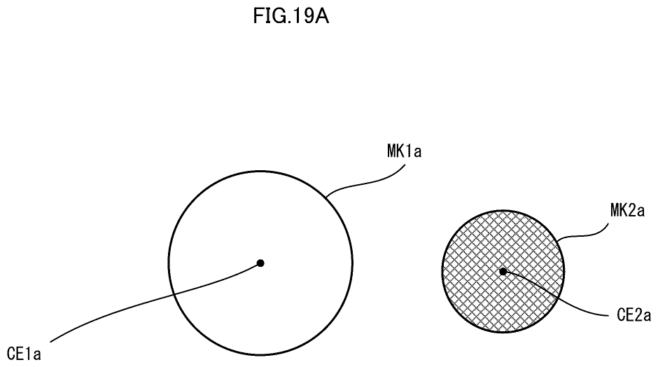

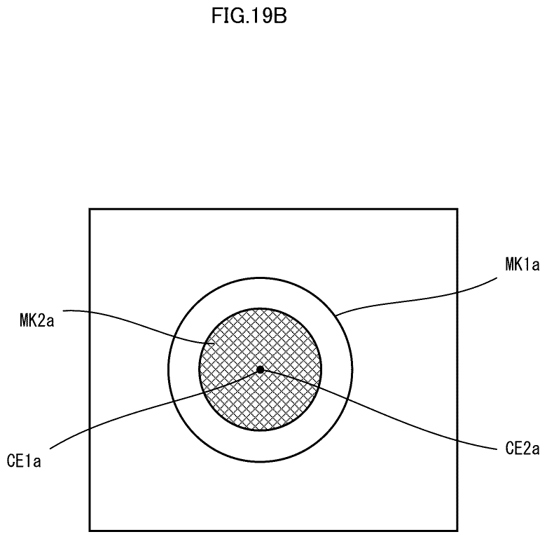

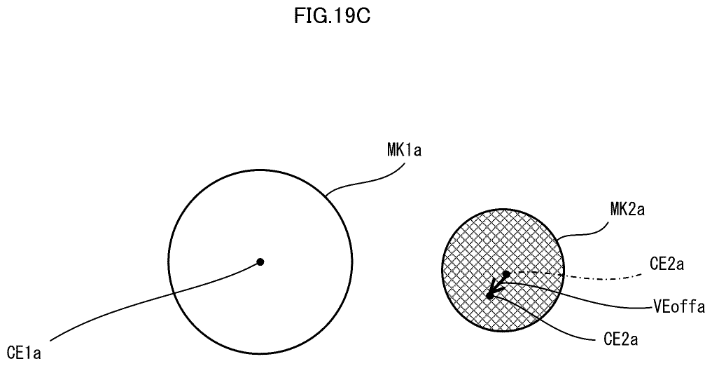

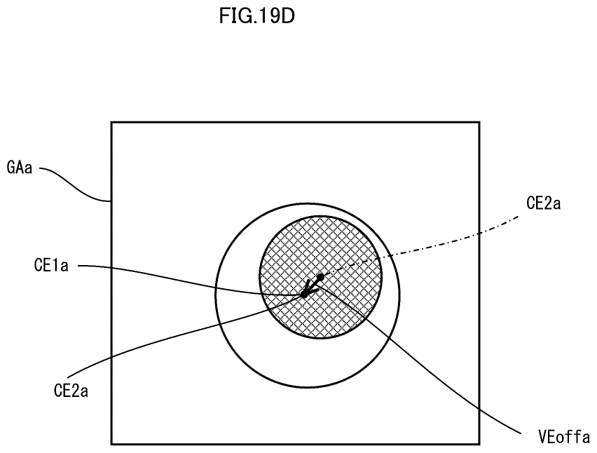

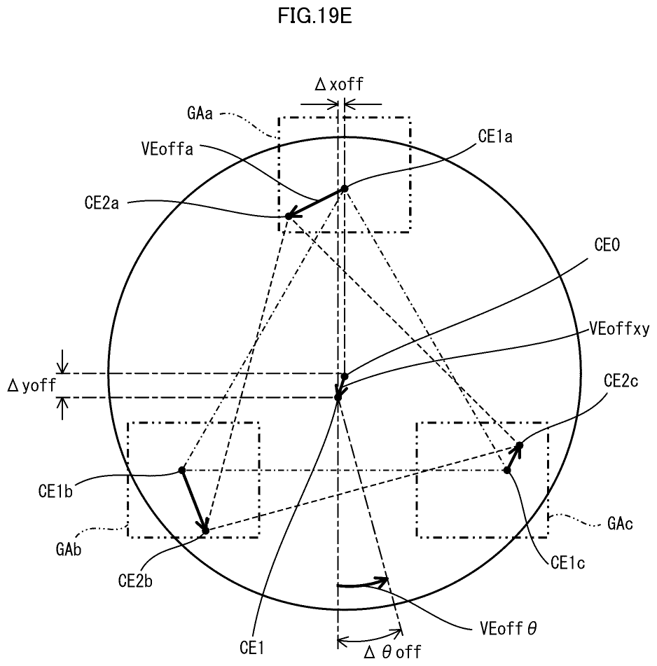

Meanwhile, it is preferable that the calculated offset amount is converted into a horizontal offset vector which is a vector reflecting an axial offset amount which is an offset amount in an axial direction, that is, an XY direction, and a rotational direction offset amount which is an offset amount in a rotational direction of the substrate W2 with respect to the substrate W1 at each of the positions of the alignment marks MK1a, Mk1b, MK2a, MK2b, MK3a, and MK3b used in the bonder 1, and alignment is executed using the converted horizontal offset vector in the bonder 1 because the horizontal offset amounts in the alignment marks MK1a, Mk1b, MK2a, MK2b, MK3a, and MK3b actually used are more reflected from the viewpoint of improving alignment accuracy. First, representative positions CE1a and CE2a of the alignment marks MK1a and MK2a illustrated in FIG. 19A are set to coincide with each other in a state where the central portions of the two alignment marks MK1a and MK1b are disposed to coincide with each other as illustrated in FIG. 19B. Then, as illustrated in FIG. 19C, it is assumed that the representative position CE2a of the alignment mark MK2a is moved by an amount reflecting the direction and the size indicated by a horizontal offset vector VEoffa. Then, as illustrated in FIG. 19D, the alignment marks MK1a and MK2a are aligned in a state of being shifted by the horizontal offset vector VEoffa. Then, as illustrated in FIG. 19E, it is assumed that the offset amounts in the XY directions of the substrate W2 with respect to the substrate W1 are Δxoff and Δyoff, and the rotational direction offset amount is Δθoff. In this case, the horizontal offset vector VEoffa corresponding to the set of the alignment marks MK1a and MK2a imaged by the imaging unit 501A is represented by a vector having the representative position CE1a of the alignment mark MK1a as a start point and the representative position CE2a of the alignment mark MK2a as an end point, and the horizontal offset vector VEoffb corresponding to the set of the alignment marks MK1b and MK2b imaged by the imaging unit 501B is represented by a vector having the representative position CE1b of the alignment mark MK1b as a start point and the representative position CE2b of the alignment mark MK2b as an end point. The horizontal offset vector VEoffc corresponding to the set of alignment marks MK1c and MK2c imaged by the imaging unit 501C is represented by a vector having the representative position CE1c of the alignment mark MK1c as a start point and the representative position CE2c of the alignment mark MK2c as an end point. Here, the horizontal offset vectors VEoffa, VEoffb, and VEoffc are expressed as vectors having different orientations and sizes. The controller 9 calculates the horizontal offset vectors VEoffa, VEoffb, and VEoffc. Then, the controller 9 executes alignment between the substrates W1 and W2 using the representative positions CE2a, CE2b, and CE2c obtained by shifting the alignment marks MK1b, MK2b, and MK2c by the horizontal offset vectors VEoffa, VEoffb, and VEoffc described above.

In addition, the controller 9 calculates the projection offset amounts of the pressing units 1441a and 1432a of the pressing mechanisms 1441 and 1432 base on only the warpage component. Here, every time the plurality of substrates W1 and W2 bonded to each other whose number is set in advance are produced, the controller 9 calculates the horizontal offset vector and the projection offset amount based on the positional shift amount the average value or the intermediate value in the positional shift direction obtained for the plurality of substrates W1 and W2 bonded to each other. Then, the controller 9 stores information indicating the calculated horizontal offset vector and the calculated projection offset amount in the memory. As a result, the substrate bonder 1 corrects the calculated horizontal offset vector and the projection offset amount at the time of bonding the substrates W1 and W2. Thereafter, the conveyance device 82 conveys the substrates W1 and W2 bonded to each other after the measurement from the inspection device 7 to the extraction port 813 (step S118). In this substrate bonding method, at least a part of the series of processing from steps S101 to S104, the series of processing from steps S105 to S107, the series of processing from steps S108 to S113, and the series of processing from steps S115 to S117 may be executed on different substrates W1 and W2 in parallel.

As described above, in the substrate bonder 1 according to the present embodiment, in a state where the central portion W1c of the substrate W1 and the central portion W2c of the substrate W2 are in contact with each other and the peripheral portion W1s of the substrate W1 is held by the electrostatic chucks 1411 and 1412, the substrates W1 and W2 are brought into contact with each other while gas is being discharged between the stage 141 and the substrate W1 from the gas discharge hole 1413c and the groove 1413d. With this configuration, the pressure of the gas discharged from the gas discharge holes 1413c and 1423c to the grooves 1413d and 1423d is effectively applied to the force for bringing the substrates W1 and W2 into close contact with the stage 141 and the head 142 because of the residual electrostatic force remaining between the electrostatic chucks 1413 and 1423 after releasing the holding with the electrostatic chucks 1413 and 1423. Thus, the substrates W1 and W2 are in a free state with respect to the force for bringing the substrates W1 and W2 into close contact with the stage 141 and the head 142. Then, in this state, bonding can be advanced from the central portions of the substrates W1 and W2 toward the peripheral portions in a state where there is no influence of the adhesion force of the substrates W1 and W2 to the stage 141 and the head 142 by pressurizing and bringing the central portions of the substrates W1 and W2 into contact with each other at a pressure equal to or higher than the critical pressure. Thus, the substrates W1 and W2 can be bonded on the entire surface with high positional accuracy without distortion.

When the grooves 1413d and 1423d are not provided in the stage 141 and the head 142, only a part of the substrates W1 and W2 is peeled off from the stage 141 and the head 142, and there is a possibility that a portion in close contact with the stage 141 and the head 142 remains in the substrates W1 and W2. In this case, there is a possibility that the entire portions of the substrates W1 and W2 except for the peripheral portions are not brought into a free state with respect to the force for bringing the substrates W1 and W2 into close contact with the stage 141 and the head 142. In particular, as described above, in the case of discharging gas from the gas discharge holes 1413c and 1423c before releasing the holding with the electrostatic chucks 1413 and 1423, when the residual electrostatic force of the electrostatic chucks 1413 and 1423 is relatively small, only the vicinity of the gas discharge holes 1413c and 1423c is in a state of being peeled off from the stage 141 and the head 142, the pressure of the gas cannot be effectively applied to the entire portion excluding the peripheral portions of the substrates W1 and W2, and the entire portion excluding the peripheral portions of the substrates W1 and W2 are not brought into a free state from the stage 141 and the head 142 in some cases. On the other hand, in the stage 141 and the head 142 according to the present embodiment, the grooves 1413d and 1423d are provided, and thus the entire substrates W1 and W2 except for the peripheral portions can be made in a free state from the force of bringing the substrates close contact to the stage 141 and the head 142. Thus, bonding can be advanced from the central portions of the substrates W1 and W2 toward the peripheral portions in a state where there is no influence of the adhesion force of the substrates W1 and W2 to the stage 141 and the head 142.

The grooves 1413d and 1423d formed in the second region A2 of the stage 141 and the head 142 according to the present embodiment have portions extending along the extending directions of the plurality of electrode elements 1413b and 1423b, respectively. The grooves 1413d and 1423d are provided between the plurality of electrode elements 1413b electrically connected to the terminal electrode 1413a of the stage 141 and the head 142 and the plurality of electrode elements 1423b connected to the terminal electrode 1423a. This can make the force in the direction of peeling the substrates W1 and W2 from the stage 141 and the head 142 act on the entire substrates W1 and W2 with the gas discharged from the gas discharge holes 1413c and 1423c via the grooves 1413d and 1423d with respect to the force of the electrostatic chucks 1413 and 1423 to bring the substrates into close contact with the stage 141 and the head 142. In addition, since the grooves 1413d and 1423d are provided between the electrode elements 1413b and 1423b to which voltages having different polarities are applied, the pressure of the gas discharged from the grooves 1413d and 1423d can be effectively applied to the force for bringing the substrates W1 and W2 into close contact with the stage 141 and the head 142 by the electrostatic force generated between the electrode elements 1413b and 1423b. Thus, the speed at which the contact portions between the substrates W1 and W2 expand can be made uniform.

Further, the stage 141 and the head 142 according to the present embodiment are provided in the sub-annular region A11 of the first region A1, and have grooves 1411d and 1421d communicating with the gas discharge holes 1411c and 1411d. The stage 141 and the head 142 are provided in the sub-annular region A12 of the first region A1, and have grooves communicating with the gas discharge holes. Then, when the substrates W1 and W2 are brought into contact with each other on the entire surface from a state where the central portions of the bonding surfaces of the substrates W1 and W2 are in contact with each other and the peripheral portions of the substrates W1 and W2 are held by the electrostatic chucks 1411, 1412, 1421, and 1422, the controller 9 first controls the chuck drive unit 1491 and the gas supply unit 1492 so as to release the holding of the substrates W1 and W2 with the electrostatic chucks 1421 and 1422 after filling the entire groove provided in the sub-annular region A12 with gas from the gas discharge hole provided in the sub-annular region A12 of the first region A1. Next, the controller 9 controls the chuck drive unit 1491 and the gas supply unit 1492 so as to release the holding of the substrates W1 and W2 with the electrostatic chucks 1411, 1412, 1421, and 1422 after filling the entire grooves 1411d and 1412d provided in the sub-annular region A11 with gas from the gas discharge holes 1411c and 1412c provided in the sub-annular region A11 of the first region A1. As a result, the state in which the peripheral portions of the substrates W1 and W2 are held with the electrostatic chucks 1411, 1412, 1421, and 1422 is released in a state where a force in a direction in which the substrates W1 and W2 are peeled off from the stage 141 and the head 142 acts from the entire grooves 1411d and 1412d. Thus, with the force acting in the direction in which the substrates W1 and W2 are peeled off from the stage 141 and the head 142 to the entire substrates W1 and W2, peeling of a part of the substrates W1 and W2 from the stage 141 and the head 142 can be preferentially suppressed, and the speed at which the contact portions between the substrates W1 and W2 expand can be made uniform.

In addition, by filling the entire grooves provided in the sub-annular region A12 of the first region A1 and the entire grooves 1411d and 1412d provided in the sub-annular region A11 of the first region A1 with gas in a state where a voltage is applied between the plurality of electrode elements 1411b, 1421b, 1412b, and 1422b of the electrostatic chucks 1411, 1421, 1412, and 1422, a part of the gas filled in the grooves 1411d and 1412d can be ionized. As a result, the residual electrostatic force of the electrostatic chucks 1411, 1421, 1412, and 1422 is neutralized by the ions contained in the gas. Thus, the substrates W1 and W2 are easily peeled off from the stage 141 and the head 142.

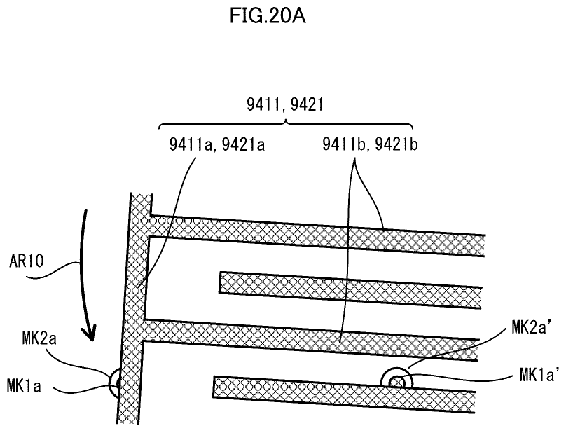

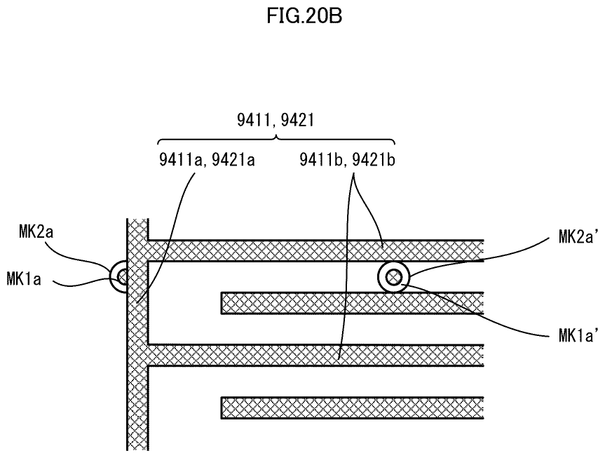

Meanwhile, it is assumed that the stage and the head include, for example, as illustrated in FIG. 20A, electrostatic chucks 9411 and 9421 including linear terminal electrodes 9411a and 9421a having no bent portion and electrode elements 9411b and 9421b. Here, for example, as illustrated in FIG. 20A, it is assumed that alignment marks MK1a′ and MK2a′ used for calculating the positional shift amount of the substrates W1 and W2 are overlapped with the electrode elements 9411b and 9421b of the electrostatic chucks 9411 and 9421. In this case, when the substrate bonder 1 receives the substrates W1 and W2 after rotating the stage 141, the alignment marks MK1a′ and MK2a′ can be brought into a state of not being overlapped with the electrode elements 9411b and 9421b of the electrostatic chucks 9411 and 9421 as illustrated in FIG. 20B. However, for example, as illustrated in FIG. 20A, when the alignment marks MK1a and MK2a used for calculating the positional shift amount of the substrates W1 and W2 are overlapped with the terminal electrodes 9411a and 9421a of the electrostatic chucks 9411 and 9421, the alignment marks MK1a and MK2a are overlapped with the terminal electrodes 9411a and 9421a of the electrostatic chucks 1411 and 1421 as illustrated in FIG. 20B even though the substrate bonder 1 receives the substrates W1 and W2 after rotating the stage 141 in the rotation direction indicated by the arrow AR10 in FIG. 20A. When the stage and the head are moved in parallel such that the alignment marks MK1a and MK2a used for calculating the positional shift amount of the substrates W1 and W2 are not overlapped with the electrostatic chucks 1411 and 1421, the positions where the substrates W1 and W2 are pressed by the pressing mechanism shift from the central portions of the substrates W1 and W2, and as a result, the substrates W1 and W2 bonded to each other are likely to have a distortion.

On the other hand, in the electrostatic chucks 1411 and 1421 according to the present embodiment, the terminal electrode 1411a has a plurality of bent portions 1411ab bent so as to project in a direction away from the others in plan view, and a coupling portion 1411aa coupling ends of two bent portions 1411ab adjacent to each other in the circumferential direction. As a result, when the substrate bonder 1 receives the substrates W1 and W2 after rotating the stage 141, the alignment marks MK1a and MK2a used for calculating the positional shift amount of the substrates W1 and W2 can be brought into a state of not being overlapped with the electrostatic chucks 1411 and 1421 without moving the stage 141 or the head 142 in parallel. Thus, the substrates W1 and W2 can be bonded to each other with high positional accuracy, and distortion to be generated in the substrates W1 and W2 bonded to each other can be reduced.

The alignment marks MK1a, MK2a, MK1b, MK2b, MK1c, and MK2c of the substrates W1 and W2 are often provided in corner portions of regions to be bases of chips in the substrates W1 and W2, that is, in peripheral portions of regions to be bases of chips. Here, since the alignment marks MK1a, MK2a, MK1b, MK2b, MK1c, and MK2c need to be disposed so as not to overlap with the dicing line provided between the regions to be the bases of adjacent chips, it is necessary to provide the alignment marks inside the regions to be the bases of the chips, and the area of the regions to be the bases of the chips increases accordingly. Then, the positions of the alignment marks MK1a, MK2a, MK1b, MK2b, MK1c, and MK2c are disposed closer to the central portion side than the peripheral edges of the substrates W1 and W2 by an amount corresponding to an increase in the area of the region to be the bases of the chips. On the other hand, the alignment marks MK1a, MK2a, MK1b, MK2b, MK1c, and MK2c need to be disposed at positions facing the first region A1 in a state where the substrates W1 and W2 are disposed at the substrate holding positions of the stage 141 and the head 142, respectively. Thus, when the positions of the alignment marks MK1a, MK2a, MK1b, MK2b, MK1c, and MK2c are disposed closer to the central portion side than the peripheral edges of the substrates W1 and W2, it is necessary to set the width of the first region A1 wider accordingly. Here, with one electrostatic chuck provided in the first region A1, when the central portions of the substrates W1 and W2 are brought into contact with each other, the bonding between the substrates W1 and W2 stops at a portion facing the first region A1, and the bonding between the substrates W1 and W2 does not sufficiently expand to the vicinity of the peripheral edge, which may cause distortion in the peripheral portions of the substrates W1 and W2. On the other hand, in the stage 141 and the head 142 according to the present embodiment, two sub-annular regions A11 and A12 set in advance are set in the first region A1, and the electrostatic chucks 1411, 1412, 1421, and 1422 are provided in the sub-annular regions A11 and A12, respectively. As a result, even when the positions of the alignment marks MK1a, MK2a, MK1b, MK2b, MK1c, and MK2c of the substrates W1 and W2 are disposed closer to the central portion side than the peripheral edges of the substrates W1 and W2, imaging of these alignment marks are possible, and at the same time, it is possible to advance the bonding between the substrates W1 and W2 to the vicinity of the peripheral edges of the substrates W1 and W2 by releasing the holding of only the electrostatic chucks 1412 and 1422 provided in the sub-annular region A12 when the central portions of the substrates W1 and W2 are brought into contact with each other and the bonding between the substrates W1 and W2 is advanced. The electrostatic chucks 1412 and 1422 provided in the sub-annular region A12 may be driven simultaneously with the electrostatic chucks 1413 and 1423 provided in the second region A2. In this case, the electrostatic chucks 1412 and 1422 and the electrostatic chucks 1413 and 1423 can share a power source, and thus the configuration of the substrate bonder 1 can be simplified.

Further, the substrate bonding system according to the present embodiment includes the inspection device 7 including the imaging unit 73 that images all of the plurality of alignment marks of the substrates W1 and W2 bonded to each other. In addition, the controller 9 calculates the positional shift amount and the positional shift direction of each of the plurality of alignment marks of the substrates W1 and W2 based on the captured image obtained by imaging the plurality of alignment marks of the substrates W1 and W2 with the imaging unit 73. Then, the controller 9 separates an axial-direction component along each of the two intersecting axial directions of the positional shift vectors determined by the calculated positional shift amount and positional shift direction, that is, an XY-direction component, and a rotation-direction component, and calculates a horizontal offset vector that is a vector reflecting an axial direction offset amount that is the offset amount in the axial direction along each of the two axes intersecting each other of the substrate W2, that is, an XY-direction offset amount with respect to the substrate W1 when the substrates W1 and W2 are bonded and a rotation direction offset amount that is an offset amount in the rotation direction based on the separated XY-direction component and rotation-direction component. In addition, the controller 9 separates a warpage component of the positional shift vector determined by the calculated positional shift amount and the positional shift direction, and calculates the projection offset amount that is the offset amount of the projection amount of the central portion of the substrate W1 to the substrate W2 side with respect to the peripheral portion of the substrate W1 when the substrates W1 and W2 are bonded based on the separated warpage component. As a result, for example, when the substrates W1 and W2 are repeatedly bonded a plurality of times, the relative positions of the substrates W1 and W2 are corrected by the offset amount corresponding to the absolute value of the horizontal offset vector in the offset direction indicated by the horizontal offset vector calculated based on the positional shift amount of the alignment mark after the past substrate bonding process when the substrates W1 and W2 are bonded. Thus, the bonding position accuracy between the substrates W1 and W2 can be enhanced. Here, when the pressing mechanism on the head 142 side is position control, and the pressing mechanism on the stage 141 side is pressure control, the peripheral portions of the substrates W1 and W2 bonded to each other are warped toward the head 142 side with respect to the central portion when the projection offset amount on the head 142 side is increased. On the other hand, when the projection offset amount on the head 142 side is reduced, the peripheral portions of the substrates W1 and W2 bonded to each other are warped toward the stage side 141 side with respect to the central portion.

Meanwhile, when the offset direction and the offset amount are determined based on only the captured image captured by the imaging unit 73 of the inspection device 7 without considering the positional shift amount error of the alignment marks MK1a, MK1b, MK1c, MK2a, MK2b, and MK2c described above, the positional shift of the alignment marks MK1a, MK1b, MK1c, MK2a, MK2b, and MK2c occurs by the positional shift amount error in the substrate bonder 1. On the other hand, in the present embodiment, the horizontal offset vector is calculated by correcting the offset direction and the offset amount by the positional shift amount error amount of the positional shift amounts of the alignment marks MK1a, MK1b, MK1c, MK2a, MK2b, and MK2c before and after bonding the substrates W1 and W2 in the substrate bonder 1. As a result, the accuracy of the horizontal offset vector required for bonding the substrates W1 and W2 can be enhanced.

### Embodiment 2

A substrate bonder according to the present embodiment is different from that of the first embodiment in that the substrate bonder includes a plurality of pressing members, the pressing members have annular shapes having different inner diameters, are concentrically disposed such that a central portion of a second region inside a first region in a first substrate holding unit coincides with a central portion of the first substrate holding unit, and the pressing member press a portion of the first substrate disposed at the substrate holding position, the portion facing the second region. The substrate bonder according to the present embodiment brings the first substrate and the second substrate into contact with each other while preferentially pressing the first substrate from the pressing member positioned on the central portion side of the first substrate holding unit among the plurality of pressing members in a state where the central portion of the first substrate and the central portion of the second substrate are in contact with each other and the peripheral portion of the first substrate is held by the substrate holding unit.

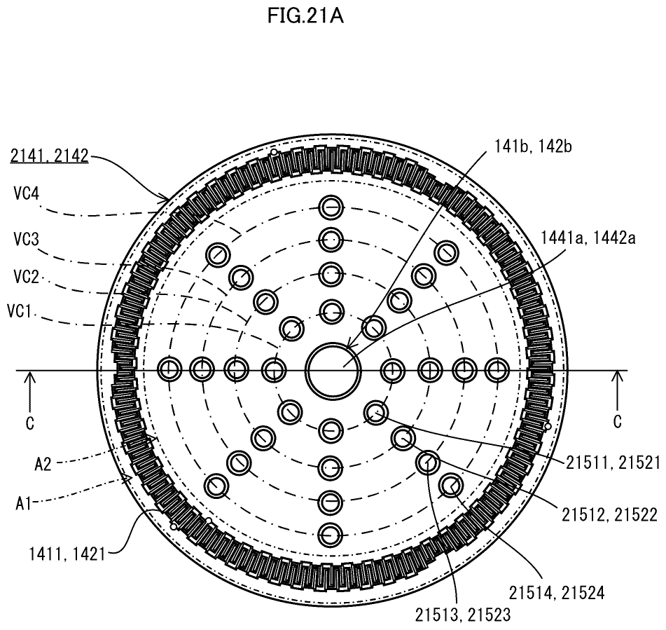

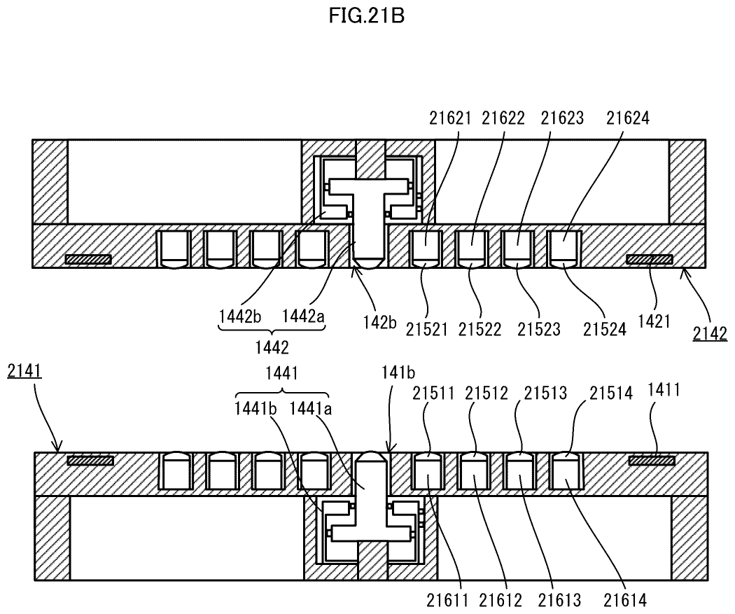

The substrate bonder according to the present embodiment has a structure substantially similar to that of the substrate bonder 1 constituting the substrate bonding system described in the first embodiment, and as illustrated in FIGS. 21A and 21B, only the structures of the stage 2141 and the head 2142 are different from those of the first embodiment. In FIGS. 21A and 21B, the same components as those of Embodiment 1 are denoted by the same reference numerals as those in FIGS. 5A and 5B. The substrate bonder according to the present embodiment includes a chamber 120, a stage 2141, a head 2142, a stage drive unit 143, a head drive unit 144, substrate heating units 1481 and 1482, a position measurement unit 500, and a distance measurement unit 1493, similarly to the substrate bonder 1 described in Embodiment. In the following description, the same reference numerals as those used in Embodiment 1 will be appropriately used to describe the same configurations as those of Embodiment 1.

The stage 2141 and the head 2142 are disposed to face each other in the vertical direction in the chamber 120. The stage 2141 is a first substrate holding unit that holds the substrate W1 on its upper surface, and the head 2142 is a second substrate holding unit that holds the substrate W2 on its lower surface. Here, the stage 2141 supports the substrate W1 in a state where the upper surface thereof is in surface contact with the entire substrate W1, and the head 2142 supports the substrate W2 in a state where the lower surface thereof is in surface contact with the entire substrate W2. The stage 2141 and the head 2142 are made of a translucent material such as glass having translucency, for example. As illustrated in FIG. 21A, the stage 2141 is provided with an electrostatic chuck 1411 that holds the substrate W1, a pressing mechanism 1441 that presses a central portion of the substrate W1, and a plurality of (32 in FIG. 21A) pressing members 21511, 21512, 21513, and 21514 each having a circular shape in plan view. As illustrated in FIG. 21B, the stage 2141 is provided with piezo actuators 21611, 21612, 21613, and 21614. As illustrated in FIG. 21A, the head 2142 is provided with an electrostatic chuck 1421 that holds the substrate W2, a pressing mechanism 1442 that presses a central portion of the substrate W2, and a plurality of (32 in FIG. 21A) pressing members 21521, 21522, 21523, and 21524 each having a circular shape in plan view. As illustrated in FIG. 21B, the head 2142 is provided with piezo actuators 21621, 21622, 21623, and 21624. The electrostatic chucks 1411 and 1421 are provided in the annular first region A1 facing the peripheral portions of the substrates W1 and W2 in the stage 2141 and the head 2142 in a state where the substrates W1 and W2 are held by the stage 2141 and the head 2142. The electrostatic chucks 1411 and 1421 hold peripheral portions of the substrates W1 and W2, respectively. Through holes 141b and 142b having a circular shape in plan view are provided in a central portion of the stage 141 and the head 142.

The pressing members 21511, 21512, 21513, and 21514 are respectively disposed along four virtual circles VC1, VC2, VC3, and VC4 whose central portions coincide with the central portion of the stage 2141 in the second area A2 of the stage 2141. Then, the pressing members 21511, 21512, 21513, and 21514 press a portion facing the second region A2 in the substrate W1 disposed at a preset substrate holding position in the stage 2141. Each of piezo actuators 21611, 21612, 21613, and 21614 is a pressing member drive unit that drives corresponding one of the pressing members 21511, 21512, 21513, and 21514 in a direction of projecting the pressing members from the stage 2141 or a direction of embedding the pressing members into the stage 2141. The pressing members 21521, 21522, 21523, and 21524 are also respectively disposed along four virtual circles VC1, VC2, VC3, and VC4 whose central portions coincide with the central portion of the head 2142 in the second area A2 of the head 2142. Then, the pressing members 21521, 21522, 21523, and 21524 press a portion facing the second region A2 in the substrate W2 disposed at a preset substrate holding position in the head 2142. Each of piezo actuators 21621, 21622, 21623, and 21624 is a pressing member drive unit that drives corresponding one of the pressing members 21521, 21522, 21523, and 21524 in a direction of projecting the pressing members from the head 2142 or a direction of embedding the pressing members into the head 2142.

The controller 9 controls the movement amount of each of the pressing members 21511, 21512, 21513, and 21514 by controlling the amount of change in the length of the piezo actuators 21611, 21612, 21613, and 21614 in the direction in which the stage 2141 and the head 2142 face each other. Then, the controller 9 controls the piezo actuators 21611, 21612, 21613, and 21614 such that the speed at which the plurality of pressing members 21511, 21512, 21513, and 21514 sequentially come into contact with the substrate W1 from the side closer to the central portion of the stage 2141 is faster than the speed at which temporary bonding of the substrates W1 and W2 proceeds from the state in which the central portions of the bonding surfaces of the substrates W1 and W2 are in contact with each other toward the peripheral portions of the substrates W1 and W2. The controller 9 controls the movement amount of each of the pressing members 21521, 21522, 21523, and 21524 by controlling the amount of change in the length of the piezo actuators 21621, 21622, 21623, and 21624 in the direction in which the stage 2141 and the head 2142 face each other. Then, the controller 9 controls the piezo actuators 21611, 21612, 21613, and 21614 such that the speed at which the plurality of pressing members 21521, 21522, 21523, and 21524 sequentially come into contact with the substrate W2 from the side closer to the central portion of the stage 2142 is faster than the speed at which temporary bonding of the substrates W1 and W2 proceeds from the state in which the central portions of the bonding surfaces of the substrates W1 and W2 are in contact with each other toward the peripheral portions of the substrates W1 and W2.

The flow of a series of operations in the substrate bonding system according to the present embodiment from when the substrates W1 and W2 are put in when the substrates W1 and W2 are bonded and extracted from the substrate bonding system is substantially the same as that in the first embodiment, and only a part of the operations in the substrate bonding step is different from that in the first embodiment. The substrate bonding step executed by the substrate bonding system according to the present embodiment will be described in detail with reference to FIG. 14, 22A to 23B.

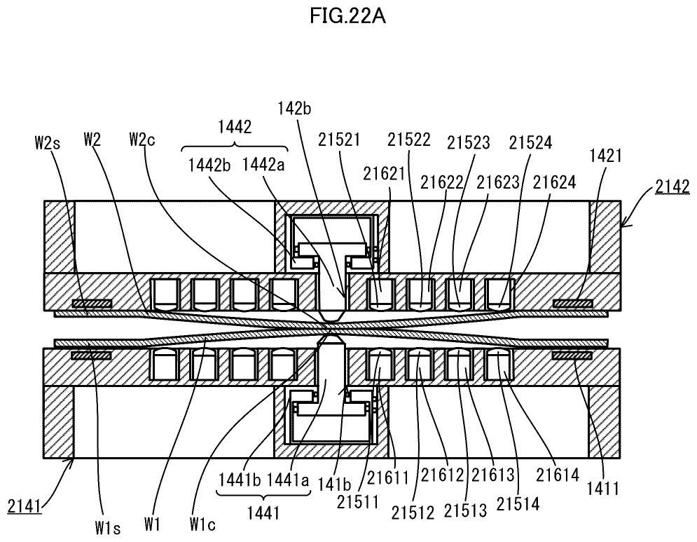

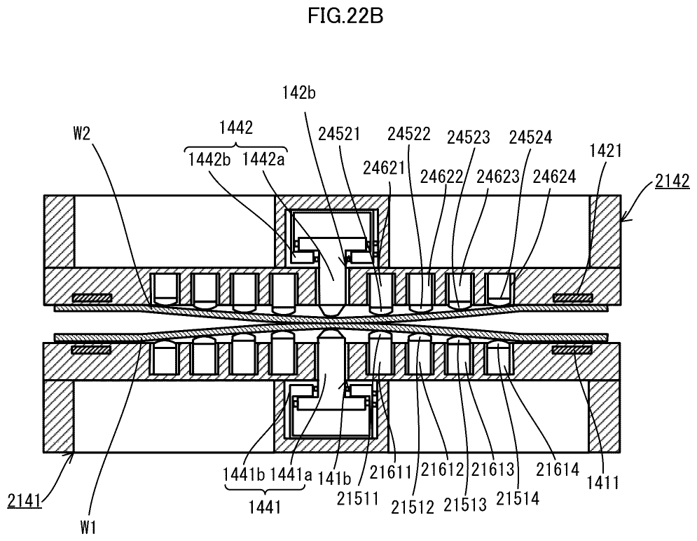

First, as illustrated in FIG. 14, the substrate bonder executes a series of operations from steps S1 to S4. Next, the substrate bonder brings the substrates W1 and W2 close to each other by further bringing the head 142 close to the stage 141 (step S5). Subsequently, the substrate bonder executes a first contact step of bringing the central portion of the substrate W1 and the central portion of the substrate W2 into contact with each other by warping the substrates W1 and W2 in a state where the substrates W1 and W2 are separated from each other (step S6). At this time, for example, as illustrated in FIG. 22A, the substrate bonder warps the substrate W1 such that the central portion W1c of the substrate W1 projects toward the substrate W2 by pressing the central portion of the substrate W1 toward the substrate W2 by the pressing portion 1441a in a state where the peripheral portion of the substrate W1 is held by the electrostatic chuck 1411. The substrate bonder also warps the substrate W2 such that the central portion of the substrate W2 projects toward the substrate W1 by pressing the central portion of the substrate W2 toward the substrate W1 by the pressing portion 1442a in a state where the peripheral portion of the substrate W2 is held by the electrostatic chuck 1422. Then, as illustrated in FIG. 22B, the substrate bonder abuts the pressing members 21511, 21512, 21513, and 21514 against the substrate W1 with the piezo actuators 21611, 21612, 21613, and 21614. The substrate bonder also abuts the pressing members 21521, 21522, 21523, and 21524 against the substrate W2 with the piezo actuators 21621, 21622, 21623, and 21624.

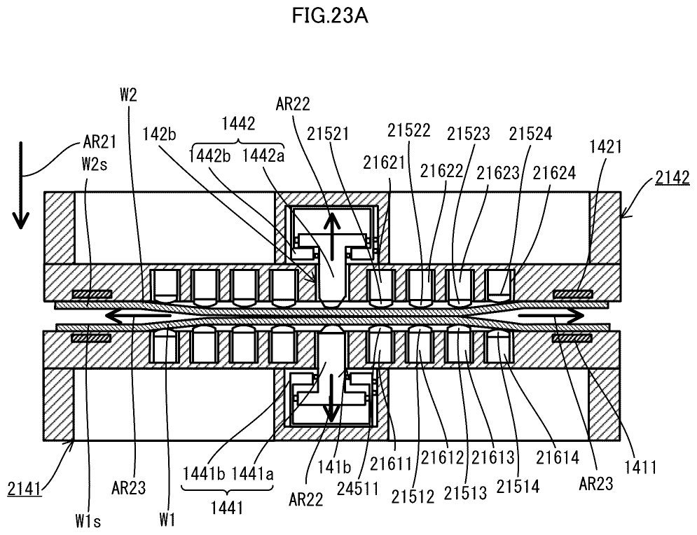

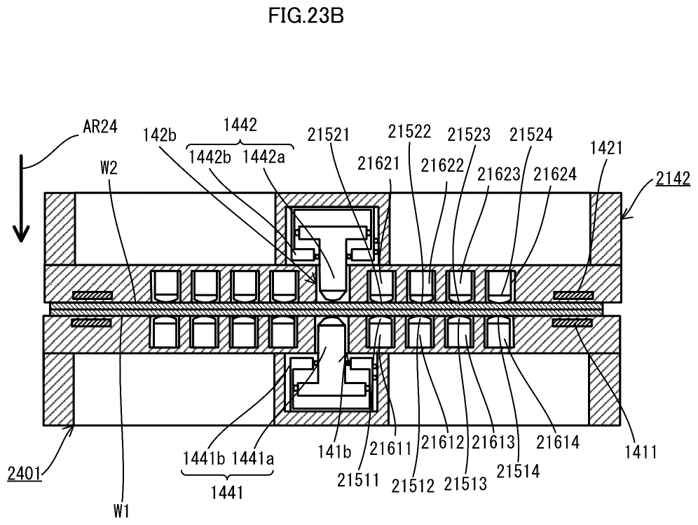

Subsequently, as illustrated in FIG. 14, the substrate bonder executes a second contact step of expanding the contact portions of the substrates W1 and W2 from central portions W1c and W2c of the substrates W1 and W2 toward peripheral portions W1s and W2s (step S7). Here, as indicated by the arrows AR22 in FIG. 23A, the substrate bonder moves the pressing unit 1441a in a direction of embedding the pressing unit 1441a in the stage 2141 and moves the pressing unit 1442a in a direction of embedding the pressing unit 1442a in the head 2142. At the same time, the substrate bonder moves the head 2142 in the direction of approaching the stage 2141 as indicated by the arrow AR21. Then, the substrate bonder preferentially presses the substrate W1 from one of the pressing members 21511, 21512, 21513, and 21514 positioned on the central portion side of the stage 2141. The substrate bonder also preferentially presses the substrate W2 from one of the pressing members 21521, 21522, 21523, and 21524 positioned on the central portion side of the head 2142. As a result, as indicated by the arrows AR23, the contact portion between the substrates W1 and W2 expands from the central portion toward the peripheral portion of the substrates W1 and W2 starting from the central portion point-pressurized by the pressing mechanisms 1441 and 1432.

Thereafter, a series of processing from steps S8 to S12 is executed. Then, it is assumed that the substrate bonder has determined that all of the calculated positional shift amounts dx, dy, and dθ are equal to or less than preset positional shift amount thresholds dxth, dyth, and doth (step S9: Yes). In this case, the substrate bonder 1 further expands the contact portion between the substrates W1 and W2 from the central portions of the substrates W1 and W2 toward the peripheral portions to bring the substrates W1 and W2 into contact with each other over the entire surface (step S13). Here, as illustrated in FIG. 23B, the substrate bonder moves the pressing unit 1441a of the pressing mechanism 1441 in the direction of embedding the pressing unit 1441 in the stage 2141 and moves the pressing unit 1442a of the pressing mechanism 1442 in the direction of embedding the pressing unit 1442a in the head 2142, and at the same time, further moves the head 142 in the direction of approaching the stage 141 as indicated by the arrow AR24, thereby reducing the distance between the peripheral portions of the substrates W1 and W2. In this manner, the substrate bonder 1 brings the peripheral portion of the substrate W1 into contact with the peripheral portion of the substrate W2 and brings the bonding surfaces of the substrates W1 and W2 into contact with each other on the entire surfaces.

The description returns to FIG. 14. Next, the substrate bonder 1 executes the main bonding process of bonding the substrates W1 and W2 (step S14), and then stops the electrostatic chuck 1421 of the head 2142 to release the holding of the substrate W2 (step S15). Then, the substrate bonder 1 executes the processing after step S16.

As described above, in the substrate bonder according to the present embodiment, in a state where the central portion of the substrate W1 and the central portion of the substrate W2 are in contact with each other and the peripheral portion of the substrate W1 is held by the stage 2141, the substrates W1 and W2 are brought into contact with each other while the substrate W1 is preferentially pressed from the pressing member 21511, 21512, 21513, or 21514 from the position on the central portion side of the stage 2141. At this time, the substrate bonder also preferentially presses the substrate W2 from one of the pressing members 21521, 21522, 21523, and 21524 positioned on the central portion side of the head 2142. With this configuration, the pressure of the gas discharged from the grooves 1413d and 1423d is effectively applied to the force for bringing the substrates W1 and W2 into close contact with the stage 141 and the head 142 because of the residual electrostatic force remaining between the electrode elements 1413b and 1423b after releasing the holding with the electrostatic chucks 1413 and 1423. Thus, the substrates W1 and W2 are in a free state with respect to the force for bringing the substrates W1 and W2 into close contact with the stage 141 and the head 142. Then, in this state, bonding can be advanced from the central portions of the substrates W1 and W2 toward the peripheral portions in a state where there is no influence of the adhesion force to the stage 141 and the head 142 by pressurizing and bringing the central portions of the substrates W1 and W2 into contact with each other at a pressure equal to or higher than the critical pressure. Thus, the substrates W1 and W2 can be bonded on the entire surfaces with high positional accuracy without distortion.

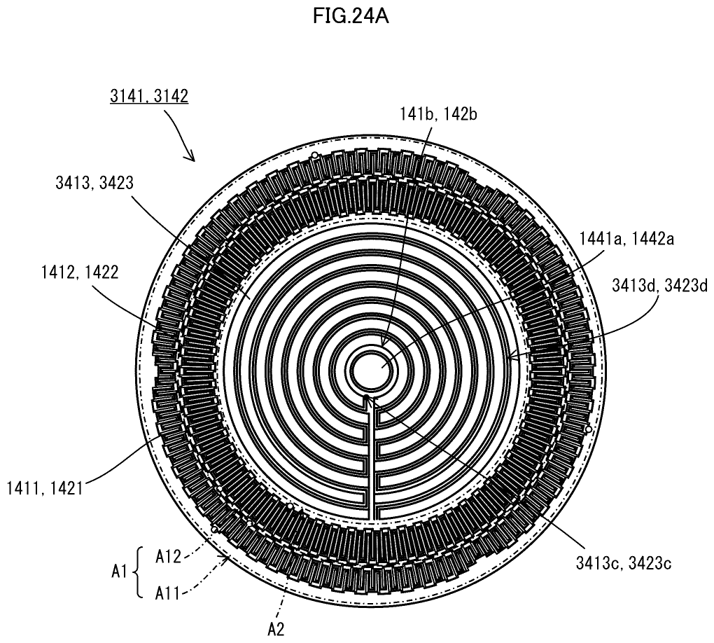

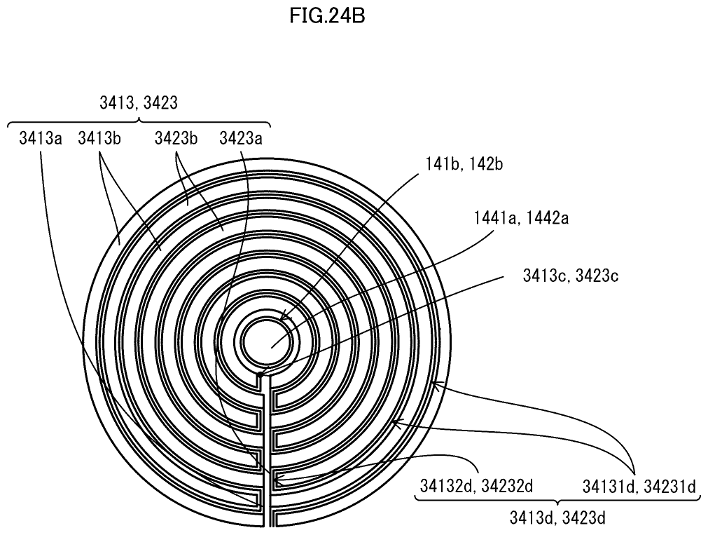

Although each embodiment of the present invention has been described above, the present invention is not limited to the configuration of each embodiment described above. For example, as illustrated in FIG. 24A, the stage 3141 and the head 3142 may respectively include grooves 34131d and 34231d having a plurality of arc-shaped sub grooves 3413d and 3423d extending concentrically and having different diameters, and gas discharge holes 3413c and 3423c communicating with the grooves 3413d and 3423d. In FIG. 24A, the same components as those of the first embodiment are denoted by the same reference numerals as those in FIG. 5A. Here, as illustrated in FIG. 24B, the plurality of sub grooves 34131d and 34231d communicate with the other sub grooves 34131d and 34231d adjacent to each other in the radial direction of the stage 4141 and the head 3142 at both ends thereof via the sub grooves 34132d and 34232d extending in the radial direction of the stages 3141 and 4142.

The electrostatic chucks 3413 and 3423 according to the present modification have a plurality of electrode elements 3413b and 3423b extending in an arc shape around the central portion of the stage 4141 and the head 4142 and a plurality of terminal electrodes 3413a and 3423a in the second region A2, respectively. The plurality of electrode elements 3413b and 3423b are concentric around the central portion of the stage 4141 and the head 4142, and are alternately disposed in the radial direction. Each of the plurality of terminal electrodes 3413a extends in the radial direction of the stage 4141 and the head 4142, and couples one end portions of two electrode elements 3423b adjacent to each other with one electrode element 3413b interposed therebetween in the radial direction of the stage 4141 and the head 4142. Each of the plurality of terminal electrodes 3423a also extends in the radial direction of the stage 4141 and the head 4142, and couples one end portions of two electrode elements 3413b adjacent to each other with one electrode element 3423b interposed therebetween in the radial direction of the stage 4141 and the head 4142.

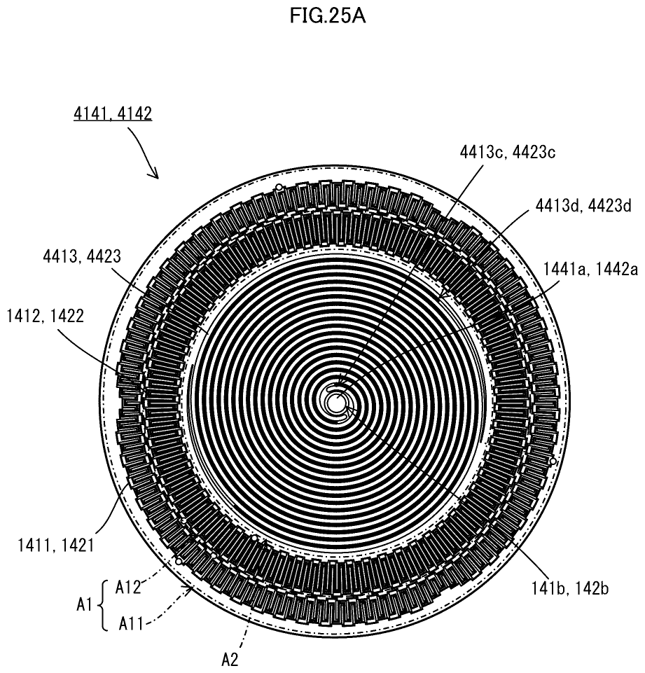

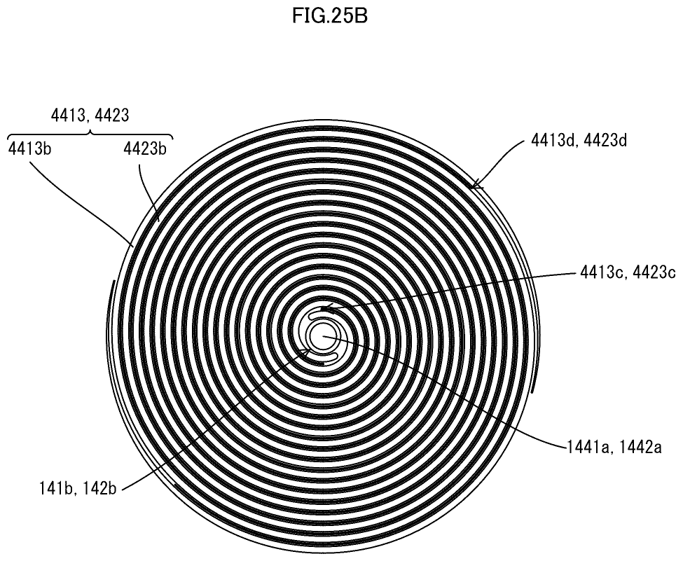

Alternatively, for example, as illustrated in FIG. 25A, the stage 4141 and the head 4142 may have spiral grooves 4413d and 4423d and a plurality of gas discharge holes 4413c and 4423c communicating with the grooves 4413d and 4423d, respectively. In FIG. 25A, the same components as those of the first embodiment are denoted by the same reference numerals as those in FIG. 5A.

As illustrated in FIG. 25B, the electrostatic chucks 4413 and 4423 according to the present modification have two electrode elements 4413b and 4423b extending in a spiral shape around the central portion of the stage 4141 and the head 4142 in the second region A2, respectively. At least one side of one of the two electrode elements 4413b and 4423b in the radial direction of the stage 4141 and the head 4142 is provided with the other electrode element.

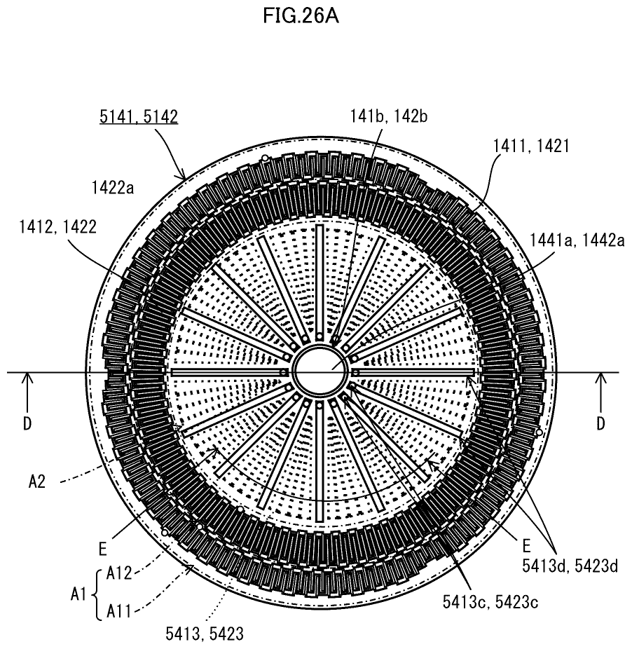

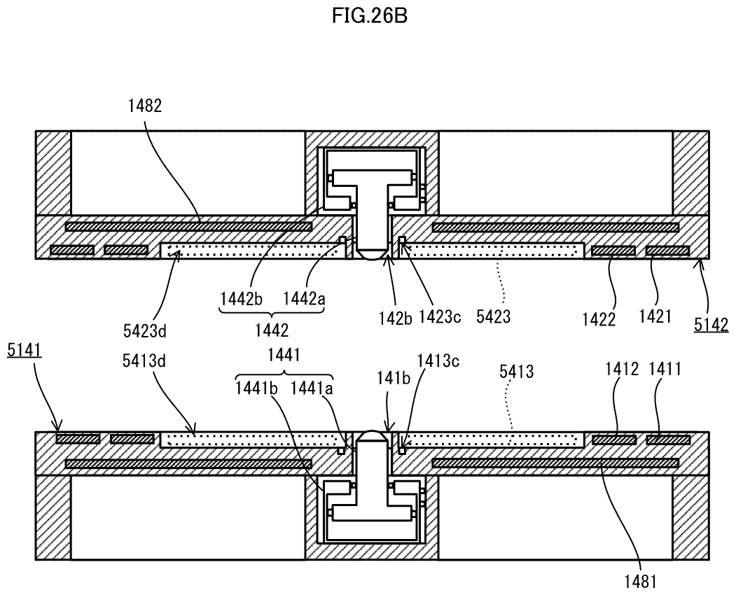

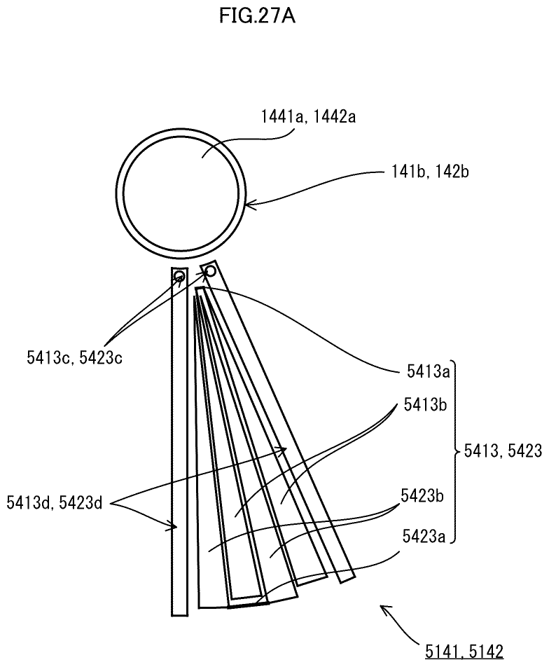

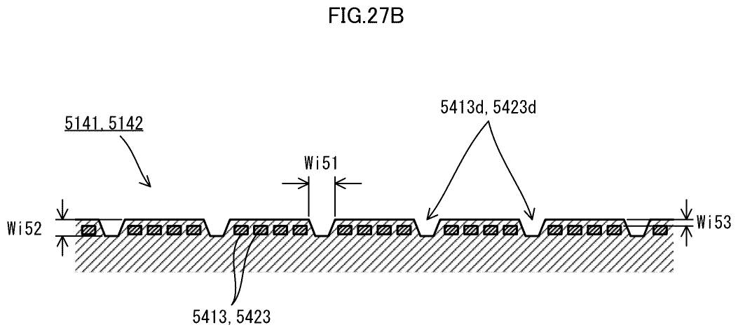

In addition, for example, as illustrated in FIG. 26A, in the second region A2 inside the first region A1 in the stage 5141 and the head 5142, a plurality of long and thin grooves 5413d and 5423d extending radially and gas discharge holes 5413c and 5423c opened at the bottom of the end portion on the central portion side of the stage 5141 and the head 5142 in the grooves 5413d and 5423d may be provided. As illustrated in FIG. 26B, a groove does not have to be provided in the first region A1. In FIGS. 26A and 26B, the same components as those of the first embodiment are denoted by the same reference numerals as those in FIGS. 5A and 7A. In the stage 5141 and the head 5142 according to the present modification, in the second region A2, the electrostatic chucks 5413 and 5423 are disposed between the two grooves 5413d and 5423d adjacent to each other in the circumferential direction of the stage 5141 and the head 5142. Here, the width Wi51 of the grooves 5413d and 5423d is set to, for example, about 0.2 mm. As illustrated in FIG. 27A, the electrostatic chucks 5413 and 5423 include two arc-shaped terminal electrodes 5413a and 5423a extending in the circumferential direction of the stage 5141 and the head 5142, and a plurality of elongated electrode elements 5413b and 5423b extending from the two terminal electrodes 5413a and 5423a toward the other terminal electrodes 5423a and 5413a, respectively, along the radial direction of the stage 5141 and the head 5142. Here, the electrode elements 5413b and 5423b have a wedge shape in plan view in which the width increases toward the peripheral edge side of the stage 5141 and the head 5142, respectively. As illustrated in FIG. 27B, a width Wi53 between the electrostatic chucks 5413 and 5423 and the surfaces of the stage 5141 and the head 5142 is set shorter than a depth Wi52 of the grooves 5413d and 5423d.

In Embodiment 1, an example has been described in which the two annular sub-annular regions A11 and A12 are set in the first region A1 of the stage 141 and the head 142, and the electrostatic chucks 1411, 1421, 1412, and 1422 are disposed in the respective sub-annular regions A11 and A12. However, the number of sub-annular regions set in the first region A1 is not limited to two. For example, three or more annular sub-annular regions may be set in the first region A1, and an electrostatic chuck may be disposed in each sub-annular region.

In Embodiment 1, an example has been described in which the substrate bonder 1 first fills the entire groove 1413d provided in the second region A2 with gas from the gas discharge hole 1413c provided in the second region A2 of the stage 141 and the head 142, and then releases the holding of the substrates W1 and W2 with the electrostatic chucks 1413 and 1423. However, the present invention is not limited to this configuration, and for example, the substrate bonder 1 may discharge gas from the gas discharge holes 1413c and 1423c provided in the second region A2 of the stage 141 and the head 142 toward the grooves 1413d and 1423d provided in the second region A2 after releasing the holding of the substrates W1 and W2 with the electrostatic chucks 1413 and 1423. At this time, the controller 9 controls the gas supply unit 1492 such that the gas is discharged from the gas discharge holes 1413c and 1423c so that the pressure at which the substrates W1 and W2 are brought into contact with each other becomes lower than the critical pressure at which the substrates W1 and W2 are temporarily bonded. With this configuration, the pressure of the gas discharged from the gas discharge holes 1413c and 1423c via the grooves 1413d and 1423d is effectively applied to the force for bringing the substrates W1 and W2 into close contact with the stage 141 and the head 142 because of the residual electrostatic force remaining between the electrode elements 1413b and 1423b after releasing the holding with the electrostatic chucks 1413 and 1423. Thus, the substrates W1 and W2 are in a free state with respect to the force for bringing the substrates W1 and W2 into close contact with the stage 141 and the head 142. Then, in this state, bonding can be advanced from the central portions of the substrates W1 and W2 toward the peripheral portions in a state where there is no influence of the adhesion force to the stage 141 and the head 142 by pressurizing and bringing the central portions of the substrates W1 and W2 into contact with each other at a pressure equal to or higher than the critical pressure. Thus, the substrates W1 and W2 can be bonded on the entire surfaces with high positional accuracy without distortion.

In Embodiment 1, the controller 9 may calculate the horizontal offset vector without using the captured image of the alignment mark captured by the imaging unit 73 of the inspection device 7. In this case, the controller 9 calculates the positional shift amount and the positional shift direction of the alignment marks MK1a, MK1b, MK1c, MK2a, MK2b, and MK2c based on the captured images obtained by imaging the alignment marks MK1a, MK1b, MK1c, MK2a, MK2b, and MK2c in a state where the substrates W1 and W2 are separated after the substrates W1 and W2 are aligned and the captured images obtained by imaging the alignment marks MK1a, MK1b, MK1c, MK2a, MK2b, and MK2c of the substrates W1 and W2 bonded to each other with the imaging units 501A, 501B, and 501C. Specifically, the controller 9 calculates a positional shift amount error from the captured images obtained by imaging the alignment marks MK1a, MK1b, MK1c, MK2a, MK2b, and MK2c after the substrates W1 and W2 are separated from each other and the alignment of the substrates W1 and W2 is completed. Then, the controller 9 subtracts the positional shift amount error from the positional shift amount calculated from the captured images obtained by imaging the alignment marks MK1a, MK1b, MK1c, MK2a, MK2b, and MK2c of the substrates W1 and W2 bonded to each other, thereby calculating the positional shift amount at the time of bonding the substrates W1 and W2. Then, the controller 9 may calculate the horizontal offset vector of the substrate W2 with respect to the substrate W1 when the substrates W1 and W2 are bonded based on the calculated positional shift amount and positional shift direction. Here, the horizontal offset amount is calculated for each set of alignment marks MK1a and MK2a (MK1b and MK2b, MK1c and MK2c).

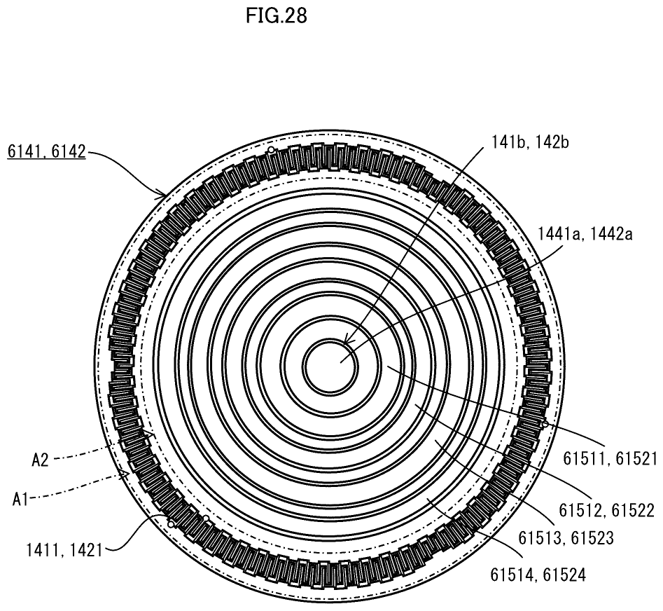

In Embodiment 2, an example has been described in which the plurality of pressing members 21511, 21512, 21513, and 21514 are disposed along the four virtual circles whose central portion coincides with the central portion of the stage 2141 in the second region A2 of the stage 2141, respectively, and the plurality of pressing members 21521, 21522, 21523, and 21524 are disposed along the four virtual circles whose central portion coincides with the central portion of the head 2142 in the second region A2 of the head 2142, respectively. However, the present invention is not limited to this configuration, and for example, as illustrated in FIG. 28, a plurality of (four in FIG. 28) pressing members 61511, 61512, 61513, and 61514 disposed on the stage 6141 may have annular shapes having different inner diameters, and the plurality of pressing members 61511, 61512, 61513, and 61514 disposed on the head 6142 may also have annular shapes having different inner diameters. Here, the four pressing members 61511, 61512, 61513, and 61514 are concentrically disposed whose central portions coincide with the central portion of the stage 6141 in the second region A2 of the stage 6141. The four pressing members 61521, 61522, 61523, and 61524 are also concentrically disposed whose central portions coincide with the central portion of the head 6142 in the second region A2 of the head 6142.

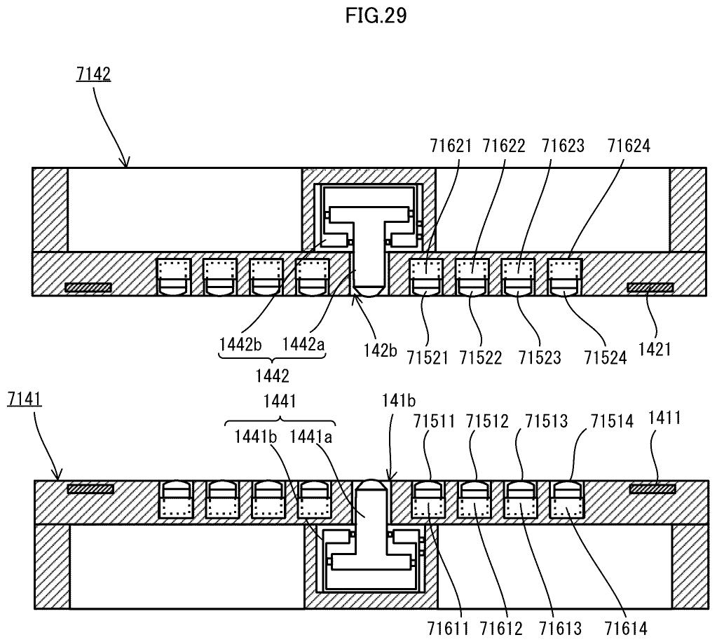

In Embodiment 2, an example has been described in which the piezo actuators 21611, 21612, 21613, and 21614 drive the pressing members 21511, 21512, 21513, and 21514, respectively, and the piezo actuators 21621, 21622, 21623, and 21624 drive the pressing members 21521, 21522, 21523, and 21524, respectively. However, the means for driving the pressing members 21511, 21512, 21513, 21514, 21521, 21522, 21523, and 21524 is not limited to these members. For example, as in a stage 7141 illustrated in FIG. 29, the pressing members 71511, 71512, 71513, and 71514 may constitute pistons driven by air cylinders 71611, 71612, 71613, and 71614, respectively. As in a head 7142 illustrated in FIG. 29, the pressing members 71521, 71522, 71523, and 71524 may constitute pistons driven by air cylinders 71621, 71622, 71623, and 71624, respectively. Here, the air cylinders 71611, 71612, 71613, and 71614 individually move the pressing members 21511, 21512, 21513, and 21514 in a direction approaching the head 2142 or a direction away from the head 2142 with air pressure. The air cylinders 71621, 71622, 71623, and 71624 individually move the pressing members 21521, 21522, 21523, and 21524 in a direction approaching the stage 2141 or a direction away from the head 2142 with air pressure.

In this case, the controller 9 may control the air cylinders 71621, 71622, 71623, and 71624 such that the pressing members 21511, 21512, 21513, and 21514 press the substrate W1 with the pressure at which the substrate W1 comes into contact with the substrate W2 less than the critical pressure at which the substrates W1 and W2 are temporarily bonded. In this case, the substrate bonder first presses the substrates W1 and W2 with the pressing members 21511, 21512, 21513, 21514, 21521, 21522, 21523, and 21524 such that the pressure at which the substrate W1 comes into contact with the substrate W2 is less than the critical pressure at which the substrates W1 and W2 are temporarily bonded. Thereafter, the substrate bonder may press the central portions of the substrates W1 and W2 by the pressing units 1441a and 1432a in a state where the peripheral portions of the substrates W1 and W2 are held by the electrostatic chucks 1411 and 1412 by applying a voltage from the chuck drive unit 1491 to the stage 141 and the electrostatic chucks 1411 and 1412 of the head 142.

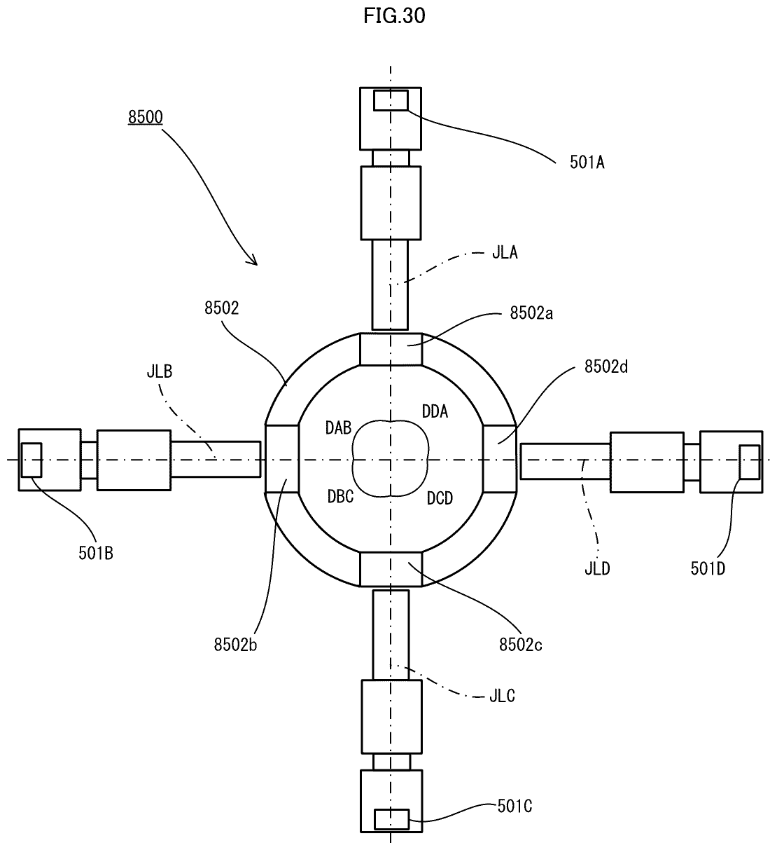

In Embodiment 1, an example has been described in which the position measurement unit 500 includes the three imaging units 501A, 501B, and 501C, but the number of imaging units is not limited to three. For example, like a position measurement unit 8500 illustrated in FIG. 30, the position measurement unit may include four imaging units 501A, 501B, 501C, and 501D, and a reflection member 6502 in which four reflection surfaces 6502a, 6502b, 6502c, and 6502d corresponding to the four imaging units 501A, 501B, 501C, and 501D, respectively, are formed. Here, the four imaging units 501A, 501B, 501C, and 501D are disposed around the reflection member 6502 such that angles DAB, DBC, DCD, and DDA on the acute angle side formed by two optical axes JLA and JLB (JLB and JLC, JLC and JLD, and JLD and JLA) adjacent to each other in the circumferential direction of the reflection member 6502 are equal.

In each embodiment, for example, a water gas supply unit (not illustrated) that supplies water gas into the chamber 851 of the load lock unit 85 or the chamber 863 of the conveyance device 86 may be provided. The water gas supply unit mixes a carrier gas such as argon (Ar), nitrogen (N2), helium (He), or oxygen (O2) with vaporized water to generate and supply water gas. The water gas supply unit is connected to the chamber 851 of the load lock unit 85 via a supply valve and a supply pipe. The flow rates of the water gas and the carrier gas introduced into the chamber 851 are adjusted by controlling the opening degree of the supply valve. The water gas supply unit may be configured to accelerate molecules, clusters, and the like of water (H2O) and irradiate the bonded surfaces of the substrates W1 and W2. Here, the water gas supply unit may be formed of a particle beam source that emits accelerated water (H2O) particles. In this case, the particle beam source may be configured to generate water gas using, for example, an ultrasonic wave generating element. Alternatively, a mixed gas of a carrier gas and water (H2O) generated by the above-described bubbling, ultrasonic vibration, or the like may be introduced into the above-described particle beam source to generate a particle beam of water and irradiate the bonding surfaces of the substrates W1 and W2 with the particle beam. In addition, the substrate bonding system exposes the bonding surfaces of the substrates W1 and W2 to water gas without opening the inside of the chamber 851 to the atmosphere after the substrates W1 and W2 are conveyed into the chamber 851 of the load lock unit 85, for example, in the step of step S104 in FIG. 12 described above. Then, the substrate bonding system opens the inside of the chamber 851 to the atmosphere by opening a gate 8531 of the chamber 851 on the conveyance device 82 side. Instead of the water gas supply unit, a gas supply unit (not illustrated) that supplies a gas including H group and OH group into the chamber 851 of the load lock unit 85 or the chamber 863 of the conveyance device 86 may be provided.

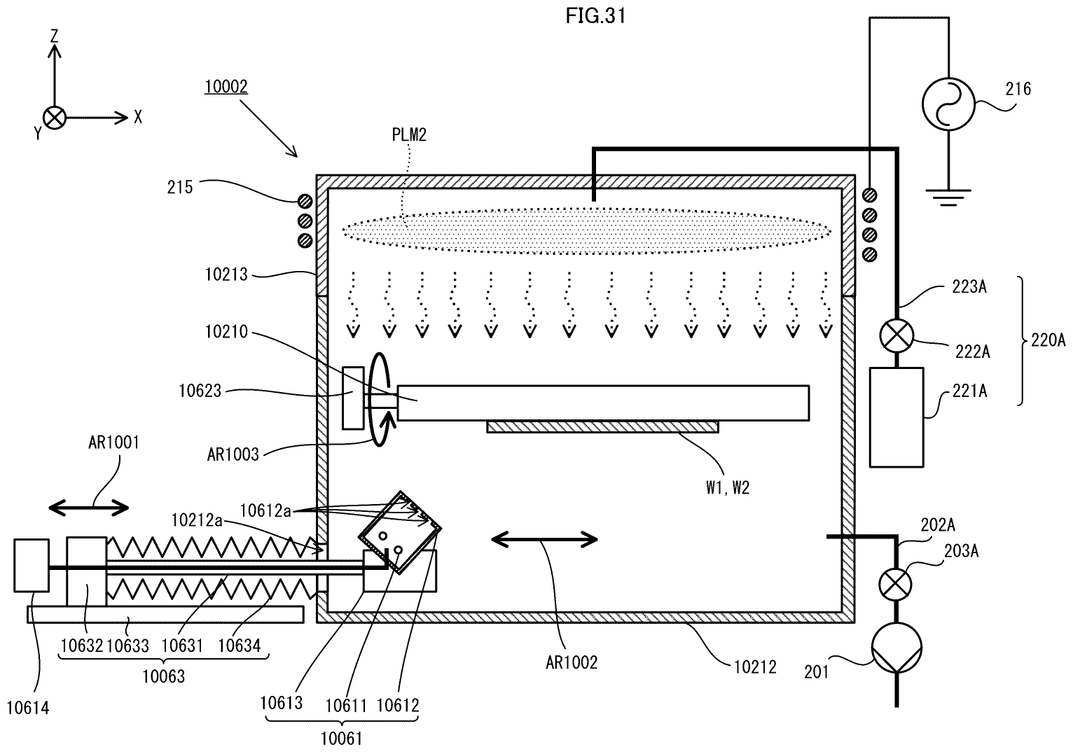

In each embodiment, the substrate bonding system may include an activation processing device 10002 having a particle beam source that irradiates the substrates W1 and W2 with a particle beam to activate the bonding surfaces of the substrates W1 and W2, for example, as illustrated in FIG. 31. The activation processing device 10002 includes a chamber 10212, a stage 10210 that holds the substrates W1 and W2, a particle beam source 10061, and a beam source conveyance unit 10063. In FIG. 31, the same components as those of each embodiment are denoted by the same reference numerals as those in FIG. 2. The activation processing device 10002 includes a plasma chamber 10213, an induction coil 215, and a high-frequency power supply 216. Further, the activation processing device 10002 includes a stage drive unit 10623 that rotationally drives the stage 10210 around one axis orthogonal to the thickness direction thereof as indicated by the arrow AR1003 in FIG. 31. The stage 10210 includes, for example, a vacuum chuck, and the chuck sucks and holds the substrates W1 and W2 when the substrates W1 and W2 are put in.

The particle beam source 10061 is, for example, a fast atom beam (FAB, Fast Atom Beam) source, and includes a discharge chamber 10612, an electrode 10611 disposed in the discharge chamber 10612, a beam source drive unit 10613, and a gas supply unit 10614 that supplies a nitrogen gas into the discharge chamber 10612. A peripheral wall of the discharge chamber 10612 is provided with a FAB radiation port 10612a through which neutral atoms are emitted. The discharge chamber 10612 is formed of a carbon material. Here, the discharge chamber 10612 has an elongated box shape, and a plurality of FAB radiation ports 10612a are arranged side by side on straight lines along the longitudinal direction thereof. The beam source drive unit 10613 includes a plasma generation unit (not illustrated) that generates plasma of nitrogen gas in the discharge chamber 10612, and a DC power source (not illustrated) that applies a DC voltage between the electrode 10611 and the peripheral wall of the discharge chamber 10612. The beam source drive unit 10613 applies a DC voltage between the electrode 10611 and the peripheral wall of the discharge chamber 10612 in a state a plasma of nitrogen gas is generated in the discharge chamber 10612. At this time, nitrogen ions in the plasma are attracted to the peripheral wall of the discharge chamber 10612. At this time, when passing through the FAB radiation port 10612a, the nitrogen ions directed to the FAB radiation port 10612a receive electrons from the peripheral wall of the discharge chamber 10612 formed of the carbon material on the outer peripheral portion of the FAB radiation port 10612a. Then, the nitrogen ions become electrically neutralized nitrogen atoms and are discharged to the outside of the discharge chamber 10612. However, some of the nitrogen ions cannot receive electrons from the peripheral wall of the discharge chamber 10612, and are released to the outside of the discharge chamber 10612 as nitrogen ions. A part or the whole of the discharge chamber 10612 may be formed of Si. With such a configuration, Si particles are emitted simultaneously with the Ar beam, thus Si is implanted into the interface, OH groups are attached to the implanted Si, more OH groups can be generated, and the bonding strength can be increased.

The beam source conveyance unit 10063 includes a support rod 10631 that is long, is inserted into a hole 10212a provided in the chamber 10212, and supports the particle beam source 10061 at one end, a support 10632 that supports the support rod 10631 at the other end of the support rod 10631, and a support drive unit 10633 that drives the support 10632. The beam source conveyance unit 10063 also includes a bellows 10634 interposed between the outer peripheral portion of the hole 10212a of the chamber 10212 and the support 10632 to maintain the degree of vacuum in the chamber 10212. The support driver 10633 drives the support 10632 in directions in which the support rod 10631 is inserted into and removed from the chamber 10212 as indicated by the arrows AR1001 in FIG. 31, thereby changing the position of the particle beam source 10061 in the chamber 10212 as indicated by the arrows AR 1002 in FIG. 31. Here, the beam source conveyance unit 10063 moves the particle beam source 10061 in directions orthogonal to the arrangement direction of the plurality of FAB radiation ports 10612a.

The activation processing device 10002 also includes a nitrogen gas supply unit 220A that supplies nitrogen gas into the chamber 10212 via a supply pipe 223A. Then, when a high-frequency current is supplied to the induction coil 215 in a state where N₂ gas is introduced into the plasma chamber 10213, plasma PLM2 is formed in the plasma chamber 10213. At this time, only radicals contained in the plasma PLM2 generated in the plasma chamber 10213 downflow to the lower side of the plasma chamber 10213. At the time of irradiation with the particle beam, the pressure in the chamber 10212 is evacuated to 10⁻³ Pa level using, for example, a turbo molecular pump, but at the time of radical treatment, the pressure in the chamber 10212 is increased to about several 10 Pa.

The activation processing device 10002 first moves the particle beam source 10061 in the X-axis directions while irradiating the bonding surfaces of the substrates W1 and W2 with the particle beam. Here, for example, the activation processing device 10002 irradiates the bonding surfaces of the substrates W1 and W2 with the particle beam while moving the particle beam source 10061 in the +X direction, and then irradiates the bonding surfaces of the substrates W1 and W2 with the particle beam while moving the particle beam source 10061 in the −X direction. The moving speed of the particle beam source 10061 is set to, for example, 1.2 to 14.0 mm/sec. The power supplied to the particle beam source 10061 is set to, for example, 1 kV or 100 mA. The flow rate of the nitrogen gas or the oxygen gas introduced into the discharge chamber 10612 of the particle beam source 10061 is set to, for example, 100 sccm. Then, the activation processing device 10002 reverses the stage 10210 to bring the bonding surfaces of the substrates W1 and W2 into an orientation facing vertically upward. Then, the activation processing device 10002 irradiates the bonding surfaces of the substrates W1 and W2 with nitrogen radicals generated in the plasma chamber 10213.

In each embodiment, an example in which the imaging units 501A, 501B, and 501C are of a so-called reflection type having an imaging element and a coaxial illumination system has been described, but the configuration of the imaging unit is not limited to this configuration. For example, the imaging unit may include an imaging element (not illustrated) and a light source (not illustrated) disposed at positions facing each other with the substrates W1 and W2 interposed therebetween in the thickness direction of the substrates W1 and W2, and may have a so-called transmissive configuration in which the alignment marks MK1a, MK2a, MK1b, MK2b, MK1c, and MK2c are imaged in an arrangement in which light emitted from the light source and transmitted through the substrates W1 and W2 is received by the imaging element.

In each embodiment, an example has been described in which the substrate bonder 1 images the alignment marks MK1a, MK2a, MK1b, MK2b, MK1c, and MK2c provided three for each of the substrates W1 and W2 with the three imaging units 501A, 501B, and 501C. However, the number of the imaging units is not limited to three, and for example, the substrate bonder may include two imaging units, and the two imaging units may image two alignment marks provided on each of the substrates W1 and W2. In this case, the substrate bonder may include, for each of the two imaging units, an imaging unit position adjustment unit that moves the imaging unit in the vertical directions and the horizontal directions orthogonal to the optical axis direction and the vertical directions of each of the two imaging units. In this case, the substrate bonder receives the substrates W1 and W2 after rotating the stage 141 such that the two alignment marks are positioned between the plurality of electrode elements 1411b, 1412b, 1421b, and 1422b of the electrostatic chucks 1411, 1412, 1421, and 1422. Then, the substrate bonder may move the two imaging units to positions where the alignment marks of the substrates W1 and W2 can be imaged, and then cause the two imaging units to image the alignment marks. Further, the substrate bonder may include one imaging unit and an imaging unit position adjustment unit that moves the one imaging unit in the horizontal directions. When the imaging unit has a so-called transmissive configuration as described above, the imaging unit may include a light source position adjustment unit (not illustrated) that moves the light source according to the positions of the alignment marks MK1a, MK2a, MK1b, MK2b, MK1c, and MK2c.

In Embodiment 1, the gas supply unit 1492 may supply gas containing ions, and the gas discharge holes 1411c, 1412c, 1421c, 1422c, 1431c, and 1432c may discharge gas containing ions. In this case, there is an advantage that the residual electrostatic force of the electrostatic chucks 1411, 1421, 1412, and 1422 is neutralized by the ions contained in the gas. Thus, the substrates W1 and W2 are easily peeled off from the stage 141 and the head 142.

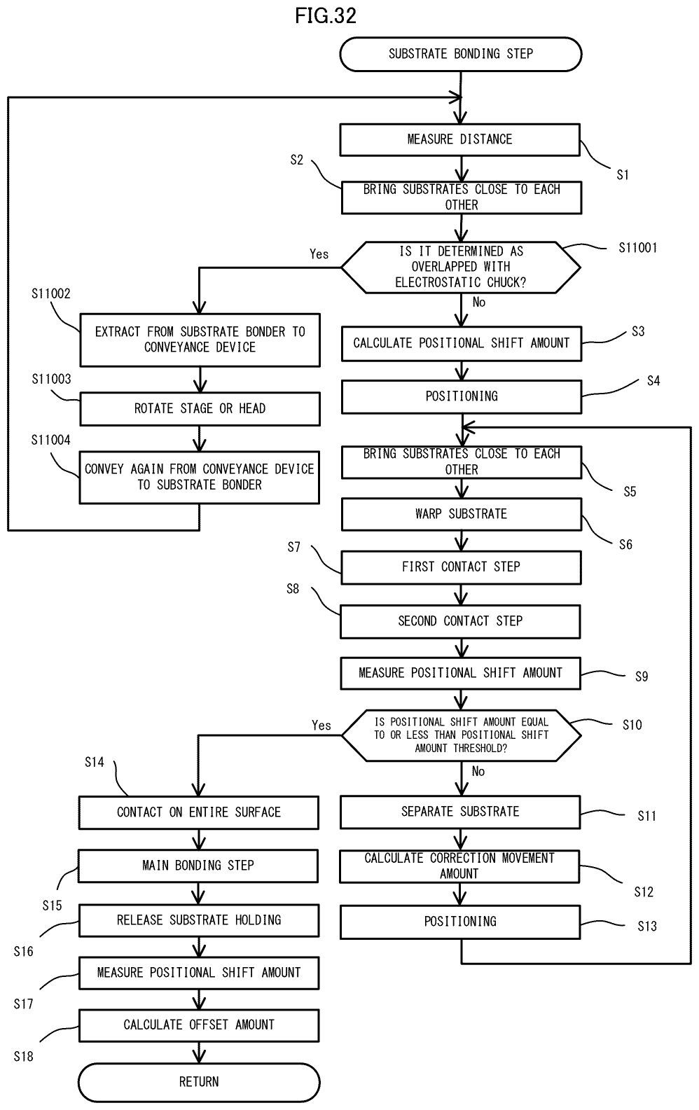

In each embodiment, in the substrate bonder 1, it may be determined whether at least one of the alignment marks MK1a, MK2a, MK1b, MK2b, MK1c, and MK2c is overlapped with any one of the electrostatic chucks 1411, 1412, 1421, and 1422. Here, the substrate bonding step executed by the substrate bonding system according to this modification will be described in detail with reference to FIG. 32. In FIG. 32, the same components as those of Embodiment 1 are denoted by the same reference numerals as those in FIG. 14. First, the substrate bonder 1 executes the distance measuring step of measuring the distance between the stage 141 and the head 142 at three points of the stage 141 and the head 142 with the distance measurement unit 1493 (step S1). Next, the substrate bonder 1 calculates the distance between the bonding surface of the substrate W1 and the bonding surface of the substrate W2 based on the measured distances between the stage 141 and the head 142 at the three points of the stage 141 and the head 142 and the thicknesses of the substrates W1 and W2. Then, the substrate bonder 1 moves the head 142 vertically downward based on the calculated distance to bring the substrates W1 and W2 close to each other (step S2). Subsequently, the substrate bonder 1 acquires captured images of the two substrates W1 and W2 from the imaging units 501A, 501B, and 501C of the position measurement unit 500. Then, the substrate bonder 1 determines whether at least one of the alignment marks MK1a, MK2a, MK1b, MK2b, MK1c, and MK2c used for calculating the positional shift amount is overlapped with any of the electrostatic chucks 1411, 1412, 1421, and 1422 based on the captured image (step S11001). Here, when the substrate bonder 1 determines that none of the alignment marks MK1a, MK2a, MK1b, MK2b, MK1c, and MK2c used for calculating the positional shift amount is overlapped with the electrostatic chucks 1411, 1412, 1421, or 1422 (step S11001: No), the processing in and after step S3 is executed. On the other hand, it is assumed that the substrate bonder 1 determines that at least one of the alignment marks MK1a, MK2a, MK1b, MK2b, MK1c, and MK2c used for calculating the positional shift amount is overlapped with the electrostatic chucks 1411, 1412, 1421, and 1422 (step S11001: Yes). In this case, the conveyance device 84 extracts the substrates W1 and W2 from the substrate bonder 1 (step S11002). Subsequently, the substrate bonder 1 rotates the stage 141 and the head 142 by a preset angle (step S11003). Thereafter, the conveyance device 84 conveys again the substrates W1 and W2 to the substrate bonder 1 (step S11004). Then, the processing of step S1 is executed again.

According to this configuration, even when the conveyance device 84 does not include the conveyance device imaging unit 844, it is possible to bond the substrates W1 and W2 in a state where none of the alignment marks MK1a, MK2a, MK1b, MK2b, MK1c, and MK2c used for calculating the positional shift amount is overlapped with the electrostatic chucks 1411, 1412, 1421, or 1422.

In each embodiment, an example has been described in which the controller 9 calculates a horizontal offset vector so as to minimize the positional shift amount of each of the plurality of sets of alignment marks imaged by the imaging unit 73 of the inspection device 7. However, the present invention is not limited to this configuration, and when at least one of the substrates W1 and W2 has a plurality of chip formation regions to be bases of chips, the controller 9 may calculate the horizontal offset vector so as to minimize the ratio of chip formation regions that become defective due to the relative positional shift of the substrates W1 and W2 among the plurality of chip formation regions. In addition, when at least one of the substrates W1 and W2 has a plurality of chip formation regions to be bases of chips, the controller 9 may calculate a positional shift amount and a positional shift direction in each of the chip formation regions other than the chip formation region that becomes defective due to the positional shift of the substrate W2 with respect to the substrate W1 among the plurality of chip formation regions, separate axial-direction components, that is, XY-direction components, and rotation-direction components along two axial directions intersecting each other of the positional shift vectors determined by the calculated positional shift amount and positional shift direction, and calculate the horizontal offset vector based on the separated XY-direction components and rotation-direction components.

In each embodiment, an example in which both the stage 141 and the head 142 have the pressing mechanisms 1441 and 1432, respectively, has been described, but the present invention is not limited to this configuration, and only one of the stage 141 and the head 142 may have the pressing mechanism. Here, since the electrostatic chuck 1413 provided on the stage 141 acts in a direction in which the weight of the substrate W1 adheres to the stage 141, the holding force thereof can be set low. Thus, when the pressing mechanism 1441 is provided only on the stage 141, adhesion of the substrate W1 to the stage 141 due to the residual electrostatic force of the electrostatic chuck 1431 can be suppressed when the central portion of the substrate W1 is pressed, which is preferable.

In each embodiment and each modification described above, the case where the substrates W1 and W2 are bonded to each other by so-called hydrophilization has been described as the substrate bonding system, but the present invention is not limited to this configuration. For example, the substrate bonding system may execute so-called normal temperature bonding in which the bonding surfaces of the substrates W1 and W2 are brought into contact with each other immediately after the bonding surfaces of the substrates W1 and W2 are activated by the particle beam in so-called ultrahigh vacuum to bond the substrates W1 and W2 via a dangling bond present on the bonding surfaces. Even in this case, in the substrate bonder, bonding can be advanced from the central portion toward the peripheral portion of the substrates W1 and W2 in a state where the substrates W1 and W2 are free from the adhesion force to the stage and the head. Thus, the substrates W1 and W2 can be bonded on the entire surface with high positional accuracy without distortion. In addition, the substrate bonding system may execute so-called heat-and-pressure bonding in which the substrates W1 and W2 are bonded to each other via a solder portion and a metal portion, or may execute so-called anode bonding in which the substrates W1 and W2 are bonded to each other by applying a voltage between the substrates W1 and W2.

In the embodiments, when the distribution of the positional displacement vectors as illustrated in FIG. 18(A) is obtained, the horizontal offset amount of the substrate W2 with respect to the substrate W1 is calculated from only the XY-direction component and the rotation-direction component obtained by separating the positional shift vectors into the XY-direction component, the rotation-direction component, the warpage component, and the distortion component as illustrated in FIGS. 18(B) to (E). Here, the correction movement amount may be calculated in consideration of the calculated horizontal offset amount as it is at the time of alignment calculation with respect to the substrate W2 with respect to the substrate W1.

In Embodiment 1, an example has been described in which the inspection device 7 images all of the plurality of alignment marks including the alignment marks MK1a, MK2a, MK1b, MK2b, MK1c, and MK2c. However, the present invention is not limited to this configuration, and the inspection device 7 may image all alignment marks different from the alignment marks MK1a, MK2a, MK1b, MK2b, MK1c, and MK2c used for alignment in the substrate bonder 1.

In Embodiment 1, the bonder 1 may execute alignment of the substrate W2 with respect to the substrate W1 using representative positions of the alignment marks MK2a, MK2b, and MK2c shifted by an amount reflecting the direction and the size indicated by the horizontal offset vector calculated in advance.

The present invention enables various embodiments and modifications without departing from the broad spirit and scope of the present invention. The above-described embodiments are for describing the present invention, and do not limit the scope of the present invention. That is, the scope of the present invention is indicated by the claims rather than the embodiments. Various modifications made within the scope of the claims and the meaning of the invention equivalent thereto are regarded as being within the scope of the present invention.

### INDUSTRIAL APPLICABILITY

The present invention is suitable for manufacturing, for example, a CMOS image sensor, a memory, an arithmetic element, or a MEMS.

### REFERENCE SIGNS LIST

1 substrate bonder
2, 10002 activation processing device
3 cleaning device
7 inspection device
9 controller
71, 141, 210, 2141, 3141, 3210, 4141, 5141, 6141, 7141, 10210 stage
72 light source
73, 501A, 501B, 501C, 501D imaging unit
74 horizontal direction drive unit
82, 84, 86 conveyance device
83, 85 load lock unit
120, 831, 843, 851, 863, 10212 chamber
120a window
121a, 201a vacuum pump
121b, 201b exhaust pipe
121c, 201c exhaust valve
141b, 142b through hole
142, 2142, 3142, 4142, 5142, 6142, 7142 head
143, 10623 stage drive unit
144 head drive unit
145 XY-direction drive unit
146 lift drive unit
147 rotation drive unit
148, 1457 pressure sensor
212 processing chamber
213, 10213 plasma chamber
215 induction coil
216 high-frequency power source
217 bias application unit
220A nitrogen gas supply unit
220B oxygen gas supply unit
221A nitrogen gas storage unit
221B oxygen gas storage unit
222A, 222B supply valve
223A, 223B supply pipe
500, 8500 position measurement unit
502, 8502 reflection member
502a, 502b, 502c, 8502a, 8502b, 8502c, 8502d reflection surface
503A, 503B, 503C imaging unit position adjustment unit
511A, 511B, 511C, 731 imaging element
811, 812 introduction port
813 extraction port
821, 841, 861 conveyance robot
844 conveyance device imaging unit
1211, 8321, 8331, 8521, 8531, 8621 gate
1411, 1412, 1413, 1421, 1422, 1423, 3413, 3423, 4413, 4423, 5413, 5423 electrostatic chuck
1411a, 1412a, 1413a, 1421a, 1422a, 1423a, 3413a, 3423a, 5413a, 5423a terminal electrode
1411aa, 1421aa coupling portion
1411ab, 1421ab bent portion
1411b, 1412b, 1413b, 1421b, 1422b, 1423b, 3413b, 3423b, 4413b, 4423b, 5413b, 5423b electrode element
1411c, 1421c, 3413c, 3423c, 4413c, 4423c, 5413c, 5423c gas discharge hole
1411d, 1413d, 1423d, 3413d, 3423d, 4413d, 4423d, 5413d, 5423d groove
1441, 1442 pressing mechanism
1441a, 1442a pressing unit
1441b, 1442b pressing unit drive unit
1456, 21611, 21612, 21613, 21614, 21621, 21622, 21623, 21624 piezo actuator
1481, 1482 substrate heating unit
1491 chuck drive unit
1492 gas supply unit
1493 distance measurement unit
10212a hole
10061 particle beam source
10063 beam source conveyance unit
10611 electrode
10612 discharge chamber
10612a FAB radiation port
10613 beam source drive unit
10614 gas supply unit
10631 support rod
10632 support
10633 support drive unit
10634 bellows
21511, 21512, 21513, 21514, 21521, 21522, 21523, 21524, 61511, 61512, 61513, 61514, 61521, 61522, 61523, 61524, 71511, 71512, 71513, 71514, 71521, 71522, 71523, 71524 pressing member
34131d, 34132d, 34231d, 34232d sub groove
71611, 71612, 71613, 71614, 71621, 71622, 71623, 71624 air cylinder
A1 first region
A2 second region
A11, A12 sub-annular region
GAa, GAb, GAc captured image
JLA, JLB, JLC optical axis
MK1a, MK1b, MK1c, MK2a, MK2b, MK2c alignment mark
P11, P12, P13, P21, P22, P23 point
PLM, PLM2 plasma
VC1, VC2, VC3 virtual circle
W1, W2 substrate
W1c, W2c central portion
W1s, W2s peripheral portion

1. A substrate bonding system that bonds a first substrate and a second substrate, the substrate bonding system comprising:
a first substrate holding unit that holds the first substrate;
a second substrate holding unit that holds the second substrate in a state where a bonding surface of the second substrate faces a bonding surface of the first substrate;
at least one first electrostatic chuck provided in a first region facing a peripheral portion of the first substrate disposed at a substrate holding position set in advance in the first substrate holding unit;
at least one second electrostatic chuck that is provided in a second region inside the first region in the first substrate holding unit and holds a portion facing the second region in the first substrate disposed at the substrate holding position;
a chuck drive unit that individually drives the first electrostatic chuck and the second electrostatic chuck;
a gas discharge unit that is provided in the second region of the first substrate holding unit and discharges gas toward the first substrate;
a gas supply unit that supplies gas to the gas discharge unit; and
a controller that releases holding of the first substrate with the second electrostatic chuck and controls the chuck drive unit and the gas supply unit to discharge gas from the gas discharge unit in a state where the peripheral portion of the first substrate is held by the first electrostatic chuck before bringing a central portion of the bonding surface of the first substrate and a central portion of the bonding surface of the second substrate into contact with each other,
wherein the first substrate holding unit includes a first recess provided in the second region and communicating with the gas discharge unit.

2. The substrate bonding system according to claim 1, wherein the first recess includes at least one first groove, the first groove including a portion at least a part of which radially extends in a direction from a central portion of the first substrate holding unit toward a peripheral edge of the first substrate holding unit in the second region.

3. The substrate bonding system according to claim 2, wherein
in the first region, the first electrostatic chuck includes a plurality of first electrode elements radially extending in the direction from the central portion of the first substrate holding unit toward the peripheral edge of the first substrate holding unit, and
in the second region, the second electrostatic chuck includes a plurality of second electrode elements radially extending in the direction from the central portion of the first substrate holding unit toward the peripheral edge of the first substrate holding unit.

4. The substrate bonding system according to claim 3, wherein the plurality of second electrode elements have a shape in which a width in plan view becomes wider toward a peripheral edge side of the first substrate holding unit.

5. The substrate bonding system according to claim 2, wherein in the second region, the first recess includes at least one first groove, the first groove including a portion extending in an arc shape with the central portion of the first substrate holding unit as a central portion.

6. The substrate bonding system according to claim 5, wherein in each second region, the second electrostatic chuck includes a plurality of second electrode elements extending in an arc shape with the central portion of the first substrate holding unit as a central portion.

7. The substrate bonding system according to claim 2, wherein in the second region, the first recess includes at least one first groove, the first groove including a portion extending in a spiral shape from the central portion of the first substrate holding unit.

8. The substrate bonding system according to claim 7, wherein in each second region, the second electrostatic chuck includes at least one electrode element extending in a spiral shape from the central portion of the first substrate holding unit.

9. The substrate bonding system according to claim 3, wherein the at least one first groove includes a portion extending along an extending direction of each of the plurality of second electrode elements.

10. The substrate bonding system according to claim 9, wherein:
some second electrode elements among the plurality of second electrode elements are electrically connected to a first terminal electrode;
remaining second electrode elements among the plurality of second electrode elements are electrically connected to a second terminal electrode different from the first terminal electrode,
the some second electrode elements and the remaining second electrode elements are alternately arranged in a direction orthogonal to an extending direction of the plurality of second electrode elements; and
the at least one first groove is provided between a first electrode element electrically connected to the first terminal electrode among the plurality of first electrode elements and a second electrode element electrically connected to the second terminal electrode among the plurality of second electrode elements.

11. The substrate bonding system according to claim 1, wherein the controller fills the entire first recess with gas from the gas discharge unit in a state where the first substrate is held by the second electrostatic chuck before bringing a central portion of the bonding surface of the first substrate and a central portion of the bonding surface of the second substrate into contact with each other and then controls the chuck drive unit and the gas supply unit to release holding of the first substrate with the second electrostatic chuck.

12. The substrate bonding system according to claim 1, wherein the gas discharge unit discharges gas containing ions.

13. The substrate bonding system according to claim 1, wherein the first substrate holding unit includes a second recess provided in the first region and communicating with the gas discharge unit.

14. The substrate bonding system according to claim 13, wherein the controller fills the entire second recess with gas from the gas discharge unit in a state where the central portion of the bonding surface of the first substrate and the central portion of the bonding surface of the second substrate are in contact with each other and the peripheral portion of the first substrate is held by the first electrostatic chuck and then controls the chuck drive unit and the gas supply unit to release holding of the first substrate with the first electrostatic chuck and bring the first substrate and the second substrate into contact with each other.

15. The substrate bonding system according to claim 13, wherein:
some first electrode elements among the plurality of first electrode elements are electrically connected to a third terminal electrode;
remaining first electrode elements among the plurality of first electrode elements are electrically connected to a fourth terminal electrode different from the third terminal electrode;
the some first electrode elements among the plurality of first electrode elements and the remaining first electrode elements are alternately arranged in a direction orthogonal to an extending direction of the plurality of first electrode elements;
in the first region, the second recess includes at least one second groove including a portion at least a part of which radially extends in a direction from the central portion of the first substrate holding unit toward a peripheral edge of the first substrate holding unit; and
the at least one second groove is provided between a first electrode element electrically connected to the third terminal electrode among the plurality of first electrode elements and a first electrode element electrically connected to the fourth terminal electrode among the plurality of first electrode elements.

16. The substrate bonding system according to claim 1, wherein
the first electrostatic chuck includes:
a plurality of first electrode elements radially extending in a direction from a central portion of the first substrate holding unit toward a peripheral edge of the first substrate holding unit in the first region;
a third terminal electrode having an annular shape electrically connected to some first electrode elements among the plurality of first electrode elements in the first region; and
a fourth terminal electrode having an annular shape electrically connected to remaining first electrode elements among the plurality of first electrode elements in the first region, and
at least one of the third terminal electrode and the fourth terminal electrode includes a plurality of bent portions bent and projecting in a direction away from the other in plan view and a coupling portion coupling ends of two bent portions adjacent to each other in a circumferential direction.

17. The substrate bonding system according to claim 1,
further comprising a pressing mechanism that presses a central portion of the first substrate at the central portion of the first substrate holding unit,
wherein the controller controls the chuck drive unit and the gas supply unit to release holding of the first substrate with the second electrostatic chuck and discharge gas from the gas discharge unit in a state where a peripheral portion of the first substrate is held by the first electrostatic chuck, and then controls the pressing mechanism to bring the central portion of the bonding surface of the first substrate into contact with the central portion of the bonding surface of the second substrate and advance bonding between the first substrate and the second substrate in a state where the pressing mechanism presses the first substrate and warps the central portion of the first substrate to project the central portion of the first substrate toward the second substrate side with respect to a peripheral portion of the first substrate.

18. The substrate bonding system according to claim 1, wherein the controller controls the gas supply unit to discharge gas from the gas discharge unit and make a pressure at which the first substrate comes into contact with the second substrate less than a critical pressure at which the first substrate and the second substrate are temporarily bonded.

19. The substrate bonding system according to claim 18,
further comprising an air pressure detection unit that detects an air pressure in a region between the first substrate holding unit and the first substrate when gas is discharged from the gas discharge unit,
wherein the controller controls a flow rate of the gas discharged from the gas discharge unit to make the air pressure lower than the critical pressure based on the air pressure detected by the air pressure detection unit.

20. The substrate bonding system according to claim 1, wherein
the first electrostatic chuck includes a plurality of first electrode elements,
the second electrostatic chuck includes a plurality of second electrode elements,
some second electrode elements among the plurality of second electrode elements are electrically connected to a first terminal electrode,
remaining second electrode elements among the plurality of second electrode elements are electrically connected to a second terminal electrode different from the first terminal electrode,
some first electrode elements among the plurality of first electrode elements are electrically connected to a third terminal electrode,
remaining first electrode elements among the plurality of first electrode elements are electrically connected to a fourth terminal electrode different from the third terminal electrode,
the some second electrode elements and the remaining second electrode elements are alternately arranged,
the some first electrode elements and the remaining first electrode elements are alternately arranged, and
when releasing the holding of the peripheral portion of the first substrate from the first electrostatic chuck, the controller controls the chuck drive unit to gradually reduce an amplitude of pulse voltages while alternately applying the pulse voltages having different polarities between the first terminal electrode and the second terminal electrode.

21. The substrate bonding system according to claim 1, further comprising:
a first imaging unit disposed on a side opposite to a side on which the first substrate is supported in the first substrate holding unit; and
a holding unit drive unit that relatively moves at least one of the first substrate holding unit and the second substrate holding unit with respect to the other in a direction intersecting a direction in which the first substrate holding unit and the second substrate holding unit face each other,
wherein the first substrate holding unit is made of translucent glass,
the first substrate is provided with a plurality of first alignment marks,
the second substrate is provided with a plurality of second alignment marks as many as the plurality of first alignment marks,
the first imaging unit images the plurality of first alignment marks and the plurality of second alignment marks through the first substrate holding unit, and
the controller further controls the holding unit drive unit to move at least one of the first substrate holding unit and the second substrate holding unit and reduce a relative positional shift amount of the first substrate with respect to the second substrate based on a captured image of the plurality of first alignment marks and the plurality of second alignment marks imaged by the first imaging unit.

22. The substrate bonding system according to claim 21, wherein
the first electrostatic chuck is provided in each of a plurality of sub-annular regions set in advance with a central portion of the first substrate holding unit as a central portion in the first region of the first substrate holding unit, and holds a portion facing each of the plurality of sub-annular regions in the first substrate disposed at the substrate holding position,
the chuck drive unit individually drives the first electrostatic chuck provided in each of the plurality of sub-annular regions,
the first imaging unit images the plurality of first alignment marks and the plurality of second alignment marks in the first region of the first substrate holding unit, and
the controller controls the chuck drive to release holding of the first substrate with the first electrostatic chuck preferentially from a sub-annular region positioned on a central portion side of the first substrate holding unit among the plurality of sub-annular regions in a state where a peripheral portion of the first substrate is held by the first electrostatic chuck.

23. The substrate bonding system according to claim 21, wherein
the plurality of first alignment marks are three or more first alignment marks, and the plurality of second alignment marks are three or more second alignment marks, and
the controller controls the holding unit drive unit to move at least one of the first substrate holding unit and the second substrate holding unit to reduce a positional shift amount between the plurality of first alignment marks and the second alignment marks respectively corresponding to the plurality of first alignment marks.

24. The substrate bonding system according to claim 21, wherein the first imaging unit captures an image of the plurality of first alignment marks and the plurality of second alignment marks in a state where the first substrate and the second substrate are irradiated with light from a light source disposed on a side opposite to a side on which the first substrate is supported in the first substrate holding unit.

25. The substrate bonding system according to claim 21, wherein the first imaging unit captures an image of the plurality of first alignment marks and the plurality of second alignment marks in a state where the first substrate and the second substrate are irradiated with light from a light source disposed on a side opposite to a side on which the second substrate is supported in the second substrate holding unit.

26. The substrate bonding system according to claim 24, further comprising a light source position adjustment unit that moves the light source according to positions of the plurality of first alignment marks and the plurality of second alignment marks.

27. The substrate bonding system according to claim 21, wherein there are a plurality of the first imaging units as many as the first alignment marks, and each of the plurality of first imaging units captures an image of one of the plurality of first alignment marks and one of the second alignment marks corresponding to the one of the plurality of first alignment marks.

28. The substrate bonding system according to claim 21, further comprising an imaging unit position adjustment unit that moves the first imaging unit according to positions of the plurality of first alignment marks and the plurality of second alignment marks.

29. The substrate bonding system according to claim 21, wherein at least one of the plurality of first electrode elements and the plurality of second electrode elements is made of a transparent conductive film.

30.-38. (canceled)

39. The substrate bonding system according to claim 1, wherein
the first substrate is provided with at least one third alignment mark different from the plurality of first alignment marks,
the second substrate is provided with a fourth alignment mark as many as the at least one third alignment mark, the fourth alignment mark being different from the plurality of second alignment marks,
the substrate bonding system further comprises an inspection device, the inspection device including a second imaging unit that images all of the plurality of first alignment marks, the plurality of second alignment marks, the at least one third alignment mark, and the at least one fourth alignment mark of the first substrate and the second substrate bonded to each other, and
the controller:
calculates a positional shift amount and a positional shift direction of each of the plurality of first alignment marks and the plurality of second alignment marks and a positional shift amount and a positional shift direction of each of the at least one third alignment mark and the at least one fourth alignment mark based on a captured image obtained by imaging the plurality of first alignment marks, the plurality of second alignment marks, the at least one third alignment mark, and the at least one fourth alignment mark with the second imaging unit;
separates an axial-direction component and a rotation-direction component along two axial directions intersecting with each other of positional shift vectors determined by the positional shift amount and the positional shift direction that have been calculated; and
calculates a horizontal offset amount reflecting an axial-direction offset amount that is an offset amount in the axial direction of the second substrate with respect to the first substrate when the first substrate and the second substrate are bonded to each other and a rotational-direction offset amount that is an offset amount in a rotational direction based on the axial-direction component and the rotational-direction component that have been separated.

40. The substrate bonding system according to claim 1, wherein
the first substrate is provided with at least one third alignment mark different from the plurality of first alignment marks,
the second substrate is provided with a fourth alignment mark as many as the at least one third alignment mark, the fourth alignment mark being different from the plurality of second alignment marks,
the substrate bonding system further comprises an inspection device, the inspection device including a second imaging unit that images all of the plurality of first alignment marks, the plurality of second alignment marks, the at least one third alignment mark, and the at least one fourth alignment mark of the first substrate and the second substrate bonded to each other, and
the controller:
calculates a positional shift amount and a positional shift direction of each of the plurality of first alignment marks and the plurality of second alignment marks and a positional shift amount and a positional shift direction of each of the at least one third alignment mark and the at least one fourth alignment mark based on a captured image obtained by imaging the plurality of first alignment marks, the plurality of second alignment marks, the at least one third alignment mark, and the at least one fourth alignment mark with the second imaging unit;
separates a warpage component of a positional shift vector determined according to the positional shift amount and the positional shift direction that have been calculated to calculate a projection offset amount that is an offset amount of a projection amount of a central portion of the first substrate with respect to a peripheral portion of the first substrate toward the second substrate when the first substrate and the second substrate are bonded to each other based on the warpage component that has been separated.

41.-55. (canceled)

56. A substrate bonding method for bonding a first substrate and a second substrate, the method comprising:
a step of causing a first electrostatic chuck provided in a first region facing a peripheral portion of the first substrate disposed at a substrate holding position set in advance in the first substrate holding unit to hold the peripheral portion of the first substrate;
a step of causing a second substrate holding unit to hold the second substrate in a state where a bonding surface of the second substrate faces a bonding surface of the first substrate;
a step of causing a gas discharge unit in the first substrate holding unit having a first recess to discharge gas to the first recess, the first recess being provided in a second region inside the first region and communicating with the gas discharge unit, in a state where the peripheral portion of the first substrate is held by the first electrostatic chuck; and
a step of, after the gas is discharged to the first recess, causing a central portion of the bonding surface of the first substrate and a central portion of the bonding surface of the second substrate to come into contact with each other.

57. (canceled)

58. The substrate bonding method according to claim 56, wherein
the first substrate holding unit is made of translucent glass,
the first substrate is provided with three or more first alignment marks,
the second substrate is provided with three or more second alignment marks as many as the three or more first alignment marks, and
the method comprising:
a step of imaging the three or more first alignment marks and the three or more second alignment marks through the first substrate holding unit with a first imaging unit disposed on a side opposite to a side on which the first substrate is supported in the first substrate holding unit; and
a step of moving at least one of the first substrate holding unit and the second substrate holding unit to reduce a positional shift amount between the three or more first alignment marks and the second alignment marks respectively corresponding to the three or more first alignment marks.

59. The substrate bonding method according to claim 58, the method further comprising:
a step of imaging, with a second imaging unit different from the first imaging unit, all of the three or more first alignment marks, the three or more second alignment marks, at least one third alignment mark different from the three or more first alignment marks, and at least one fourth alignment mark different from the three or more second alignment marks as many as the at least one third alignment mark of the first substrate and the second substrate bonded to each other; and
a step of calculating a positional shift amount and a positional shift direction of each of the three or more first alignment marks and the three or more second alignment marks and a positional shift amount and a positional shift direction of each of the at least one third alignment mark and the at least one fourth alignment mark based on a captured image obtained by imaging the three or more first alignment marks, the three or more second alignment marks, the at least one third alignment mark, and the at least one fourth alignment mark with the second imaging unit, separating an axial-direction component and a rotation-direction component along two axial directions intersecting with each other of positional shift vectors determined by the positional shift amount and the positional shift direction that have been calculated, and calculating a horizontal offset amount that is a vector reflecting an axial direction offset amount that is an offset amount in the axial direction of the second substrate with respect to the first substrate when the first substrate and the second substrate are bonded to each other and a rotational direction offset amount that is an offset amount in a rotational direction based on the axial-direction component and the rotational-direction component that have been separated.

60. The substrate bonding method according to claim 58, the method further comprising:
a step of capturing, with a second imaging unit different from the first imaging unit, all of the three or more first alignment marks, the three or more second alignment marks, at least one third alignment mark different from the three or more first alignment marks, and a fourth alignment mark different from the three or more second alignment marks as many as the at least one third alignment mark of the first substrate and the second substrate bonded to each other; and
a step of calculating a positional shift amount and a positional shift direction of each of the three or more first alignment marks and the three or more second alignment marks and a positional shift amount and a positional shift direction of each of the at least one third alignment mark and the at least one fourth alignment mark based on a captured image obtained by imaging the three or more first alignment marks, the three or more second alignment marks, the at least one third alignment mark, and the at least one fourth alignment mark with the second imaging unit, and separating a warpage component of a positional shift vector determined according to the positional shift amount and the positional shift direction that have been calculated to calculate a projection offset amount that is an offset amount of a projection amount of a central portion of the first substrate with respect to a peripheral portion of the first substrate toward the second substrate when the first substrate and the second substrate are bonded to each other based on the warpage component that has been separated.

61.-74. (canceled)
